(19) United States
(12) Patent Application Publication
(10) Pub. No.: US 2005/0222300 A1
(43) Pub. Date: Oct. 6, 2005

(54) Encapsulating epoxy resin composition, and electronic parts device using the same

(76) Inventors: Ryoichi Ikezawa, Ibaraki-ken (JP); Takayuki Akimoto, Ibaraki-ken (JP); Yoshihiro Takahashi, Ibaraki-ken (JP); Mitsuo Katayose, Ibaraki-ken (JP); Naoki Watanabe, Ibaraki-ken (JP); Shinya Nakamura, Ibaraki-ken (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/505,008

(22) PCT Filed: Jan. 14, 2003
(86) PCT No.: PCT/JP03/00207

§ 371 Date: Aug. 19, 2004

(30) Foreign Application Priority Data
Feb. 27, 2002 (JP) 2002-051643
Mar. 1, 2002 (JP) 2002-056319
Mar. 1, 2002 (JP) 2002-056324
Mar. 7, 2002 (JP) 2002-061268
Mar. 29, 2002 (JP) 2002-097737
Apr. 16, 2002 (JP) 2002-113690
Apr. 16, 2002 (JP) 2002-113651

(51) Int. Cl. C08L 63/00

(52) U.S. Cl. 523/457

(57) ABSTRACT

There is disclosed an encapsulating epoxy resin composition, containing an epoxy resin (A), a curing agent (B), and a composite metal hydroxide (C), and having a mold release force under shearing after 10 shots of molding which is less than or equal to 200 KPa. The resin composition is preferably applied for encapsulating a semiconductor device having at least one of features including: (a) at least one of an encapsulating material of an upper side of a semiconductor chip and an encapsulating material of a lower side of the semiconductor chip has a thickness less than or equal to 0.7 mm; (b) a pin count is greater than or equal to 80; (c) a wire length is greater than or equal to 2 mm; (d) a pad pitch on the semiconductor chip is less than or equal to 90 (m; (e) a thickness of a package, in which the semiconductor chip is disposed on a mounting substrate, is less than or equal to 2 mm; and (f) an area of the semiconductor chip is greater than or equal to 25 mm2.

### CROSS REFERENCE TO THE RELATED APPLICATIONS

This application is based upon and claims the benefit of priority from prior Japanese Patent Applications No. 2002-51643 filed on Feb. 27, 2002, No. 2002-113651 filed on Apr. 16, 2002, No. 2002-056324 filed on Mar. 1, 2002, No. 2002-056319 filed on Mar. 1, 2002, No. 2002-61268 filed on Mar. 7, 2002, No. 2002-113690 filed on Apr. 16, 2002, and No. 2002-097737 filed on Mar. 29, 2002, the disclosure of which is expressly incorporated herein by reference in its entirety. The disclosure of the present application is also related to the subject matter contained in Japanese Patent Applications No. 2001-292356 filed on Sep. 25, 2001, and No. 2001-292366 filed on Sep. 25, 2001, the disclosure of which is expressly incorporated herein by reference in its entirety.

### BACKGROUND OF THE INVENTION

1. Technical Field

The present invention relates to an encapsulating epoxy resin composition and an electronic parts device using the same.

2. Description of the Related Art

In the field of device encapsulating used for an electronic parts device such as transistors or ICs, in terms of productivity or manufacturing costs, resin encapsulating has heretofore been the major trend. Among encapsulating resin compositions, epoxy resin compositions have been widely used. The flame resistance of such an encapsulating epoxy resin composition has mainly been realized by the combination of bromide resin such as tetrabromo-bisphenol A diglycidyl ether and antimony oxide.

The use of halide resins typified by decabromo diphenyl ether and antimony compounds has tended to be regulated in recent years from the viewpoint of environmental protection. As for the encapsulating epoxy resin compositions, the use of non-halogenated (non-bromide) and non-antimony compounds has also been demanded. Moreover, since the fact that bromide compounds have an adverse effect on high temperature storage property of plastic-encapsulated ICs has been generally known, a reduction in use of bromide resin has also been required from this viewpoint. As a method to accomplish flame resistance without using bromide resin and antimony oxide, some methods have been tried including a method using flame retardant other than halides or antimony compounds such as red phosphorus, phosphate compounds, phosphazene compounds, metal hydroxides, metal oxides, and organic metal compounds, a method of increasing the filler content, and the like. Further, there is a method using composite metal hydroxides (International Publication WO 98/47968, Japanese Unexamined Patent Publication No. 2000-53875).

### DISCLOSURE OF INVENTION

According to knowledge of inventers of the present invention, each of the flame retardants belonging to a non-halogenated and non-antimony compound has not achieved moldability or reliability which is equivalent to the encapsulating epoxy resin compositions containing both bromide resin and antimony oxide. For example, there are various problems in the following cases: where red phosphorus is used, a lowering of moisture resistance is caused; where a phosphate compound or a phosphazene compound is used, due to plasticizing efficiency a lowering of moldability and of moisture resistance is caused; where a metal hydroxide is used, a lowering of fluidity or of mold release properties is caused; where a metal oxide or an increased amount of filler is used, a lowering of fluidity is caused; and in the case where an organic metal compound such as copper acetylacetonate is used, a curing reaction is hindered, and a lowering of moldability is caused.

In addition, with the progression of research on the use of metal hydroxides, the inventors of the present invention have found that the use of metal hydroxide lowers mold release properties under shearing, and that the use of composite metal hydroxide similarly lowers the same.

It is therefore an object of the present invention to provide an encapsulating epoxy resin composition which is non-halogenated and non-antimony, and has good mold release properties and frame resistance without decreasing appropriate moldability and reliability for VLSI encapsulation such as reflow resistance, moisture resistance, and high temperature storage property.

It is another object of the present invention to provide an electronic parts device comprising an elemental device encapsulated with the encapsulating epoxy resin composition.

According to the first aspect of the present invention, there is provided an encapsulating epoxy resin composition containing an epoxy resin (A), a curing agent (B), and a composite metal hydroxide (C), and having a mold release force under shearing after 10 shots of molding which is less than or equal to 200 KPa.

According to the second aspect of the present invention, there is provided an encapsulating epoxy resin composition according to the present invention for encapsulating a semiconductor device having at least one of features including:
(a) at least one of an encapsulating material of an upper side of a semiconductor chip and an encapsulating material of a lower side of the semiconductor chip has a thickness less than or equal to 0.7 mm;
(b) a pin count is greater than or equal to 80;
(c) a wire length is greater than or equal to 2 mm;
(d) a pad pitch on the semiconductor chip is less than or equal to 90 μm;
(e) a thickness of a package, in which the semiconductor chip is disposed on a mounting substrate, is less than or equal to 2 mm; and
(f) an area of the semiconductor chip is greater than or equal to 25 mm².

According to the third aspect of the present invention, there is provided an electronic parts device comprising an elemental device encapsulated with the encapsulating epoxy resin composition according to the present invention.

### BRIEF DESCRIPTION OF THE DRAWINGS

FIGS. 1A to 1C show an example of a semiconductor device (QFP). FIG. 1A is a cross section, FIG. 1B is a top view partially drawn in perspective, and FIG. 1C is an enlarged view of a bonding pad portion.

FIGS. 2A to 2C show an example of a semiconductor device (BGA). FIG. 2A is a cross section view, FIG. 2B is a top view partially drawn in perspective, and FIG. 2C is an enlarged view of a bonding pad portion.

FIGS. 3A and 3B are schematic views showing an example of a mold array package type BGA device.

FIG. 4 and FIG. 5 are diagrams schematically showing a method for determining wire sweep.

### DETAILED DESCRIPTION OF EMBODIMENTS

According to the first aspect of the invention, there is provided an encapsulating epoxy resin composition (hereinafter, simply described as “the resin composition”) containing an epoxy resin (A), a curing agent (B) and a composite metal hydroxide (C), and having a mold release force under shearing after 10 shots of molding which is less than or equal to 200 KPa. Namely, mold release properties of the resin composition is such that whose mold release force under shearing becomes less than or equal to 200 KPa within 10 shots of molding.

Here, the mold release force under shearing is an index showing a degree of release of a molded article from a mold when the resin composition is used for molding a semiconductor device. The determination of the above is conducted as follows. A disc having a diameter of 20 mm is molded on a chrome-plated stainless steel plate of 50 mm×35 mm×0.4 mm under conditions of a mold temperature of 180° C., a molding pressure of 6.9 MPa, and a curing time of 90 seconds. Immediately after molding, the stainless steel plate is drawn out and a maximum drawing force is measured. The measured maximum drawing force denotes the mold release force under shearing. Under the same conditions the molding is continuously repeated 10 times (10 shots) or more, preferably approximately 20 times (20 shots) and the mold release force under shearing is measured immediately after molding every time. It is required that the mold release force under shearing becomes less than or equal to 200 KPa within 10 times of molding (namely, the mold release force under shearing after 10 shots of molding is less than or equal to 200 KPa), preferably less than or equal to 150 KPa from the viewpoint of moldability, more preferably less than or equal to 100 KPa, and still more preferably less than or equal to 50 KPa.

The resin composition having the mold release force under shearing after 10 shots of molding which is less than or equal to 200 KPa shows good mold release properties, enabling the reduction of defects in mold release such as gate break (residue of the encapsulating material in a gate) and sticking to a mold in manufacturing a semiconductor device. Accordingly, the resin composition enables the reduction of the generation of imperfect molding such as gate break, sticking to a mold, thus enhancing reliability even when used for a semiconductor device of thin, high pin count, long wire and narrow pad pitch type. Especially, it is preferable to use the resin composition as an encapsulating material for a semiconductor device according to the second aspect of the present invention.

The resin composition contains an epoxy resin (A), a curing agent (B), and a composite metal hydroxide (C).

As an epoxy resin of the component (A), one generally used for known epoxy resin compositions can be applicable without limitation.

Non-limiting specific examples include novolak type epoxy resins (phenol-novolak-type epoxy resins, orthocresol-novolak-type epoxy resins, etc.) obtained by epoxidation of novolak resin which is a product of condensation or copolycondensation reaction of phenols (phenol series) such as phenol, cresol, xylenol, resorcin, catechol, bisphenol A, and bisphenol F, and/or naphtols (naphtol series) such as α-naphtol, β-naphtol, and dihydroxynaphthalene, with a compound comprising aldehyde group(s) such as formaldehyde, acetaldehyde, propionaldehyde, benzaldehyde, and salicylaldehyde, under the existence of acid catalyst; diglycidyl ethers of bisphenol A, bisphenol F, bisphenol S and the like (bisphenol type epoxy resins); diglycidyl ethers of biphenols unsubstituted or substituted with alkyl group(s) (biphenyl type epoxy resins); stilbene type epoxy resins; hydroquinone type epoxy resins; glycidyl ester type epoxy resins obtained by the reaction of polybasic acid such as phthalic acid, and dimeric acid with epichlorohydrin; glycidylamine type epoxy resins obtained by the reaction of polyamine such as diaminodiphenylmethane and isocyanuric acid with epichlorohydrine; epoxidation product of copolycondensed polymer of dicyclopentadiene and phenols (dicyclopentadiene type epoxy resins); epoxy resins comprising naphthalene ring (naphthalene type epoxy resins); epoxidation products of aralkyl type phenol resins such as phenol-aralkyl resins and naphtol-aralkyl resins; trimethylolpropane type epoxy resins; terpene modified epoxy resins; linear aliphatic epoxy resins obtained by oxidation of olefin bond(s) by peracid such as peracetic acid; alicyclic epoxy resins; sulfur atom containing epoxy resins; and triphenylmethane type epoxy resins. They can be used singly or in combination thereof.

Among them, the biphenyl type epoxy resins, the bisphenol F type epoxy resins, the stilbene type epoxy resins and the sulfur atom containing epoxy resins are preferable in view of reflow resistance, the novolak type epoxy resins are preferable from the viewpoint of hardening properties, the dicyclopentadiene type epoxy resins are preferable in view of low moisture-absorption properties, and the naphthalene type epoxy resins and the triphenylmethane type epoxy resins are preferable from the viewpoint of heat resistance and low warpage properties.

Among the eight favorable epoxy resins described above, including the biphenyl type epoxy resins, the bisphenol F type epoxy resins, the stilbene type epoxy resins, the sulfur atom containing epoxy resins, the novolak type epoxy resins, the dicyclopentadiene type epoxy resins, the naphthalene type epoxy resins, and the triphenylmethane type epoxy resins, each one of the above or a combination of a plurality of the above may be applicable. The amount to be mixed thereof is preferably greater than or equal to 50 wt %, more preferably greater than or equal to 60 wt %, and further preferably greater than or equal to 80 wt %, with respect to the total amount of the epoxy resins.

Examples of the biphenyl type epoxy resins include an epoxy resin shown by the general formula (IV) described below, examples of the bisphenol F type epoxy resins include an epoxy resin shown by the general formula (V) described below, and examples of the stilbene type epoxy resins include an epoxy resin shown by the general formula (VI) described below. Examples of the sulfur atom containing epoxy resins include the one comprising sulfide bond or sulfone bond in the main chain or the one comprising a functional group(s) containing sulfur atom(s) such as mercapto group and sulfonic acid group in the side chain, and they can be used singly or in combination. Among the above, a compound shown by the general formula (III) described above is preferable. These four kinds of epoxy resins can be used singly or in combination thereof, and the amount to be mixed is preferably greater than or equal to 20 wt %, more preferably greater than or equal to 30 wt %, and further preferably greater than or equal to 50 wt %, with respect to the total amount of the epoxy resins, in order to achieve their effects. 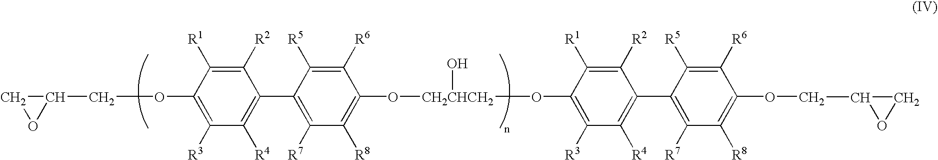
(In the formula (IV), each one of R¹ to R⁸, which may be the same or different to each other, is selected from a hydrogen atom and a substituted or unsubstituted monovalent hydrocarbon group having 1 to 10 carbon atoms, and n is an integer of 0 to 3.) 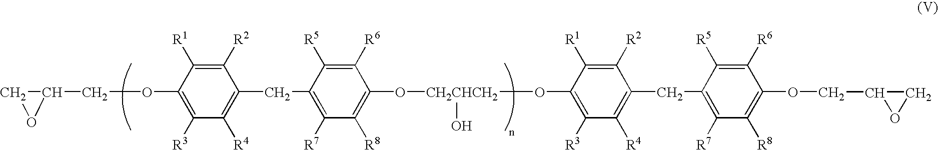
(In the formula (V), each one of R¹ to R⁸, which may be the same or different, is selected from a hydrogen atom, an alkyl group having 1 to 10 carbon atoms, an alkoxyl group having 1 to 10 carbon atoms, an aryl group having 6 to 10 carbon atoms and an aralkyl group having 6 to 10 carbon atoms, and n is an integer of 0 to 3.) 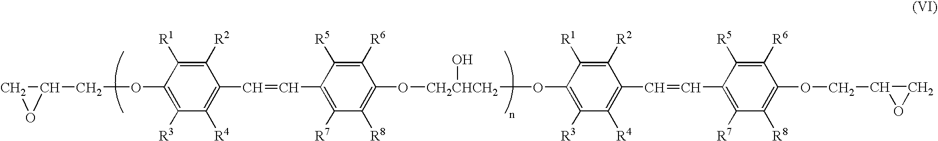
(In the formula (VI), each one of R¹ to R⁸, which may be the same or different to each other, is selected from a hydrogen atom and a substituted or unsubstituted monovalent hydrocarbon group having 1 to 10 carbon atoms, and n is an integer of 0 to 3.) 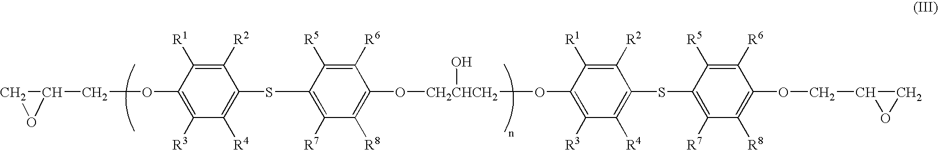
(In the formula (III), each one of R¹ to R⁸, which may be the same or different to each other, is selected from a hydrogen atom and a substituted or unsubstituted monovalent hydrocarbon group having 1 to 10 carbon atoms, and n is an integer of 0 to 3.)

Examples of the biphenyl type epoxy resin shown by the above formula (IV) include epoxy resins comprising 4,4′-bis(2,3-epoxypropoxy)biphenyl or 4,4′-bis(2,3-epoxypropoxy)-3,3′,5,5′-tetramethylbiphenyl as a main component, and epoxy resins obtained by the reaction between epichlorohydrin and 4,4′-biphenol or 4,4-(3,3′,5,5′-tetramethyl)biphenol. Among the above, the epoxy resin comprising 4,4′-bis(2,3-epoxypropoxy)-3,3′,5,5′-tetramethylbiphenyl as a main component is preferable.

As the bisphenol F type epoxy resin shown by the general formula (V) described above, for example, YSLV-80XY (product name manufactured by Nippon Steel Chemical Co., Ltd; product name of Tohto Kasei Co., Ltd. at present) is commercially available. The main component of the YSLV-80XY includes R¹, R³, R⁶ and R⁸ as methyl, R², R⁴, R⁵ and R⁷ as hydrogen, and n of 0.

The stilbene type epoxy resin shown by the general formula (VI) can be obtained by the reaction of a stilbene type phenol with epichlorohydrin under the existence of basic substance. Non-limiting examples of the stilbene type phenols include 3-t-butyl-4,4′-dihydroxy-3′,5,5′-trimethylstilbene, 3-t-butyl-4,4′-dihydroxy-3′,5′,6-trimethylstilbene, 4,4′-dihydroxy-3,3′,5,5′-tetramethylstilbene, 4,4-dihydroxy-3,3′-di-t-butyl-5,5′-dimethylstilbene, and 4,4′-dihydroxy-3,3′-di-t-butyl-6,6′-dimethylstilbene. They can be used singly or in combination thereof. Among the above, 3-t-butyl-4,4′-dihydroxy-3′,5,5′-trimethylstilbene and 4,4-dihydroxy-3,3′,5,5′-tetramethylstilbene are preferable.

Among the sulfur atom containing epoxy resin represented by the general formula (III), the epoxy resins having R¹ to R⁸ selected from a hydrogen atom and a substituted or unsubstituted alkyl group of 1 to 10 carbon atoms are preferable. Moreover, the epoxy resins in which R², R³, R⁶ and R⁷ are hydrogen and R¹, R⁴, R⁵ and R⁸ are alkyl are more preferable. The epoxy resins in which R², R³, R⁶ and R⁷ are hydrogen, R¹ and R⁸ are t-butyl, and R⁴ and R⁵ are methyl are further preferable. As the resin belonging to the above, for example, YSLV-120TE (product name manufactured by the Nippon Steel Chemical Co., Ltd.; product name of Tohto Kasei Co., Ltd. at present) is commercially available.

As the component (A), one or more kinds of the epoxy resins exemplified here may be used in addition to the sulfur atom containing epoxy resin. In this case, the amount to be mixed of the epoxy resins containing no sulfur atom is preferably less than or equal to 50 wt % with respect to the total amount of the epoxy resins. When the amount thereof exceeds 50 wt %, the sulfur atom containing epoxy resin cannot show its excellent characteristics.

Examples of the novolak type epoxy resins include an epoxy resin shown by the general formula (VII) described below. 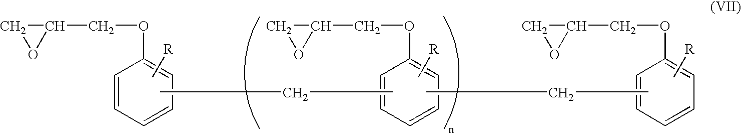
(In the formula (VII), R is selected from a hydrogen atom and a substituted or unsubstituted monovalent hydrocarbon group having 1 to 10 carbon atoms, and n is an integer of 0 to 10.)

The novolak type epoxy resin shown by the general formula (VII) described above can simply be obtained by the reaction of a novolak type phenol resin with epichlorohydrin. Specifically, as the R in the general formula (VII), alkyl groups having 1 to 10 carbon atoms such as methyl, ethyl, propyl, butyl, isopropyl and isobutyl, and alkoxyl groups having 1 to 10 carbon atoms such as methoxy, ethoxy, propoxy, and butoxy are preferable, and hydrogen and methyl are more preferable. The letter n is preferably an integer of 0 to 3. Among the novolak type epoxy resin shown by the general formula (VII), orthocresolnovolak type epoxy resins are preferable.

When the novolak type epoxy resin is used, the amount to be mixed is preferably greater than or equal to 20 wt %, and more preferably greater than or equal to 30 wt %, with respect to the total amount of the epoxy resins, in order to obtain its characteristics.

Examples of the dicyclopentadiene type epoxy resins include an epoxy resin shown by the general formula (VIII) described below. 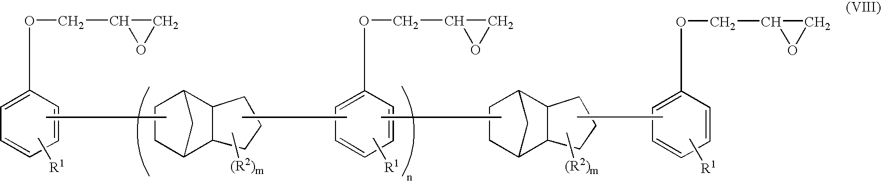
(In the formula (VIII), R¹ and R² are independently selected from a hydrogen atom and a substituted or unsubstituted monovalent hydrocarbon group having 1 to 10 carbon atoms, n is an integer of 0 to 10, and m is an integer of 0 to 6.)

Non-limiting examples of R¹ in the general formula (VIII) described above include hydrogen atom; alkyl groups such as methyl, ethyl, propyl, butyl, isopropyl, and t-butyl; alkenyl groups such as vinyl, allyl, and butenyl; alkyl groups substituted with amino group(s); substituted or unsubstituted monovalent hydrocarbon groups of 1 to 10 carbon atoms such as mercapto-substituted alkyl group. Among the above, substituted or unsubstituted monovalent hydrocarbon groups having 1 to 5 carbon atoms are preferable. Alkyl groups such as methyl and ethyl and hydrogen atom are more preferable, and methyl and hydrogen are further preferable. Non-limiting examples of R² include hydrogen atom, and substituted or unsubstituted monovalent hydrocarbon groups having 1 to 10 carbon atoms which include alkyl groups such as methyl, ethyl propyl, butyl, isopropyl, and t-butyl, alkenyl groups such as vinyl, allyl, and butenyl, amino-substituted alkyl groups, and mercapto-substituted alkyl groups. Specifically, among the above, substituted or unsubstituted monovalent hydrocarbons having 1 to 5 carbon atoms are preferable, and hydrogen atom is more preferable.

When the dicyclopentadiene type epoxy resins is used, the amount to be mixed is preferably greater than or equal to 20 wt %, more preferably greater than or equal to 30 wt %, with respect to the total amount of the epoxy resins, in order to obtain its characteristics.

Examples of the naphthalene type epoxy resins include an epoxy resin shown by the general formula (IX) described below, and examples of the triphenylmethane type epoxy resins include an epoxy resin shown by the general formula (X). 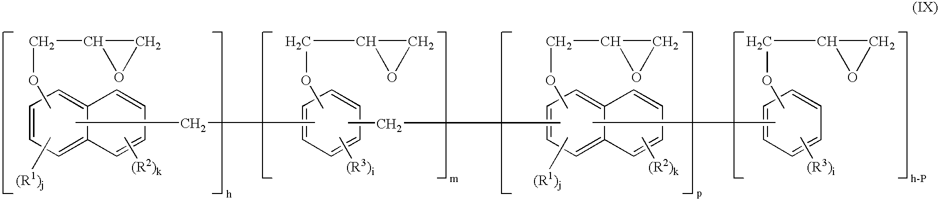
(In the formula (IX), R¹ to R³, which may be the same or different to each other, are selected from a hydrogen atom and a substituted or unsubstituted monovalent hydrocarbon group having 1 to 12 carbon atoms. The letter p is 1 or 0, h and m are respectively integers ranging from 0 to 11, the sum of (h+m) is an integer of 1 to 11, the sum of (h+p) is an integer of 1 to 12, and the individuals of h, m and p are decided to satisfy the conditions described above. The letter i is an integer of 0 to 3, j is an integer of 0 to 2, and k is an integer of 0 to 4.) 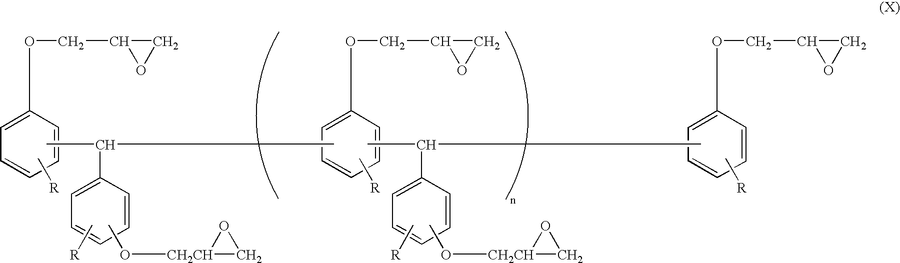
(In the formula (X), R is selected from a hydrogen atom and a substituted or unsubstituted monovalent hydrocarbon group having 1 to 10 carbon atoms, and n is an integer of 1 to 10.)

Non-limiting examples of the naphthalene type epoxy resin shown by the general formula (IX) described above include random copolymers randomly including both h sets of constitutional units and m sets of the constitutional units, alternating copolymers including the two by turns, copolymers including the two in a regular way, and block copolymers including the two in the form of blocks. They can be used singly or in combination thereof.

The naphthalene type epoxy resins and the triphenylmethane type epoxy resins can be used singly or in combination, and the amount thereof is preferably greater than or equal to 20 wt %, more preferably greater than or equal to 30 wt %, and further preferably greater than or equal to 50 wt %, with respect to the total amount of the epoxy resins, in order to achieve their effects.

As a curing agent of the component (B), one generally used for known epoxy resin compositions can be used without limitation. Non-limiting examples thereof include novolak type phenol resins obtained by condensation or copolycondensation reaction of phenols (phenol series) such as phenol, cresol, resorcin, catechol, bisphenol A, bisphenol F, phenylphenol, and aminophenol, and/or naphtols (naphtol series) such as α-naphtol, β-naphtol, and dihydroxynaphthalene, with a compound comprising aldehyde group(s) such as formaldehyde, benzaldehyde and salicylaldehyde under the existence of acid catalyst; aralkyl type phenol resins such as phenol-aralkyl resins and naphtol-aralkyl resins, synthesized from phenols and/or naphtols and dimetoxyparaxylene or bis(metoxymethyl)biphenyl; dicyclopentadiene type phenol resins synthesized by copolymerization of phenols and/or nathtols and dicyclopentadiene, such as dicyclopentadiene type phenol novolak resins and dicyclopentadiene type naphtol novolak resins; terpene modified phenol resins; biphenyl type phenol resins; and triphenylmethane type phenol resins. They can be used singly or in combination thereof.

Among the above, the biphenyl type phenol resins are preferable from the viewpoint of flame resistance, the aralkyl type phenol resins are preferable from the viewpoint of reflow resistance and hardening properties, the dicyclopentasiene type phenol resins are preferable from the viewpoint of low moisture-absorption properties, the triphenyl methane type phenol resins are preferable from the viewpoint of heat resistance, low expansion coefficient and low warpage properties, and the novolak type phenol resins are preferable from the viewpoint of hardening properties. Therefore, at least one kind of the phenol resins above is preferably contained.

As the biphenyl type phenol resins, a phenol resin shown by the general formula (XI) described below, for example, is enumerated.

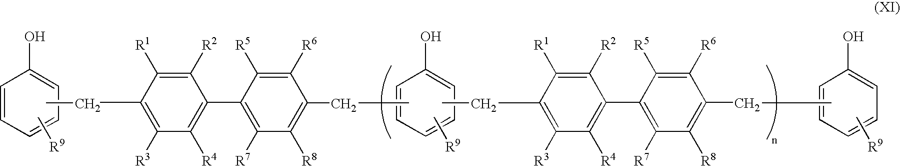

In the above formula (XI), R¹ to R⁹ may be the same or different to each other, and are selected from a hydrogen atom, an alkyl group having 1 to 10 carbon atoms such as methyl, ethyl, propyl, butyl, isopropyl, and isobutyl, an alkoxyl group having 1 to 10 carbon atoms such as methoxy, ethoxy, propoxy, and butoxy, an aryl group having 6 to 10 carbon atoms such as phenyl, tolyl, and xylyl, and an aralkyl group having 6 to 10 carbon atoms such as benzyl, and phenethyl. Among the above, hydrogen and methyl are preferable. The letter n is an integer of 0 to 10.

Non-limiting examples of the biphenyl type phenol resin shown by the general formula (XI) described above include compounds having R¹ to R⁹ which are all hydrogen, and among the above, a mixture containing greater than or equal to 50 wt % of a condensation reaction product having n being greater than or equal to 1 is preferable from the viewpoint of melt viscosity. As such compound, MEH-7851 (product name manufactured by Meiwa Plastic Industries, Ltd.) is commercially available.

When the biphenyl type phenol resin is used, the amount to be mixed is preferably greater than or equal to 30 wt %, more preferably greater than or equal to 50 wt %, and further preferably greater than or equal to 60 wt %, with respect to the total amount of the curing agents, in order to obtain its effects.

Non-limiting examples of aralkyl type phenol resins include phenol-aralkyl resins, and naphtol-aralkyl resins. A phenol-aralkyl resin shown by the general formula (XII) described below is preferable, and the phenol-aralkyl resin in which R in the general formula (XII) is hydrogen and the average of n ranges from 0 to 8 is more preferable. 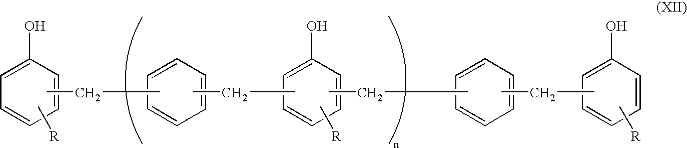
(In the formula (XII), R is selected from a hydrogen atom and a substituted or unsubstituted monovalent hydrocarbon group having 1 to 10 carbon atoms, and n is an integer of 0 to 10.)

The specific examples thereof include p-xylylene type phenol-aralkyl resins, and m-xylylene type phenol-aralkyl resins. When the aralkyl type phenol resin is used, the amount to be mixed is preferably greater than or equal to 30 wt % and more preferably greater than or equal to 50 wt %, with respect to the total amount of the curing agents, in order to obtain its effects.

As the dicyclopentadiene type phenol resins, a phenol resin shown by the general formula (XIII) described below is enumerated. 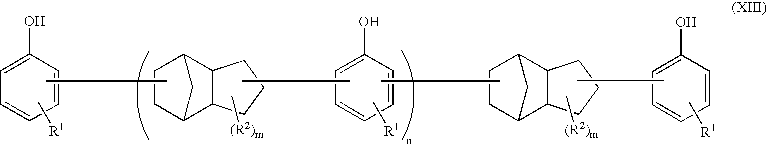
(In the formula (XIII), R¹ and R² are independently selected from a hydrogen atom and a substituted or unsubstituted monovalent hydrocarbon having 1 to 10 carbon atoms, and n and m are integers that range from 0 to 10 and from 0 to 6 respectively.)

When using dicyclopentadiene type phenol resin, the amount to be mixed is preferably greater than or equal to 30 wt % and more preferably greater than or equal to 50 wt %, with respect to the total amount of the curing agents, in order to obtain its effects.

Examples of the triphenylmethane type phenol resins include a phenol resin shown by the general formula (XIV) described below. 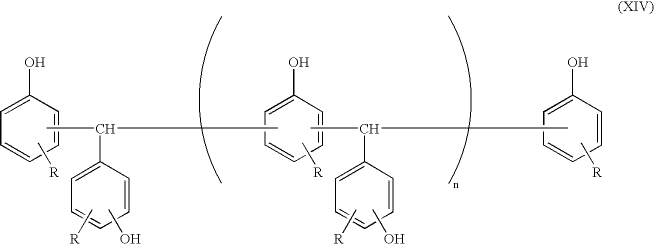
(In the formula (XIV), R is selected from a hydrogen atom and a substituted or unsubstituted monovalent hydrocarbon having 1 to 10 carbon atoms, and n is an integer of 1 to 10.)

When the triphenylmethane type phenol resin is used, the amount to be mixed is preferably greater than or equal to 30 wt % and more preferably greater than or equal to 50 wt %, with respect to the total amount of the curing agents, in order to obtain its effects.

Examples of the novolak type phenol resins include phenol novolak resins, cresol novolak resins, and naphtol novolak resins. Among the above, the phenol novolak resins are preferable. When the novolak type phenol resin is used, the amount to be mixed is preferably greater than or equal to 30 wt % and more preferably greater than or equal to 50 wt %, with respect to the total amount of the curing agents, in order to obtain its effects.

The resins described above including the biphenyl type phenol resins, the aralkyl type phenol resins, the dicyclopentadiene type phenol resins, the triphenylmethane type phenol resins, and the novolak type phenol resins may be used singly or in combination thereof. When one of the above is used, the amount to be mixed is preferably greater than or equal to 30 wt %, more preferably greater than or equal to 50 wt %, and further preferably greater than or equal to 60 wt %, with respect to the total amount of the curing agents (B), in order to obtain its effects. When the two or more arbitrary ones above are mixed, the amount thereof is preferably greater than or equal to 60 wt %, and more preferably greater than or equal to 80 wt %, with respect to the total amount of the curing agents.

The equivalence ratio between the epoxy resin (A) and the curing agent (B), in other word, the ratio of hydroxyl group within the curing agent (B) to epoxy group within the epoxy resin (A) (that is, the number of hydroxyl group in the curing agent divided by the number of epoxy group in the epoxy resin) is not specifically limited. However, the ratio is preferably set in a range of 0.5 to 2, and more preferably of 0.6 to 1.3, in order to reduce unreacted components. From the viewpoint of improving moldability and reflow resistance properties, a ratio in a range of 0.8 to 1.2 is further preferable.

A composite metal hydroxide of the component (C) works as a flame retardant that consists of hydroxides of plural metals, in other word, a solid solution or a mixture of two or more kinds of metal hydroxides. The composite metal hydroxide is preferably stable under temperatures ranging from room temperature to the one used during mounting, from the viewpoint of improving moldability and reducing molding defects such as voids. When the composite metal hydroxide is used as a flame retardant, it is preferable that the components (A) and (B) cause dehydration at the temperature range under which the both components are decomposed. Any publicly known manufacturing method of the composite metal hydroxide is applicable. For example, it can be prepared by a precipitation method under which a metal salt dissolved in a good solvent gradually drops into an aqueous alkali solution.

Though there are no limitations as long as the effect of the present invention can be obtained, a compound represented by the chemical composition formula (C-I) described below is preferable as the component (C).
p(M¹aOb).q(M²cOd).r(M³cOd).mH₂O (C-I)
(In the formula (C-I), M¹, M² and M³ are different metal elements each other, a, b, c, d, p, q, and m are positive numerals, and r is 0 or a positive numeral.)

Among the above, a compound in which r in the formula (C-I) described above is 0, in other word, a compound represented by the chemical composition formula (C-II) described below is more preferable.
m(M¹aOb).n(M²cOd).h(H₂O) (C-II)
(In the formula (C-II), M¹ and M² represent different metal elements each other, and a, b, c, d, m, n, and h are positive numerals.)

M¹ and M² in the chemical composition formulas (C-I) and (C-II) described above are different metal elements each other and there are no specific limitations imposed thereon. From the viewpoint of better flame resistance, while avoiding selecting a same metal for M¹ and M², M¹ is preferably selected from the group consisting of metal elements belonging to the third period, alkaline earth metal elements of group IIA and metal elements belonging to groups IVB, IIB, VIII, IB, IIIA and IVA, and M² is preferably selected from transition metal elements of groups IIIB to IIB. The metal M¹ is more preferably selected from the group consisting of magnesium, calcium, aluminum, tin, titanium, iron, cobalt, nickel, copper and zinc, and M² is more preferably selected from the group consisting of iron, cobalt, nickel, copper and zinc. From the viewpoint of fluidity, M¹ is preferably magnesium and M² preferably zinc or nickel, and the case that M¹ is magnesium and M² is zinc is more preferable. Here, metal elements include so-called semimetal elements, that is, the metal elements represent all the elements except nonmetal elements. The classification of the metal elements is based on the long form of the periodic law table, in which typical elements are to be in A subgroup and transition elements are to be in B subgroup, and the source of which is: The Encyclopedia Chimica, vol. 4, the reduced size edition 30^{th}, Feb. 15, 1987, published by Kyoritsu Shuppan Co., Ltd.).

Though the molar ratio between p, q and r in the chemical composition formula (C-I) described above is not especially limited, r is preferably equal to 0 and the molar ratio between p and q (p/q) is preferably 99/1 to 50/50. In other words, the molar ratio between m and n (m/n) in the chemical composition formula (C-II) described above is preferably 99/1 to 50/50.

In terms of a commercialized composite metal hydroxide, the component (C), for example, the Echomag Z-10 that is the product name manufactured by the Tateho Chemical Industries Co., Ltd. is available.

The shape of the composite metal hydroxides is not especially limited. However, from the viewpoint of fluidity, polyhedrons with appropriate thickness are more preferable than tabular ones. Compared with metal hydroxides, polyhedral crystals of the composite metals hydroxides are easy to obtain. Though the amount to be mixed of the composite metal hydroxide to the amount of the resin composition is not specifically limited, greater than or equal to 0.5 wt % is preferable from the viewpoint of flame resistance, less than or equal to 20 wt % is preferable from the viewpoint of fluidity and reflow resistance, a range of 0.7 to 15 wt % is more preferable, and a range of 1.4 to 12 wt % is further preferable.

In the first preferred embodiment, an inorganic filler (D) can be mixed in order to reduce moisture absorption and linear expansion coefficient, and to improve thermal conductivity and strength. Non-limiting examples of the inorganic filler include fused silica, crystal silica, alumina, zircon, calcium silicate, calcium carbonate, potassium titanate, silicon carbide, silicon nitride, aluminum nitride, boron nitride, beryllia, zirconia, forsterite, steatite, spinel, mullite, and titania, which are provided in the form of powder or ensphered beads, glass fiber and the like. They can be used singly or in combination thereof. Among the above, fused silica is preferable from the viewpoint of lower linear expansion coefficient, alumina is preferable from the viewpoint of better thermal conductivity, and the shape of the filler is preferably spherical from the viewpoint of fluidity and mold abrasion resistance when used for molding.

In terms of the amount of the component (D) to be mixed with respect to the total amount of the resin composition, greater than or equal to 60 wt % is preferable, greater than or equal to 75 wt % is more preferable, greater than or equal to 80 wt % is further preferable, and greater than or equal to 88 wt % is still further preferable, from the viewpoint of reflow resistance, fluidity, flame resistance, moldability, reduction in moisture absorption and linear expansion coefficient, and improvement in strength. On the other hand, the amount to be mixed thereof is preferably less than or equal to 95 wt %, and more preferably less than or equal to 92 wt %. That is, a preferable range is from 70 to 95 wt %, and a more preferable range is from 75 to 92 wt %. Or, depending upon the intended use or the like, a preferable range is from 80 to 95 wt %, and a more preferable range is from 88 to 92 wt %. When the amount is less than 60 wt %, flame resistance and reflow resistance tend to be worse, and when the amount exceeds 95 wt %, fluidity tends to be insufficient.

In the second preferred embodiment, a hardening accelerator (E) may be used to facilitate the reaction between the epoxy resin (A) and the curing agent (B) as required. Though the amount to be mixed of the component (E) is not specifically limited as far as the amount is enough to accelerate the reaction, it preferably ranges from 0.005 to 2 wt %, and more preferably from 0.01 to 0.5 wt %, with respect to the total amount of the resin composition. When the amount thereof is less than 0.005 wt %, the hardening in a short time period range tends to decline, and when higher than 2 wt %, the hardening rate tends to be too high to produce a favorable molding product.

As the hardening accelerator, one generally used for known epoxy resin compositions can be utilized without limitation. Non-limiting examples of the hardening accelerator include cycloamidine compounds such as 1,8-diaza-bicyclo(5,4,0)undecene-7,1,5-diaza-bicyclo(4,3,0)nonene, and 5,6-dibutylamino-1,8-diaza-bicyclo(5,4,0)undecene-7; compounds having an intramolecular polarization, obtained by addition of the above cycloamidine compound and a compound having π-bond(s) in the molecule such as maleic anhydride, or quinone compounds such as 1,4-benzoquinone, 2,5-tolquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, and phenyl-1,4-benzoquinone, diazophenylmethane, and phenol resins; tertiary amines such as benzyldimethylamine, triethanolamine, dimethylaminoethanol, and tris(dimethylaminomethyl)phenol, and their derivatives; imidazols such as 2-methylimidazol, 2-phenylimidazol, and 2-phenyl-4-methylimidazol, and their derivatives; phosphine compounds such as tributylphosphine, methyldiphenylphosphine, triphenylphosphine, tris(4-methylphenyl)phosphine, diphenylphosphine, and phenylphosphine; phosphorus compounds having an intramolecular polarization, obtained by addition of the phosphine compound described above and a compound having π-bond(s) in the molecule such as maleic anhydride, the quinone compounds described above, diazophenylmethane, and phenol resins; tetraphenyl borate salts such as tetraphenylphosphonium tetraphenylborate, triphenylphosphine tetraphenylborate, 2-ethyl-4-methylimidazol tetraphenylborate, N-methylmorpholine tetraphenylborate, and their derivatives. They can be used singly or in combination thereof.

The component (E) preferably contains a phosphine compound from the viewpoint of hardening properties. In this case, the resin composition preferably further contains a quinone compound. The component (E) preferably contains an adduct of the phosphine compound and the quinone compound from the viewpoint of hardening properties and fluidity.

As the phosphine compound, a tertiary phosphine compound is more preferable. Non-limiting examples of the phosphine compound include tertiary phosphine compounds comprising alkyl and/or aryl group(s), such as tricyclohexylphosphine, tributylphosphine, dibutylphenylphosphine, butyldiphenylphosphine, ethyldiphenylphosphine, triphenylphosphine, tris(4-methylphenyl)phosphine, tris(4-ethylphenyl)phosphine, tris(4-propylphenyl)phosphine, tris(4-butylphenyl)phosphine, tris(isopropylphenyl)phosphine, tris(t-butylphenyl)phosphine, tris(2,4-dimethylphenyl)phosphine, tris(2,6-dimethylphenyl)phosphine, tris(2,4,6-trimethylphenyl)phosphine, tris(2,6-dimethyl-4-ethoxyphenyl)phosphine, tris(4-methoxyphenyl)phosphine, and tris(4-ethoxyphenyl)phosphine. Among the above, the phosphine compound selected from the group consisting of triphenylphosphine, tri-p-tolylphosphine, and tributylphosphine is especially preferable.

Non-limiting examples of the quinone compound include o-benzoquinone, p-benzoquinone, diphenoquinone, 1,4-naphthoquinone, and anthraquinone. Among the above, p-benzoquinone (1,4-benzoquinone) is preferable from the viewpoint of moisture resistance and storage stability. Moreover, an adduct of a tertiary phosphine compound shown by the general formula (IA) and p-benzoquinone is preferable.

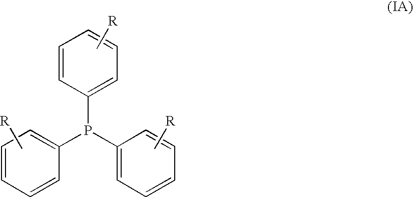

The letter R in the formula (IA) is selected from a hydrogen atom, a hydrocarbon group having 1 to 12 carbon atoms and an alkoxy group having 1 to 12 carbon atoms, and all of which may be the same or different to each other. The above hydrocarbon groups or alkoxy groups may be substituted. Each R above is preferably selected independently from a hydrogen atom, an alkyl group having 1 to 4 carbon atoms and an alkoxy group having 1 to 4 carbon atoms. From the viewpoint of mold release properties, in the case that m is equal to 1, one or more of the three R are preferably alkyl or alkoxy groups, and all of the R are further preferably alkyl or alkoxy groups. More specifically, an adduct of triphenylphosphine, tris(4-methylphenyl)phosphine, or tributylphosphine and p-benzoquinone is more preferable from the viewpoint of mold release properties.

From the viewpoint of storage stability, the hardening accelerator (E) preferably includes an adduct of cycloamidine compound and phenol resin, and especially, a phenol novolak resin salt of diazabicycloundecene is more preferable.

From the viewpoint of improving the mold release properties and reliability, etc., the resin composition includes any one of the following hardening accelerators as the component (E).
(1) a hardening accelerator that includes an adduct of the phosphine compound represented by the general formula (IA) described above and a quinone compound;
(2) a hardening accelerator that includes both the phosphine compound shown by the general formula (IA) described above and a quinone compound;
(3) a hardening accelerator that includes an adduct of a phosphine compound comprising a phosphorus atom(s) bonded with at least one alkyl group and a quinone compound;
(4) a hardening accelerator that includes both a phosphine compound comprising a phosphorus atom(s) bonded with at least one alkyl group and a quinone compound;

For example, the hardening accelerator may contain both the adduct of the phosphine compound shown by the general formula (IA) and the quinone compound, and the adduct of the phosphine compound comprising a phosphorus atom(s) bonded with at least one alkyl group and the quinone compound. The hardening acceleration also may contain the phosphine compound shown by the general formula (IA), the phosphine compound comprising a phosphorus atom(s) bonded with at least one alkyl group, and the quinone compound.

In the above, the adduct indicates a compound or a complex, obtained by the addition of the phosphine compound and the quinone compound, and non-limiting examples of the adduct include an addition reaction product, and a compound composed of two compounds with different π-electron densities each other, due to intermolecular force working between them. In the (2) and (4) described above, the ratio between the phosphine compound and the quinone compound preferably ranges from 1/1 to 1/1.5 in the molar ratio.

As the phosphine compound comprising a phosphorus atom(s) bonded with at least one alkyl group, a phosphine compound shown by the general formula (IB) described below is preferable.

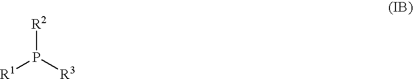

The letter R¹ in the general formula (IB) indicates an alkyl group having 1 to 12 carbon atoms, and R² and R³ are hydrogen atoms or selected from a hydrocarbon group having 1 to 12 carbon atoms, which may be the same or different one other. The alkyl group and the hydrocarbon group mentioned above may be substituted. Preferably, R¹, R² and R³ are independently selected from an alkyl group having 1 to 12 carbon atoms. From the viewpoint of better mold release properties, one or more of R¹ to R³ are preferably cyclohexyl, butyl or octyl.

Non-limiting examples of the phosphine compound shown by the general formula (IA) include triphenylphosphine, diphenyl-p-tolylphosphine, diphenyl(p-methoxyphenyl)phosphine, di-p-tolylphenylphosphine, bis-(p-methoxyphenyl)phenylphosphine, tri-p-tolylphosphine, tri-o-tolylphosphine, tri-m-tolylphosphine, tris-(p-ethylphenyl)phosphine, tris-(p-n-butylphenyl)phosphine, tris-(p-methoxyphenyl)phosphine, tris-(o-methoxyphenyl)phosphine, and tris-(m-methoxyphenyl)phosphine. Especially, in view of their excellent hardening properties, preferable examples include phenylbis-(p-alkylphenyl)phosphines, phenylbis-(p-alkoxyphenyl)phosphines, tris-(p-alkylphenyl)phosphines, tris-(o-alkylphenyl)phosphines, tris-(m-alkylphenyl)phosphines, and tris-(p-alkoxyphenyl)phosphines, all of which have two or more electron donative substituents such as alkyl group and alkoxy group introduced into para, meta or ortho position, such as phenyldi-p-tolylphosphine, phenylbis-(p-methoxyphenyl)phosphine, tri-p-tolylphosphine, tri-o-tolylphosphine, tri-m-tolylphosphine, tris-(p-ethylphenyl)phosphine, tris-(p-n-butylphenyl)phosphine, and tris-(p-methoxyphenyl)phosphine. One or more kinds of the phosphine compounds shown by the general formula (IA) may be properly selected to be applied in the form of the adduct of the quinone compound or in the form of the mixture with the quinone compound, the former of which is preferable from the viewpoint of fluidity.

Non-limiting examples of the phosphine compound shown by the general formula (IB) include trialkylphosphines such as tributylphosphine, tricyclohexylphosphine, and trioctylphosphine; aryldialkylphosphines such as phenyldibutylphosphine, and phenyldicyclohexylphosphine; and diarylalkylphosphines such as diphenylbutylphosphine, and diphenylcyclohexylphosphine. Among the compounds above, from the viewpoint of hardening properties, trialkylphosphines such as tributylphosphine, tricyclohexylphosphine, and trioctylphosphine are preferable, and from the viewpoint of reflow resistance, aryldialkylphosphines such as diphenylbutylphosphine, and diphenylcyclohexylphosphine are preferable. The phosphine compounds shown by the general formula (IB) can be used singly or in combination, and may be applied in the form of the addition product with the quinone compound, or together with the quinone compound. The addition product is preferable from the viewpoint of fluidity.

As the quinone compound which is contained in the resin composition in the form of the adduct with the phosphine compound or together with the phosphine compound, for example, benzoquinone, naphthoquinone, and anthraquinone are enumerated. Among the above, p-quinones are preferable. Non-limiting examples of p-quinones include 1,4-benzoquinone, methyl-1,4-benzoquinone, methoxy-1,4-benzoquinone, t-butyl-1,4-benzoquinone, phenyl-1,4-benzoquinone, 2,3-dimethyl-1,4-benzoquinone, 2,5-dimethyl-1,4-benzoquinone, 2,3-dimethoxy-1,4-benzoquinone, 2,5-dimethoxy-1,4-benzoquinone, 2,5-di-t-butyl-1,4-benzoquinone, 1,4-naphthoquinone, and 9,10-anthraquinone. Among the above, 1,4-benzoquinone and methyl-p-benzoquinone are more preferable for better reactivity with the phosphine compound. As to the quinone compound, one or more kinds thereof may be appropriately selected for the use.

In terms of the adducts of the phosphine compound shown by the general formula (IA) and the quinone compound, though no specific limitations are imposed thereon, the adduct produced by the quinone compound and a phosphine compound comprising two or more aryl groups having an electron donative substituent(s) is preferable from the view point of hardening properties. Non-limiting examples thereof include an adduct of tris-(p-methoxyphenyl)phosphine and 1,4-benzoquinone, an adduct of tris-(p-methoxyphenyl)phosphine and methyl-1,4-benzoquinone, an adduct of tris-(p-methoxyphenyl)phosphine and t-butyl-1,4-benzoquinone, an adduct of tri-p-tolylphosphine and 1,4-benzoquinone, an adduct of tri-p-tolylphosphine and methyl-1,4-benzoquinone, an adduct of tri-p-tolylphosphine and t-butyl-1,4-benzoquinone, an adduct of tri-o-tolylphosphine and 1,4-benzoquinone, an adduct of tri-o-tolylphosphine and methyl-1,4-benzoquinone, an adduct of tri-o-tolylphosphine and t-butyl-1,4-benzoquinone, an adduct of tri-m-tolylphosphine and 1,4-benzoquinone, an adduct of tri-m-tolylphosphine and methyl-1,4-benzoquinone, an adduct of tri-m-tolylphosphine and t-butyl-1,4-benzoquinone, a reaction product of bis-(p-methoxyphenyl)phenylphosphine and 1,4-benzoquinone, a reaction product of bis-(p-methoxyphenyl)phenyl phosphine and methyl-1,4-benzoquinone, a reaction product of bis-(p-methoxyphenyl)phenylphosphine and t-butyl-1,4-benzoquinone, a reaction product of di-p-tolylphenylphosphine and 1,4-benzoquinone, a reaction product of di-p-tolylphenylphosphine and methyl-1,4-benzoquinone, and a reaction product of di-p-tolylphenylphosphine and t-butyl-1,4-benzoquinone.

From the viewpoint of reflow resistance, the adducts of a phosphine compound comprising less than two aryl groups having an electron donative substituent(s) and the quinone compound are preferable. Non-limiting examples thereof include an adduct of diphenyl(p-methoxyphenyl)phosphine and 1,4-benzoquinone, an adduct of diphenyl(p-methoxyphenyl)phosphine and methyl-1,4-benzoquinone, an adduct of diphenyl(p-methoxyphenyl)phosphine and t-butyl-1,4-benzoquinone, an adduct of diphenyl-p-tolylphosphine and 1,4-benzoquinone, an adduct of diphenyl-p-tolylphosphine and methyl-1,4-benzoquinone, an adduct of diphenyl-p-tolylphosphine and t-butyl-1,4-benzoquinone, an adduct of triphenylphosphine and 1,4-benzoquinone, an adduct of triphenylphosohine and methyl-1,4-benzoquinone, and an adduct of triphenylphosphine and t-butyl-1,4-benzoquinone.

As the adducts of the phosphine compound shown by the general formula (IB) and the quinone compound, though no specific limitations are imposed thereon, the compounds described below are preferable from the viewpoint of hardening properties. Non-limiting examples include the adducts of the trialkylphosphine and the quinone compound such as an adduct of tricyclohexylphosphine and 1,4-benzoquinone, an adduct of tricyclohexylphosphine and methyl-1,4-benzoquinone, an adduct of tricyclohexylphosphine and t-butyl-1,4-benzoquinone, an adduct of tributylphosphine and 1,4-benzoquinone, an adduct of tributylphosphine and methyl-1,4-benzoquinone, an adduct of tributylphosphine and t-butyl-1,4-benzoquinone, an adduct of trioctylphosphine and 1,4-benzoquinone, an adduct of trioctylphosphine and methyl-1,4-benzoquinone, and an adduct of trioctylphosphine and t-butyl-1,4-benzoquinone.

From the viewpoint of reflow resistance, an adduct of alkyldiarylphosphine or dialkylarylphosphine and the quinone compound is preferable. Non-limiting examples of the above include an adduct of cyclohexyldiphenylphosphine and 1,4-benzoquinone, an adduct of cyclohexyldiphenylphosphine and methyl-1,4-benzoquinone, an adduct of cyclohexyldiphenylphosphine and t-butyl-1,4-benzoquinone, an adduct of butyldiphenylphosphine and 1,4-benzoquinone, an adduct of butyldiphenylphosphine and methyl-1,4-benzoquinone, an adduct of butyldiphenylphosphine and t-butyl-1,4-benzoquinone, an adduct of dicyclohexylphenylphosphine and 1,4-benzoquinone, an adduct of dicyclohexylphenylphosphine and methyl-1,4-benzoquinone, an adduct of dicyclohexylphenylphosphine and t-butyl-1,4-benzoquinone, an adduct of dibutylphenylphosphine and 1,4-benzoquinone, an adduct of dibutylphenylphosphine and methyl-1,4-benzoquinone, and an adduct of dibutylphenylphosphine and t-butyl-1,4-benzoquinone. Among the above, the adducts of alkyldiphenylphosphine and 1,4-benzoquinone such as the adduct of cyclohexyldiphenylphosphine and 1,4-benzoquinone, the adduct of butyldiphenylphosphine and 1,4-benzoquinone, and the adduct of octyldiphenylphosphine and 1,4-benzoquinone are more preferable.

More specifically, compounds represented by the following formula (XV) are exemplified as an adduct of phosphine compound and quinone compound. 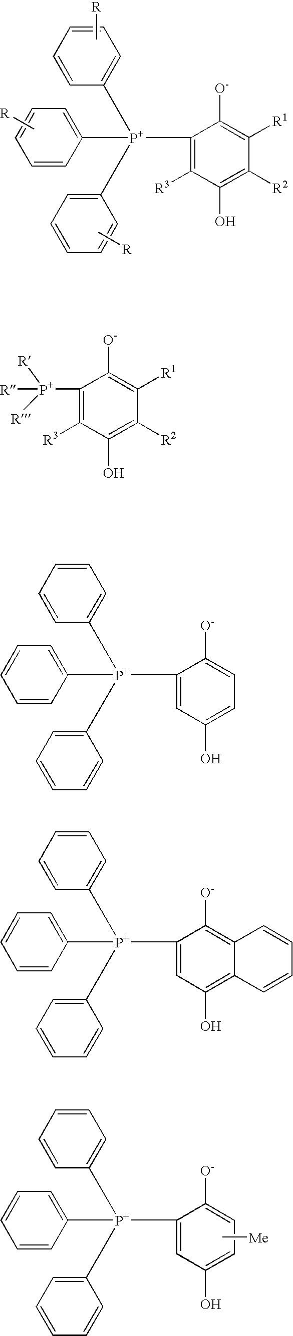 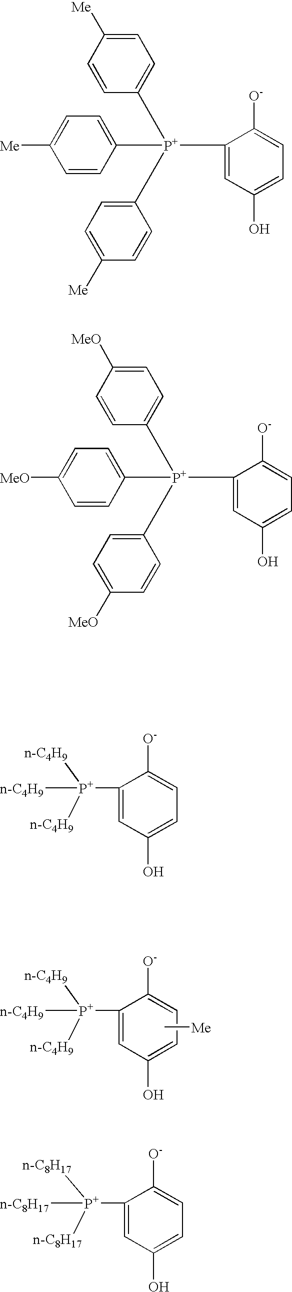 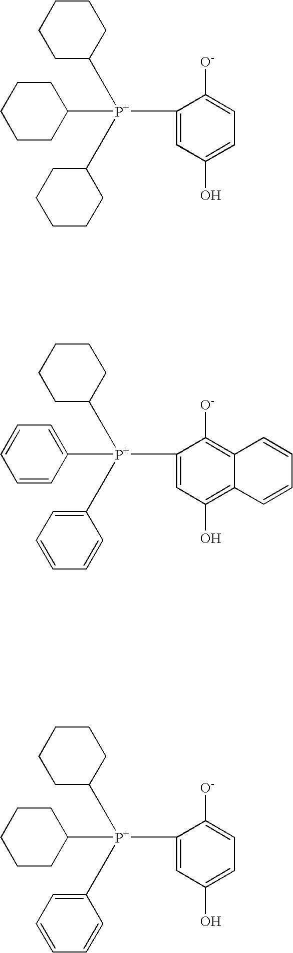
(In the formula (XV), R, R′, R″, R′″ and R¹ to R³ are selected from a hydrogen atom and a hydrocarbon group having 1 to 18 carbon atoms, and all of which may be the same or different to each other. R² and R³ may form a ring structure by connecting with each other.)

It is possible to identify the adduct shown by the above formula by using ¹H-NMR and ³¹P-NMR without difficulty. In ³¹P-NMR, a peak belonging to ³¹P of the phosphine compound shifts towards lower magnetic field, which shows the fact that a phosphorus atom is changed to cation. In terms of ¹H NMR, the change of a ¹H derived from quinone to a hydroxyl group can be proven by the disappearance of a ¹H. In addition, the coupling between ¹H and ³¹P is observed. Based on these facts, the formation of the adducted product of the quinone compound and phosphine is identified.

There are no specific limitations imposed on the manufacturing method for the adducts of the phosphine compound shown by the general formula (IA) and the quinone compound, and the adducts of the phosphine compound comprising a phosphorus atom(s) bonded with at least one alkyl group and the quinone compound. For example, one method includes addition reaction of the phosphine compound and the quinone compound in an organic solvent which can solve both raw materials followed by isolation of the product, and the other method includes addition reaction of the both in the curing agent of the component (B) described above. In the latter method, the obtained product solved in the curing agent can be used without isolation as the component of the resin composition.

As for the adducts of the phosphine compound shown by the general formula (IA) and the quinone compound, each one of the above or a combination of two or more of the above is applicable. As for the adducts of the phosphine compound comprising a phosphorus atom(s) bonded with at least one alkyl group and the quinone compound, each one of the above or a combination of two or more of the above is applicable. In addition, as mentioned above, a combination of one or more of the adducts of the phosphine compound shown by the general formula (IA) and the quinone compound and one or more of the adducts of the phosphine compound comprising a phosphorus atom(s) bonded with at least one alkyl group and the quinone compound is also applicable.

A hardening accelerator such as phosphorus compounds, tertiary amine compounds, and imidazole compounds can further be included in combination with any one of the hardening accelerators (1) to (4) described above as the component (E), as required. In this case, the amount to be mixed is preferably less than or equal to 95 wt % with respect to the total amount of the hardening accelerators.

In the third preferred embodiment, linear type oxidized polyethylene having a weight average molecular weight of greater than or equal to 4,000, as component (F), and as compound (G), an ester compound are included. The ester compound is obtained by esterification of a copolymerization product, which is made of α-olefin having 5 to 30 carbon atoms and maleic anhydride, with a monovalent alcohol having 5 to 25 carbon atoms. The above components (F) and (G) work as a mold releasing agent. The component (G) is highly compatible with the linear type oxidized polyethylene of the component (F) as well as with the epoxy resin of the component (A), therefore, the component (G) effectively prevents stain formed on molds and packages and decrease in adhesion.

Here, the linear type polyethylene is defined as polyethylene in which the number of the carbon atoms belonging to side chains is approximately less than or equal to 10% of the number of the carbon atoms belonging to main chain, and generally classified to a polyethylene showing the penetration of less than or equal to 2. Moreover, the oxidized polyethylene is defined as the polyethylene having an acid value.

The weight average molecular weight of the component (F) is greater than or equal to 4,000 from the viewpoint of mold release properties, preferably less than or equal to 30,000 from the viewpoint of adhesion and prevention of stain on molds and packages, more preferably ranging from 5,000 to 20,000, and further preferably ranging from 7,000 to 15,000. The weight average molecular weight here indicates the value measured using high-temperature GPC (Gel Permeation Chromatography). The acid value of the component (F) is not especially limited, but preferably ranges from 2 to 50 mg/KOH, more preferably from 10 to 35 mg/KOH from the viewpoint of mold release properties.

Though the amount to be mixed of the component (F) with respect to the amount of the epoxy resin (A) is not especially limited, an amount greater than or equal to 0.5 wt % is preferable from the viewpoint of mold release properties, an amount less than or equal to 10 wt % is preferable from the viewpoint of improving adhesion and avoiding stain on molds and packages, and a range of 1 to 5 wt % is more preferable.

The α-olefin having 5 to 30 carbon atoms used in the component (G) described above is not especially limited. Non-limiting examples thereof include linear type α-olefins such as 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 1-dokosene, 1-tricosene, 1-tetracosene, 1-pentacocene, 1-hexacocene, and 1-heptacosene; and branched type α-olefins such as 3-methyl-1-butene, 3,4-dimethyl-pentene, 3-methyl-1-nonene, 3,4-dimethyl-1-octene, 3-ethyl-1-dodecene, 4-methyl-5-ethyl-1-octadecene, and 3,4,5-triethyl-1-eicosene. They can be used singly or in combination thereof. Among the above, the linear type α-olefins having 10 to 25 carbon atoms are preferable, and the linear type α-olefins having 15 to 25 carbon atoms such as 1-eicosene, 1-dokosene and 1-tricosene are more preferable.

The monovalent alcohol having 5 to 25 carbon atoms used for the component (G) is not especially limited. Non-limiting examples thereof include linear or branched chain type aliphatic saturated alcohols such as amyl alcohol, isoamyl alcohol, hexyl alcohol, heptyl alcohol, octyl alcohol, capryl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, and eicocyl alcohol; linear or branched chain type aliphatic unsaturated alcohols such as hexenol, 2-hexene-1-ol, 1-hexene-3-ol, pentenol, and 2-methyl-1-pentenol; alicyclic alcohols such as cyclopentanol, and cyclohexanol; aromatic alcohols such as benzyl alcohol, and cinnamyl alcohol; and heterocyclic alcohols such as furfuryl alcohol. They can be used singly or in combination thereof. Among the above, the linear type alcohols having 10 to 20 carbon atoms are preferable, and the linear type aliphatic saturated alcohols having 15 to 20 carbon atoms are more preferable.

The copolymerization product between the α-olefin having 5 to 30 carbon atoms and maleic anhydrid in the component (G) is not especially limited. Non-limiting examples include a compound shown by the general formula (XVI) described below, and a compound shown by the general formula (XVII) described below. A commercialized product named Nissan Elector WPB-1 (product name manufactured by the NOF Corporation) is available, whose raw materials are 1-eicosene, 1-docosene and 1-tricosene. 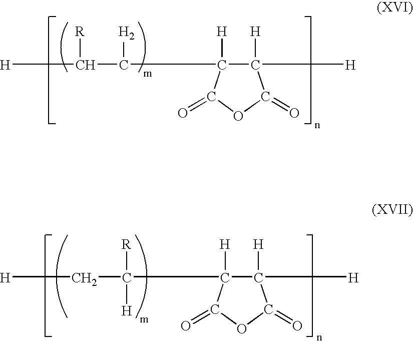
(In these formulas (XVI) and (XVII), R is selected from a monovalent aliphatic hydrocarbon group having 3 to 28 carbon atoms, n is an integer greater than or equal to 1, and m is a positive numeral.)

The letter m in the general formulas (XVI) and (XVII) described above indicates the mol number of α-olefin to be copolymerized per one mol of maleic anhydride. Though there are no specific limitations imposed thereon, m preferably ranges from 0.5 to 10, and a range of 0.9 to 1.1 is more preferable.

There are no specific limitations imposed on the manufacturing method for the copolymerization product of the component (G), and a common polymerization method can be used. An organic solvent in which α-olefin and maleic anhydride can dissolve may be used in the reaction. Though there are no specific limitations imposed on the solvent, toluene is preferable, and other solvents such as alcohol series solvents, ether series solvents, and amine series solvents are also applicable. Reaction temperature, though it varies depending upon the solvent used, is preferably set in a range of 50 to 200° C., and a range of 80 to 120° C. is more preferable, from the viewpoint of reactivity and productivity. Reaction time, which is not especially limited as far as the copolymerization products can be obtained, is preferably 1 to 30 hours, more preferably 2 to 15 hours and further preferably 4 to 10 hours, from the viewpoint of productivity. After the reaction is completed, as the need arises, unreacted materials or solvents, etc. can be removed under conditions of, for example, heat and reduced pressure. As to the conditions thereof, the temperature preferably ranges from 100 to 220° C. and more preferably from 120 to 180° C., the pressure is preferably less than or equal to 13.3×10³ Pa and more preferably less than or equal to 8×10³ Pa, and the time preferably ranges from 0.5 to 10 hours. In addition, a reaction catalyst such as amine series catalysts or acid catalysts or the like may be added as required. The pH value of the reaction system is preferably kept in a range of approximately 1 to 10.

In terms of the esterification method of the copolymerization product described above using a monovalent alcohol having 5 to 25 carbon atoms, there are no specific limitations imposed, and a common method such as an addition reaction of the copolymerization product and monovalent alcohol can be applied. The molar ratio of the reaction between the copolymerization product and the monovalent alcohol has no specific limitations, and can be arbitrarily set up. Since the hydrophilic property of the product can be controlled by adjusting the molar ratio of the reaction, it is preferable that the molar ratio is appropriately set in accordance with the characteristics of the targeting encapsulating epoxy resin composition. An organic solvent, etc. into which the copolymerization product can dissolve may be used for the reaction. As the organic solvent, though there is no limitation, toluene is preferable. Alcohol series solvents, ether series solvents, amine series solvents, etc. may also be usable. The reaction temperature, though it varies according to the kind of organic solvent used, ranges preferably from 50 to 200° C., and more preferably from 80 to 120° C., from the viewpoint of reactivity and productivity. The reaction time, though no specific limitations are imposed, preferably ranges from 1 to 30 hours, more preferably from 2 to 15 hours, and further preferably from 4 to 10 hours, from the viewpoint of productivity. After the reaction is completed, unreacted substances, solvents and the like can be removed, for example, under heat and reduced pressure conditions, as the need arises. As to the reaction conditions, the temperature preferably ranges from 100 to 220° C. and more preferably ranges 120 to 180° C., the pressure is preferably less than or equal to 13.3×10³ Pa, more preferably less than or equal to 8×10³ Pa, and the time is preferably set to be from 0.5 to 10 hours. In addition, a reaction catalyst such as amine series catalysts or acid catalysts may be added as required. The pH value of the reaction system is preferably set in a range of approximately 1 to 10.

As the compounds obtained by the esterification reaction of the copolymerization product made of α-olefin and maleic anhydride with the monovalent alcohol as mentioned above, for example, a compound which has in its constitution one or more repeating units selected from the group consisting of diesters shown by the formula (a) or (b) described below and monoesters shown by the formulas (c) to (f) described below are exemplified. The compound may contain non-esters indicated by the formula (g) or (h). Non-limiting examples of the compounds include:
(1) a compound having a main chain skeleton of a single kind selected from the formulas (a) to (f),
(2) a compound having a main chain skeleton that contains greater than or equal to 2 kinds selected from the formulas (a) to (f) randomly, periodically or in the form of blocks, and
(3) a compound having a main chain skeleton that contains both a kind of or greater than or equal to 2 kinds of the formulas (a) to (f) and at least one of the formulas (g) and (h) randomly, periodically or in the form of blocks. Such compounds can be used singly or in combination thereof.

In addition, either one or both of (4) and (5) may be included; (4) a compound having a main chain skeleton that contains the formulas (g) and (h) randomly, periodically or in the form of blocks; and (5) a compound having a main chain skeleton of a single kind of either the formula (g) or (h). 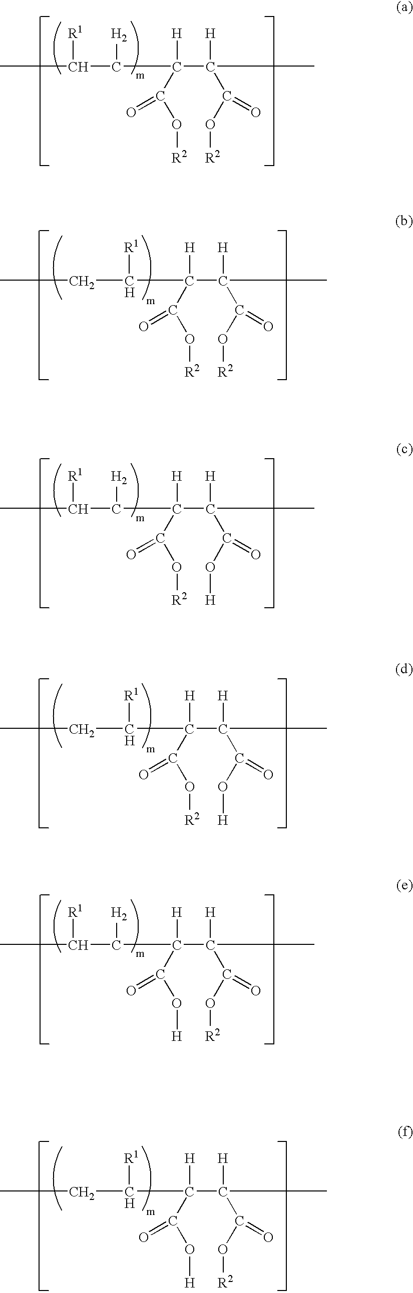 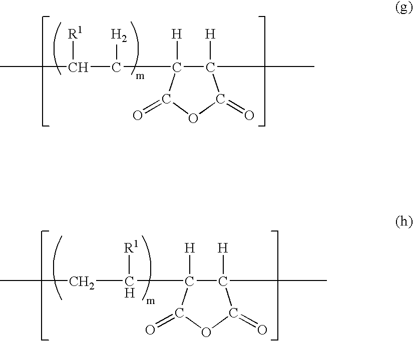
(In the above formulas (a) to (h), R¹ is a monovalent aliphatic hydrocarbon group having 3 to 28 carbon atoms, R² is a monovalent hydrocarbon group having 5 to 25 carbon atoms, and m is a positive integer.)

The letter m in the formulas (a) to (h) indicates a quantity of α-olefin in molar unit for the copolymerization reaction with one mol of maleic anhydride. Though there are no specific limitations imposed on m, a range of m from 0.5 to 10 is preferable, and a range of 0.9 to 1.1 is more preferable.

The mono-esterification ratio of the component (G) may be suitably selected depending upon the combination with the component (F). However, the ratio thereof is preferably greater than or equal to 20% from the viewpoint of mold release properties. As to the component (G), it is preferable to use a compound which contains greater than or equal to 20 mol %, more preferably greater than or equal to 30 mol %, of the summed up amount of one or more monoesters represented by the formulas (c) to (f).

Moreover, the weight average molecular weight of the component (G) preferably ranges from 5,000 to 100,000, more preferably from 10,000 to 70,000, and further preferably from 15,000 to 50,000, from the viewpoint of preventing stain formed on molds and packages and for moldability. The weight average molecular weight of less than 5,000 is prone to be insufficient to prevent stain on molds and packages, but on the other hand, the same being higher than 100,000 is prone to be inferior in kneading properties due to the higher softening point of the compound. Here, the weight average molecular weight refers to the value measured by GPC.

Though the amount to be mixed of the component (G) with respect to the amount of the epoxy resin (A) is not especially limited, an amount greater than or equal to 0.5 wt % is preferable from the viewpoint of mold release properties, an amount less than or equal to 10 wt % is preferable from the viewpoint of reflow resistance, and a range of 1 to 5 wt % is more preferable.

From the viewpoint of reflow resistance and stain on molds and packages, at least any one of the components (F) and (G) both which are mold releasing agents is preferably premixed with a part of or all of the component (A), the epoxy resin, when the epoxy resin composition is prepared. When at least one of the components (F) and (G) is premixed with the component (A), the dispersion thereof in the base resin is improved, consequently the premixing is effective in preventing the decrease in reflow resistance and stain on molds and packages.

The premixing method is not especially limited, and any method may be used as long as at least one of the components (F) and (G) is dispersed in the component (A). For example, a method including stirring at temperatures ranging from room temperature to 220° C. for 0.5 to 20 hours is preferable. From the viewpoint of dispersibility and productivity, the temperature preferably ranges from 100 to 200° C. and more preferably from 150 to 170° C., and the stirring time preferably ranges from 1 to 10 hours, and more preferably from 3 to 6 hours.

At least one of the components (F) and (G) to be premixed may be premixed either with the whole amount of the component (A) or with a part of the component (A). The pre-mixing even with a part of the component (A) can also provide sufficient effects. In this case, the amount of the component (A) to be premixed is preferably from 10 to 50 wt % with respect to the total amount of the component (A).

Further, though the effect of improving dispersion can be obtained by premixing at least one of the components (F) and (G) with the component (A), the premixing of both components (F) and (G) with the component (A) is more preferable for a greater effect. As to the order of the addition of the three components in the premixing, there are no specific limitations imposed, and a simultaneous addition and mixing of the three as well as the addition and mixing of the one of the components (F) and (G) with the component (A) followed by the addition and mixing of the rest of the components may be used.

In the fourth preferred embodiment, a phosphorus atom-containing compound (H) is additionally mixed in order to improve flame resistance. As the component (H), it is preferable to use one or more compounds selected from the group consisting of red phosphorus, phosphate, and a compound containing phosphorus and nitrogen (a compound having a phosphorus-nitrogen(s) bond therein).

When red phosphorus is used, both of a simple substance thereof and a surface coated one with an organic or an inorganic compound can be used. The surface coating of red phosphorus can be conducted by any optional, publicly known way and there is no limitation also on the coating order. Two or more of metal hydroxide, composite metal hydroxide, metal oxide and thermosetting resin can be used at the same time for coating. The non-limiting examples for manufacturing coated red phosphorus are as follows. An aqueous solution of an aqueous soluble metal salt is added into an aqueous suspension of red phosphorus, and metal hydroxide is then absorbed and separated on red phosphorus to coat the surface thereof by a double decomposition of the metal salt and sodium hydroxide or potassium hydroxide, or ammonium bicarbonate. Or, further the above obtained red phosphorus coated with metal hydroxide is heated to convert the metal hydroxide into metal oxide, then the obtained red phosphorus coated with metal oxide is suspended again in water, and the particles of the coated red phosphorus are coated with a thermosetting resin by polymerizing its monomers on the surface of the particles.

Non-limiting examples of thermosetting resins include epoxy resins, urethane resins, cyanate resins, phenol resins, polyimide resins, melamine resins, urea-formaldehyde resins, furan resins, aniline-formaldehyde resins, polyamide resins, and polyamideimide resins, which are publicly known. The monomers or oligomers of the above resins are also applicable, with which polymerization and coating are occurred at the same time, thus forming the above mentioned thermosetting resins as a coating layer. The amount to be mixed of red phosphorus is preferably in a range of 0.5 to 30 wt % to the total amount of the epoxy resin.

From the viewpoint of fluidity, the use of a phosphate as the component (H) is preferable. Since phosphates work as a plasticizer and a flame retardant, the use thereof enables the reduction in the amount to be mixed of the component (C).

Phosphate is an ester compound made of phosphoric acid and alcoholic compound or phenolic compound, and there are no specific limitations imposed thereon. Non-limiting examples thereof include trimethyl phosphate, triethyl phosphate, triphenyl phosphate, tricresyl phosphate, trixylenyl phosphate, cresyldiphenyl phosphate, xylenyldiphenyl phosphate, tris(2,6-dimethylphenyl)phosphate, and aromatic condensed phosphates. Especially, from the viewpoint of hydrolysis resistance, an aromatic condensed phosphate shown by the general formula (XVIII) described below is preferable. 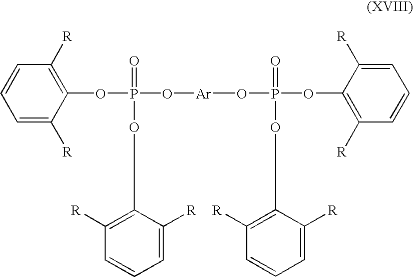
(In the formula (XVIII), R represents an alkyl group having 1 to 4 carbon atoms, all of which may be the same or different to each other, and Ar represents an aromatic group.)

As the phosphate described by the above general formula (XVIII), phosphates described by the structural formula (XIX) described below can be exemplified.

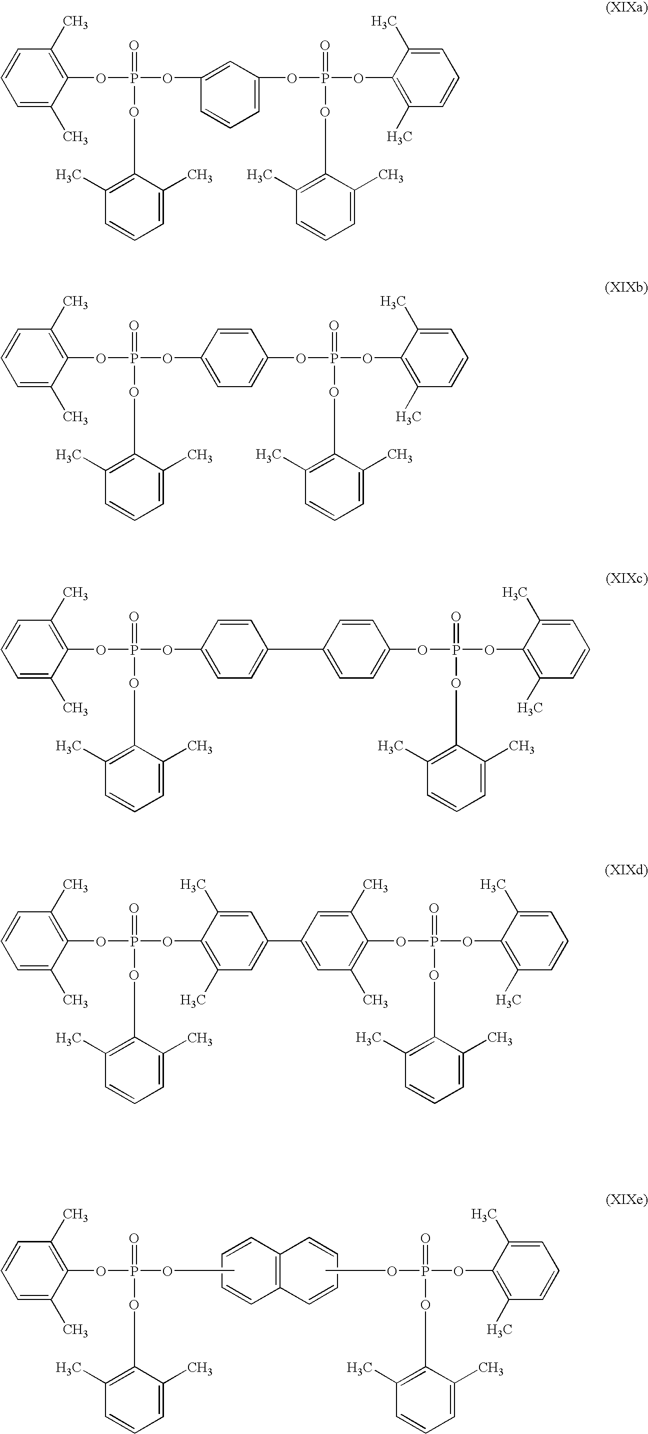

The amount of the phosphate to be added, in terms of the quantity of phosphorus atoms in the total amount of the all components excluding filler, is preferably greater than or equal to 0.2 wt % from the viewpoint of flame resistance effect and preferably less than or equal to 3.0 wt % from the viewpoint of moldability, moisture resistance and appearance. If the amount exceeds 3.0 wt %, the phosphate may sometimes be exuded on molding, harming the appearance. Especially, as the resin composition according to the second aspect mentioned later, when applied to a semiconductor device of thin, high pin count, long wire and narrow pad pitch type, the amount of phosphate is preferably greater than or equal to 0.2 wt %, in order to avoid imperfect molding such as wire sweep and voids due to lowering of fluidity.

As a compound containing phosphorus and nitrogen, cyclophosphazene compounds disclosed in the Japanese Unexamined Patent Publication No. Hei 8(1996)-225714 are exemplified. Specific examples include cyclic phosphazene compounds containing a repeating unit of the following formulas (XXa) and/or (XXb) in the skeletal main chain thereof, and cyclic phosphazene compounds containing a repeating unit in which phosphazene ring is substituted at different positions with respect to phosphorus atoms as shown in the formula (XXc) and/or (XXd).

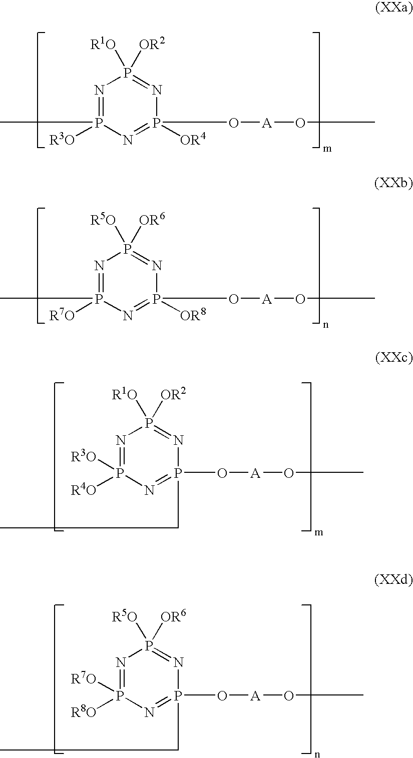

Here, in the formulas (XXa) and (XXc), m is an integer ranging from 1 to 10, R¹ to R⁴ are selected from a substituted or unsubstituted aryl group and alkyl group having 1 to 12 carbon atoms. All of R¹ to R⁴ may be the same or different to each another, but at least one of them has a hydroxyl group. The letter A indicates an alkylene group or an arylene group having 1 to 4 carbon atoms. In the formulas (XXb) and (XXd), the letter n is an integer ranging from 1 to 10, R⁵ to R⁸ are selected from a substituted or unsubstituted alkyl group and aryl group having 1 to 12 carbon atoms, all of R⁵ to R⁸ may be the same or different to each other, and the letter A indicates an alkylene group or an arylene group having 1 to 4 carbon atoms. In addition, R¹, R², R³ and R⁴ in m sets of repeating units may be completely the same or different to each other, and R⁵, R⁶, R⁷ and R⁸ in n sets of repeating units may be completely the same or different to each other.

In the formulas (XXa) to (XXd), non-limiting examples of substituted or unsubstituted alkyl groups or aryl groups having 1 to 12 carbon atoms indicated by R¹ to R⁸ include alkyl groups such as methyl, ethyl, propyl, isopropyl, butyl, isobutyl, sec-butyl, and tert-butyl; aryl groups such as phenyl, 1-naphthyl, and 2-naphthyl; aryl groups substituted with alkyl such as o-tolyl, m-tolyl, p-tolyl, 2,3-xylyl, 2,4-xylyl, o-cumenyl, m-cumenyl, p-cumenyl, and mesityl; and alkyl groups substituted with aryl such as benzyl, and phenetyl. For the substituting groups with which the groups listed above are further substituted, alkyl groups, alkoxy groups, aryl groups, hydroxyl group, amino group, epoxy group, vinyl group, hydroxyalkyl groups, and alkylamino groups are exemplified.

Among the above, from the viewpoint of heat resistance and moisture resistance of the resin composition, aryl groups are preferable, and phenyl and hydroxyphenyl groups are more preferable. Especially, at least one of R¹ to R⁴ is preferably a hydroxyphenyl group, and more preferably, any one of R¹ to R⁴ is a hydroxyphenyl group. All of the R¹ to R⁸ may be hydroxyphenyl groups, but the cured resin composition may become brittle. If all of the R¹ to R⁸ are phenyl groups, heat resistance of the cured resin composition tends to decrease because the compound is not taken into the cross linking structure of the epoxy resin.

Non-limiting examples of alkylene groups and arylene groups having 1 to 4 carbon atoms shown by A in the above mentioned formulas (XXa) to (XXd) include methylene, ethylene, propylene, isopropylene, butylene, isobutylene, phenylene, tolylene, xylylene, and naphthylene. From the viewpoint of heat resistance and moisture resistance of the resin composition, arylene groups are preferable, and phenylene is more preferable.

A cyclic phosphazene compound is a polymer of any one of the above formulas (XXa) to (XXd), a copolymer of the formulas (XXa) and (XXb) or a copolymer of the formulas (XXc) and (XXd). The copolymers may be random copolymers, block copolymers or alternating copolymers. The mole ratio in the copolymer, m/n may, though there is no limitation imposed, preferably range from 1/0 to 1/4, and more preferably from 1/0 to 1/1.5, from the viewpoint of improving heat resistance and strength of the cured resin composition. The polymerization degree, m+n, preferably ranges from 1 to 20, more preferably from 2 to 8, and still more preferably from 3 to 6.

The preferable examples of the cyclic phosphazene compounds include a polymer shown by the following formula (XI) and a copolymer shown by the following formula (XXII).

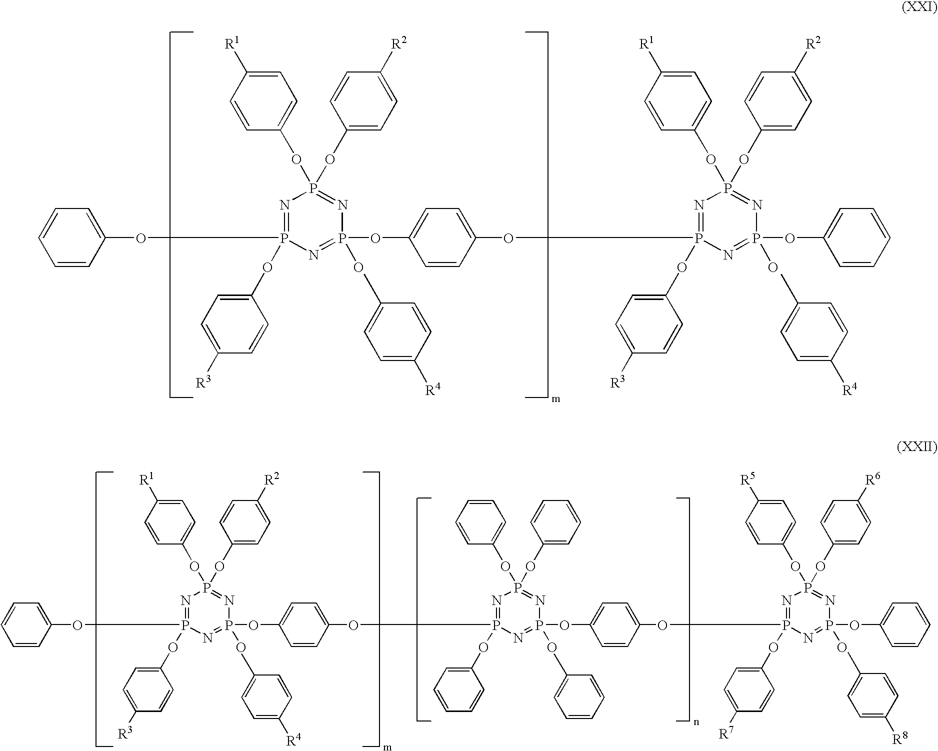

In the formula (XXI), m is an integer ranging from 0 to 9, and R¹ to R⁴ are independently selected from a hydrogen atom and a hydroxyl group. In the formula (XXII), the letters m and n are integers ranging from 0 to 9, and R¹ to R⁴ are independently selected from a hydrogen atom and a hydroxyl group, and at least one of them is a hydroxyl group. R⁵ to R⁸ are independently selected from a hydrogen atom and a hydroxyl group. Moreover, the cyclic phosphazene compound shown by formula (XXII) may be the compound containing, as shown in the following formula (XXIII), m sets of repeating units (a) and n sets of another repeating units (b) alternately, in blocks or randomly. Among the above, the compound containing both units randomly is preferable.

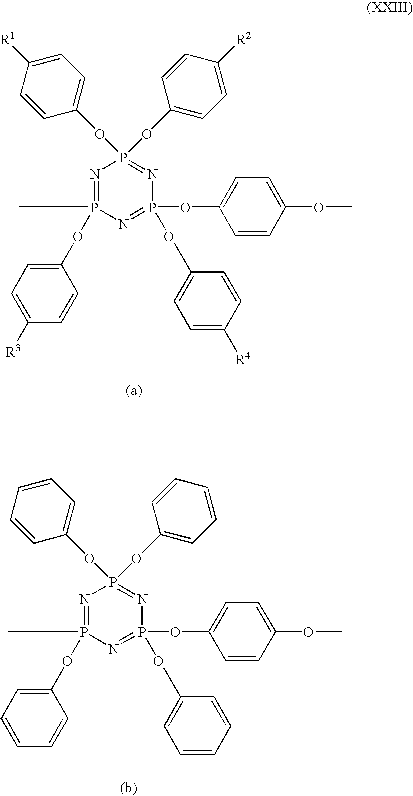

Among the compounds listed above, a preferable one is a compound having as a main component a polymer in which any one of R¹ to R⁴ in the formula (XXI) is hydroxyl and m ranges from 3 to 6, and a compound having as a main component a copolymer in which any one of R¹ to R⁴ in the formula (XXII) is hydroxyl, all of R⁵ to R⁸ are hydrogen or one of R⁵ to R⁸ is hydroxyl, m/n ranges from 1/2 to 1/3 and m+n ranges from 3 to 6. As a commercialized phosphazene compound, SPE-100 (product name manufactured by Otsuka Chemical Co., Ltd.) is available.

In the fifth preferred embodiment, a silane coupling agent (J) having a secondary amino group(s) within the molecule is mixed in the resin composition from the viewpoint of fluidity and mold release properties. Especially, an aminosilane coupling agent represented by the general formula (II) described below is more preferable. 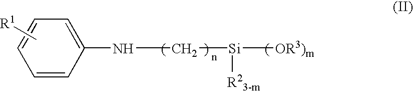
(In the formula (II), R¹ is selected from the group consisting of a hydrogen atom, an alkyl group having 1 to 6 carbon atoms and an alkoxy group having 1 or 2 carbon atoms, R² is selected from an alkyl group having 1 to 6 carbon atoms and a phenyl, R³ indicates methyl or ethyl, n is an integer ranging from 1 to 6, and m is an integer of 1 to 3).

Non limiting examples of the aminosilane coupling agent shown by the general formula (I) described above include γ-anilinopropyltrimethoxysilane, γ-anilinopropyltriethoxysilane, γ-anilinopropylmethyldimethoxysilane, γ-anilinopropylmethyldiethoxysilane, γ-anilinopropylethyldiethoxysilane, γ-anilinopropylethyldimethoxysilane, γ-anilinomethyltrimethoxysilane, γ-anilinomethyltriethoxysilane, γ-aniinomethylmethyldimethoxysilane, γ-anilinomethylmethyldiethoxysilane, γ-anilinomethylethyldiethoxysilane, γ-anilinomethylethyldimethoxysilane, N-(p-methoxyphenyl)-γ-aminopropyltrimethoxysilane, N-(p-methoxyphenyl)-γ-aminopropyltriethoxysilane, N-(p-methoxyphenyl)-γ-aminopropylmethyldimethoxysilane, N-(p-methoxyphenyl)-γ-aminopropylmethyldiethoxysilane, N-(p-methoxyphenyl)-γ-aminopropylethyldiethoxysilane, and N-(p-methoxyphenyl)-γ-aminopropylethyldimethoxysilane. Especially, γ-anilinopropyltrimethoxysilane is preferably used.

Non-limiting examples of the component (E) other than the one described by the above general formula (I) include γ-(N-methyl)aminopropyltrimethoxysilane, γ-(N-ethyl)aminopropyltrimethoxysilane, γ-(N-butyl)aminopropyltrimethoxysilane, γ-(N-benzyl)aminopropyltrimethoxysilane, γ-(N-methyl)aminopropyltriethoxysilane, γ-(N-ethyl)aminopropyltriethoxysilane, γ-(N-butyl)aminopropyltriethoxysilane, γ-(N-benzyl)aminopropyltriethoxysilane, γ-(N-methyl)aminopropylmethyldimethoxysilane, γ-(N-ethyl)aminopropylmethyldimethoxysilane, γ-(N-butyl)aminopropylmethyldimethoxysilane, γ-(N-benzyl)aminopropylmethyldimethoxysilane, N-β-(aminoethyl)-γ-aminopropyltrimethoxysilane, γ-(β-aminoethyl)aminopropyltrimethoxysilane, and N-β-(N-vinylbenzylaminoethyl)-γ-aminopropyltrimethoxysilane.

When the component (J) is mixed into the resin composition, the adhesion between the essential components and the optional components such as the filler improves and consequently the functions and the effects of the essential and optional components can appropriately be exhibited. Especially among the optional components, from the viewpoint of obtaining the function and effect of the component (D) appropriately, the components (J) and (D) are preferably used in combination.

The amount to be mixed of the component (J) preferably ranges from 0.037 to 4.75 wt % and more preferably from 0.088 to 2.3 wt %, with respect to the total amount of the resin composition, from the viewpoint of moldability and adhesion to a frame. In the case that the inorganic filler of the component (D) is added, the amount to be mixed of the component (J) is preferably in a range of 0.05 to 5 wt % and more preferably in a range of 0.1 to 2.5 wt %, with respect to the amount of the inorganic filler, from the viewpoint of moldability and adhesion to a frame. In the case that another kind of coupling agent are used in addition to the above, the amount to be mixed of the component (J) is preferably greater than or equal to 30 wt %, and more preferably greater than or equal to 50 wt %, with respect to the total amount of coupling agents, in order to obtain its effects.

The mold release force under shearing can be adjusted using different combinations of the components and controlling their amounts to be mixed, for example, as follows; the use of composite metal hydroxide of the component (C), reduction in the amount of the component (C) by using another kind of non-halogenated and non-antimony flame retardant such as phosphorus atom-containing compound of the component (H), the use of a mold releasing agent, the use of an increased amount of a mold releasing agent, especially, the simultaneous use of the components (F) and (G), and the like.

In the sixth preferred embodiment, the resin composition is such that an extract water which is obtained by extracting ions from a mixture containing 1 g of crushed pieces of a molded article made of the resin composition per 10 ml of water has a concentration of sodium ion ranging from 0 to 3 ppm, a concentration of chloride ion ranging from 0 to 3 ppm, an electric conductivity less than or equal to 100 μS/cm, and a pH value ranging from 5.0 to 9.0.

Various improvements using non-halogenated and non-antimony flame retardants have been contemplated heretofore. However, criteria for obtaining necessary moisture resistance by applying the individual components have not been clarified so far, for example, the criterion for coating materials and for thickness of the coated layer when covering red phosphorus surface with a resin or an inorganic compound, the criterion for the amount of an ion scavenger when using the same together with a phosphate compound and a phosphazene compound, and the criterion for the amount to be mixed of a metal hydroxide flame retardant when using the same. Because of this, it has been not possible to evaluate moisture resistance unless evaluation of reliability that required long period of time such as several hundreds to several thousands of hours was conducted using an actual resin composition. Thus, the problem of evaluation has been an obstacle to the development of products. Accordingly, the sixth preferred embodiment is to provide an accessible index for the evaluation of moisture resistance.

Here, the extract water is obtained as follows. A molded article made of the resin composition is crushed to pieces, and the crushed pieces are put in water in such an amount that the water contains 1 g of the crushed pieces per 10 ml. The water extraction is conducted to extract ions from the crushed pieces under conditions of 121° C. and 2 atmospheric pressures until the extracted ion concentration reaches to a saturated value. The extract water is thus prepared. As a crushing method, any publicly known method by means of ball mill, satellite mill, cutter mill, stone mill, automatic mortar, etc. is applicable. Among the above, ball mill and satellite mill are preferable since they are easy to handle and can reduce contamination of the extract water by foreign materials. In terms of the crushed pieces, particles having a diameter exceeding a given value are preferably removed using a sieve in order to maintain constant conditions of efficiency in extraction.

Though any publicly known extraction method can be used, it is important that the sample or water are not scattered and lost during the extraction. Any vessel can be used for extraction as long as it can bear conditions of 121° C. and 2 atmospheric pressures. It is preferable that a vessel is pressure tight and whose inside is lined with an inert material, because contamination by impurities from the vessel can be minimized. In terms of a lining that satisfies the above conditions, processing using a fluorocarbon resin is listed.

The quantity of the extracted ions increases with extraction time, and gradually the increase in the extracted quantity slows down. When a certain time is reached, the extracted quantity ceases to increase. This state is defined as a saturated quantity. The time taken to reach the saturated quantity differs to some extent according to the particle size of the crushed pieces, that is, the larger the content of larger radius particles, the longer the time taken to reach the saturated quantity. As to the sample fractionated using a 100 mesh sieve, the extracted concentration reaches the saturated quantity within 12 hours.

It is necessary to use high purity water for the extraction. Because the extracted ion concentration is several tens to several hundreds of ppm, the purity of water must be at least such that; each of chloride ion (Cl⁻), sodium ion (Na⁺), orthophosphate ion (PO₄³⁻), phosphite ion (HPO₃²⁻), and hypophosphite ion (H₂PO₂⁻) is in the order of 10⁻¹ ppm or less, and electric conductivity is in the order of several μS/cm or less. For a method of preparing pure water mentioned above, a publicly known method such as ion exchange and distillation is available, but it is recommended to proceed with the operation carefully so as not to mix in impurities.

In terms of the quantitative determination of ion concentration contained in the extract water, publicly known methods are available, including a method in which ions to be measured being reacted to produce an insoluble salt precipitate and weighing the precipitate, a titration method using an indicator, and a method comparing sample dimension and reference material dimension of ion chromatogram spectrum.

If the concentration of the above mentioned sodium ion (Na⁺) and chloride ion (Cl⁻) in the extract water exceeds 3 ppm, moisture resistance of the molded article tends to decrease, which tends to cause movement trouble due to wire corrosion in IC's. The concentration of chloride ion in the extract water is in a range of 0 to 3 ppm, and preferably of 0 to 2 ppm. If the chloride ion concentration exceeds 3 ppm, the molded article absorbs moisture, and corrosion of IC's wires proceeds in a short period of time, causing problems in practical use. The sodium ion concentration in the extract water ranges from 0 to 3 ppm, preferably ranging from 0 to 2 ppm. The electric conductivity of the extract water ranges from 0 to 100 μS/cm, preferably ranging from 0 to 50 μS/cm. If the electric conductivity exceeds 100 μS/cm, or if the sodium ion concentration exceeds 3 ppm, noises, cross talk, or voltage off-set occurs due to the increase in electric current leakage, or the corrosion of IC's wiring occurs, causing adverse effects to the circuit operation.

The pH value of the extract water ranges from 5.0 to 9.0. If the pH value is below this range, the corrosion in metal wirings of IC, especially in aluminum wirings and the like, may become remarkable. On the other hand, if the pH value is above this range, the surface of the package tends to turn white in a plating process for lead frame, causing inferior external appearance, or tends to cause corrosion of IC's wirings. A preferable range of the pH value is from 6.0 to 8.0.

In the sixth preferred embodiment, the phosphorus atom-containing compound of the component (H) is preferably contained in the resin composition for flame resistance. In this case, the total concentrations of orthophosphate ions (PO₄³⁻), phosphite ions (HPO₃²⁻) and hypophosphite ions (H₂PO₂⁻) (hereinafter named as “total phosphate ion concentration”) in the extract water preferably ranges from 0 to 30 ppm, more preferably ranging from 0 to 20 ppm. In order to suitably apply the resin composition to an apparatus used in a place without humidity control such as electronic apparatuses and vehicle equipments which are used out of doors, the total phosphate ion concentration is preferably less than or equal to 20 ppm. If the total phosphate ion concentration exceeds 30 ppm, the molded article made of the resin composition absorbs moisture, thus the corrosion of the IC's wirings progresses in a short period of time, and in addition, an electrode reaction occurs when electric voltage is applied to a circuit, causing disadvantages such as corrosion and metal precipitation. Since the voltage excepting electric power use is usually applied to a semiconductor circuit in the form of direct current, the electrode reaction mentioned above causes a continuous precipitation of metal on the same place, thus causing eventually short-circuit between electrodes, and damaging the function of circuit.

In the case where coated red phosphorus is used as the component (H), regardless of whether the coating material is organic or inorganic, the coating is preferably conducted with one or more materials selected from the group consisting of a metal hydroxide, a metal oxide, a composite metal hydroxide and a thermosetting resin, because it is easier to control the electric conductivity and pH of the extract water and the total phosphate ion concentration in the extract water within the range mentioned above. The amount to be mixed of red phosphorus is preferably in a range of 0.5 to 30 wt % with respect to the total amount of the epoxy resin. If the amount to be mixed is less than 0.5 wt %, it is difficult to obtain a required level of flame resistance. If the amount to be mixed exceeds 30 wt %, it is difficult to control the electric conductivity, the pH value and the total phosphate ion concentration within the requested range.

When phosphate is used as the component (H), any chemical structure thereof is acceptable. For example, phosphates listed above are applicable. Among them, aromatic phosphates are preferable in order to easily control the electric conductivity, pH, and the total phosphate ion concentration within the above described range. In addition, the use of the compound containing a phosphorus-nitrogen bond(s) mentioned above is preferable.

Both the hardening accelerator (E) containing phosphorus atom, which belongs to the compound containing phosphorus atom of the component (H), and the hardening accelerator (E) not containing phosphorus atom may be used simultaneously. At least one of the two, an adduct of phosphine compound and quinone compound and diazabicycloundecene phenolnovolak resin salt, is preferably contained.

The purpose in mixing the component (C) in the sixth embodiment is, in addition to impart flame resistance, to prevent the corrosion of internal metal wirings and to improve moisture resistance, by suppressing isolation and dissolution of ions eluted from the components, or by adsorbing the isolated and dissolved ions. Though there is no limitation imposed on the component (C), the compound shown by the above composition formula (C-I) is preferable. The amount to be mixed thereof is adjustable so as to maintain the ion concentration in the extract water within the range mentioned above. Generally, the amount to be mixed relative to 100 parts by weight of the epoxy resin is preferably greater than or equal to 0.5 parts by weight from the viewpoint of moisture resistance, and preferably less than or equal to 500 parts by weight from the viewpoint of fluidity, hardness and productivity.

When the component (C), composite metal hydroxide, is used in order to impart flame resistance, the amount to be mixed of the component (C) generally ranges from 10 to 500 parts by weight relative to 100 parts by weight of the epoxy resin when applied singly. When applied together with red phosphorus, the amount to be mixed of the component (C) generally ranges from 0.5 to 200 parts by weight relative to 100 parts by weight of the epoxy resin. When used together with phosphate or the compound containing phosphorus-nitrogen bond, the amount to be mixed of the component (C) generally ranges from 1 to 300 parts by weight relative to 100 parts by weight of the epoxy resin.

In the seventh preferred embodiment, especially when the resin composition is applied to a semiconductor device of thin, high pin count, long wire and narrow pad pitch type, such as the resin composition according to the second aspect mentioned later, a melt viscosity of the component (A), epoxy resin, at 150° C. is preferably less than or equal to 2 poise, more preferably less than or equal to 1 poise, and further preferably less than or equal to 0.5 poise, from the viewpoint of fluidity. Here, the melt viscosity denotes the viscosity measured by ICI cone plate viscometer (hereinafter, ICI viscosity). In addition, the melt viscosity of the component (B), curing agent, at 150° C. is preferably less than or equal to 2 poise, and more preferably less than or equal to 1 poise, from the viewpoint of fluidity.

In the preferred embodiments, the resin composition according to the present invention may optionally include the components described below in addition to the components described above.

(1) Flame Retardant

In addition to the above described composite metal hydroxide of the component (C), in order to improve flame resistance, a flame retardant, which is a non-halogenated and non-antimony component publicly known heretofore, may be mixed as required. Non-limiting examples include the compounds of the component (H) mentioned above; nitrogen containing compounds such as melamine, melamine derivatives, melamine-modified phenol resins, compounds containing triazine ring, cyanuric acid derivatives, and isocyanuric acid derivatives; and compounds including metal element(s) such as aluminum hydroxide, magnesium hydroxide, zinc oxide, zinc stannate, zinc borate, ferrous/ferric oxide, molybdenum oxide, zinc molybdate, and ferrous/ferric dicyclopentadienyl. They can be used singly or in combination thereof.

Among the above, inorganic frame retardants may preferably have a coating made of an organic material in order to improve their dispersibility in the resin composition, to prevent decomposition due to moisture absorbance, and to improve curing properties, and the like.

(2) Ion Scavenger (Anion Exchanger)

From the viewpoint of improving moisture resistance and high temperature storage property of semiconductor devices such as ICs, an ion scavenger (anion exchanger) may be mixed thereto as required. All publicly known ion scavengers are applicable with no special limitation thereof. Non-limiting examples include hydrotalcites and hydrate oxides of the element selected from magnesium, aluminum, titanium, zirconium, and bismuth. They can be used singly or in combination. Among the above, a hydrotalcite shown by the chemical composition formula (C-III) described below is preferable.
Mg₁₋ₓAlₓ(OH)₂(CO₃)_{x/2}.mH₂O (C-III)
(In the formula (C-III), 0<x≦0.5, and m is a positive numeral)

Though the amount to be mixed of the ion scavenger with respect to the amount of the epoxy resin of component (A) is not specifically limited as far as the amount thereof is enough to capture anions such as halogen ions, an amount ranging from 0.1 to 30 wt % is preferable, the same ranging from 0.5 to 10 wt % is more preferable, and the same ranging from 1 to 5 wt % is further preferable.

(3) Coupling Agent

In order to improve the adhesion between the resin component and inorganic filler, a coupling agent other than the component (J) described above may be used together with the component (J) or singly, if necessary. Examples of such coupling agent include different kind of silane compounds such as epoxy silane, mercapto silane, amino silane, alkyl silane, ureido silane and vinyl silane, titanium compounds, aluminum chelate compounds, and aluminum/zirconium compounds. A silane compound containing a primary amino group(s) and/or tertiary amino group(s) may be usable. Preferable amount to be mixed of the coupling agent is the same as in the component (J) mentioned above, in both cases in which the inorganic filler is contained and in which the same is not contained, respectively.

Non-limiting examples of the coupling agent described above include silane series coupling agents such as vinyltrichlorosilane, vinyltriethoxysilane, vinyltris(β-methoxyethoxy)silane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldimethoxysilane, vinyltriacetoxysilane, γ-mercaptopropyltrimethoxysilane, γ-aminopropyltriethoxysilane, γ-[bis(β-hydroxyethyl)]aminopropyltriethoxysilane, N-β-(aminoethyl)-γ-aminopropyltrimethoxysilane, γ-(β-aminoethyl)aminopropyldimethoxymethylsilane, N-(trimethoxysilylpropyl)ethylenediamine, N-(dimethoxymethylsilylisopropyl)ethylendiamine, methyltrimethoxysilane, dimethyldimethoxysilane, methyltriethoxysilane, N-β-(N-vinylbenzylaminoethyl)-γ-aminopropyltrimethoxysilane, γ-chloropropyltrimethoxysilane, hexamethyldisilane, vinyltrimethoxysilane, and γ-mercaptopropylmethyldimethoxysilane; titanate series coupling agents such as isopropyltriisostearoyl titanate, isopropyltris(dioctylpyrophosphate) titanate, isopropyltri(N-aminoethyl-aminoethyl)titanate, tetraoctylbis(ditridecylphosphite)titanate, tetra(2,2-diallyloxymethyl-1-butyl)bis(ditridecyl)phosphite titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropyltridodecylbenzenesulfonyl titanate, isopropylisostearoyldiacryl titanate, isopropyltri(dioctylphosphate) titanate, isopropyltricumenylphenyl titanate, and tetraisopropylbis(dioctylphosphite)titanate. They can be used singly or in combination thereof.

(4) Other Additives

Other additives may be mixed as required, for example; mold releasing agent such as high fatty acid, metal salt of high fatty acid, ester series wax, polyolefin series wax, polyethylene, and oxidized polyethylene; coloring agent such as carbon black; and stress relaxation agent such as silicone oil, and silicone rubber powder.

The resin composition of the present invention can be prepared by any method as long as each raw material can be uniformly dispersed and mixed. As a general method, a method in which raw materials of predetermined amount are thoroughly mixed by a mixer or the like, and fused and kneaded with mixing rolls, extruders and the like followed by cooling and crushing into powder can be exemplified. For easier handling, it is preferable to prepare a tablet with appropriate size and weight corresponding to molding conditions.

According to the third aspect of the present invention, there is provided an electronic parts device comprising an elemental device encapsulated with the resin composition according to the present invention.

Non-limiting examples of electronic parts devices include ones which load elemental device(s) such as active devices (for example, semiconductor chip, transistor, diode, and thyristor) and passive devices (for example, capacitor, resistance, and coil) onto a supporting member (for example, lead frame (island or tub), wired tape carrier, wiring substrate, glass, and silicon wafer) or on a mounting substrate, and whose necessary part(s) is encapsulated with the resin composition of the present invention. There are no limitations imposed on the mounting substrate, and non-limiting examples include interposer substrate such as organic substrate, organic film, ceramic substrate, and glass substrate, glass substrate for LCD, MCM (Multi Chip Module) substrate, and hybrid IC substrate.

As an encapsulating method using the resin composition, a low pressure transfer molding method is the most widespread. However, injection molding method or compression molding method may also be used.

Concretely, non-limiting examples of electronic parts device of the present invention include; common resin encapsulated type ICs such as DIP (Dual Inline Package), PLCC (Plastic Leaded Chip Carrier), QFP (Quad Flat Package), SOP (Small Outline Package), SOJ (Small Outline J-lead Package), TSOP (Thin Small Outline Package), and TQFP (Thin Quad Flat Package), in which elemental devices are fixed on the lead frame and the terminals of the devices such as bonding pads and the leads are connected by wire bonding or bumps, then the devices are encapsulated, for example, by transfer molding, with the resin composition of the present invention; TCP (Tape Carrier Package) which has semiconductor chips connected to a tape carrier with bump(s) and encapsulated with the resin composition of the present invention; COB (Chip On Board) module comprising active devices such as semiconductor chips, transistors, diodes, and thyristor, and/or passive devices such as capacitor, resistance, and coil, which are connected by, for example, wire bonding, flip chip bonding, and solders with wires formed on wiring substrate or glass plate, and encapsulated with the resin composition of the present invention; COG (Chip on Glass) module; hybrid IC; MCM (multi-chip module); BGA (Ball Grid Array) comprising elemental devices mounted onto the surface of an organic substrate comprising terminals for substrate wiring on the opposite side, which are connected with wires formed on the organic substrate with bumps or wire bonding and encapsulated with the resin composition of the present invention; CSP (Chip Size Package); and MCP (Multi Chip Package). Moreover, the resin composition can also effectively be used for printed wiring substrates.

The electronic parts device is preferably a semiconductor device that includes one or more features (a) to (f) mentioned later. In addition, the semiconductor device may be a stacked type package in which 2 or more elemental devices are stacked on a mounting substrate, or a mold array package in which 2 or more elemental devices are encapsulated at the same time with the resin composition.

These days, high density mounting of electronic parts onto printed interconnecting substrates has been progressing. Along with this development, semiconductor devices have moved from pin insertion packages to surface mount packages which have become mainstream. In terms of IC, LSI and the like which belong to surface mount packages, packages have been getting thinner and smaller. The occupied volume ratio of the elemental devices relative to the package has been getting bigger, and the thickness of the package has been getting thinner, in order to heighten the mounting density and to lower the mounting height. In addition, along with the progress in high pin count and a large capacity, the chip area has been expanding and the pin count has been increasing. Moreover, the number of pads (electrodes) has been increasing, thereby shortening the pad pitch and pad size, namely narrowing pad pitch.

Moreover, in order to meet the demand for a smaller and lighter package, the form of the package has been moving from QFP (Quad Flat Package), SOP (Small Outline Package) and the like to CSP (Chip Size Package) and BGA (Ball Grid Array) which are easier to meet the demand for high pin count and high density. Packages having a new structure such as face down type, stacked type, flip chip type and wafer-level type have been developed in order to realize speeding up and multiple functions. Among the above, the stacked type package has a structure having a plurality of stacked chips connected with one another by wire bonding inside the package, thus a plurality of chips serving different functions can be mounted inside a single package so as to perform multiple functions.

In addition, with regard to the process for preparing CSP and BGA, instead of the conventional encapsulating method for one chip in one cavity, an encapsulating method for a plurality of chips in one cavity, so called, a mold array type encapsulating method has been developed. Thus, improvements in productivity and lower costs have been attained.

On the other hand, the encapsulating material is required to satisfy the increasing need for reflow resistance exhibited when applied to the surface mount of the semiconductor device onto the printed wiring substrate, and temperature cycle resistance which is requested in terms of reliability after mounting. Accordingly, lowering the viscosity of the resin and thus increasing the filler content have been practiced in order to impart lower moisture absorbance and lower expansion. However, when a conventional encapsulating material is used, imperfect molding such as inferior mold release such as gate break and sticking to a mold, wire sweep and voids frequently occurs. Therefore, preparing a semiconductor device satisfying the demand for thinner package, larger chip area, increasing pin count, narrower pad pitch has been difficult.

Several improvements in the encapsulating material have been attempted in order to satisfy the demand mentioned above, but appropriate results have not been achieved as yet. Moreover, in terms of the semiconductor devices such as the stacked type CSP in which long wires are applied, and the mold array package type device having a larger cavity volume, the encapsulating material is required to have a better mole release properties.

The resin composition according to the present invention which contains the components (A) to (C) and has a mold release force under shearing after 10 shots of molding which is less than or equal to 200 KPa can satisfy such demands and preferably be applied to seal a semiconductor device of thin, high pin count, long wire and narrow pad pitch type, or to seal a semiconductor device in which semiconductor chip(s) are disposed onto a mounting substrate such as organic substrate and organic film.

Therefore, according to the second aspect of the present invention, there is provided an encapsulating epoxy resin composition according to the present invention for encapsulating a semiconductor device having at least one of features including:
(a) at least one of an encapsulating material of an upper side of a semiconductor chip and an encapsulating material of a lower side of the semiconductor chip has a thickness less than or equal to 0.7 mm;
(b) a pin count is greater than or equal to 80;
(c) a wire length is greater than or equal to 2 mm;
(d) a pad pitch on the semiconductor chip is less than or equal to 90 μm;
(e) a thickness of a package, in which the semiconductor chip is disposed on a mounting substrate, is less than or equal to 2 mm; and
(f) an area of the semiconductor chip is greater than or equal to 25 mm².

Preferably, the semiconductor device described above has the features according to the following (1) or (2):
(1) (a) or (e);
(2) (a) and at least one feature selected from (b) to (f).

More preferably, the semiconductor device has the features according to any one of the following combinations (1) to (3):
(1) (b) and (c);
(2) (b) and (d); and
(3) (b), (c) and (d).

Further preferably, the semiconductor device has the features according to any one of the following combinations (1) to (9):
(1) (a) and (b);
(2) (a) and (c);
(3) (a) and (d);
(4) (a) and (D;
(5) (c) and (e);
(6) (a), (b) and (d);
(7) (c), (e) and (f);
(8) (a), (b), (d) and (f); and
(9) (a), (b), (c) and (d).

Namely, from the viewpoint of ensuring fewer voids and improving mold release properties, the resin composition is preferably applied to a semiconductor device having one or more features selected from (a), (c), (d) (e) and (f), and more preferably having (a) or (e). From the viewpoint of suppressing the decrease in reliability caused by mold release stress, the resin composition is more preferably applied to a semiconductor device having the features (a) and one or more of the features (b) to (f).

From the viewpoint of reducing wire sweep and improving mold release properties, the resin composition is preferably applied to a semiconductor device having the features (b) and (c), or (d), more preferably having (b), further preferably having (b) and (c), or (b) and (d), and still further preferably having (b), (c) and (d).

From the viewpoint of ensuring fewer voids, reducing wire sweep and improving mold release properties, the resin composition is preferably applied to a semiconductor device having features (a) and (b), (a) and (c), (a) and (d), (a) and (f), or (c) and (e), more preferably having (a), (b) and (d), or (c), (e) and (f), and further preferably having (a), (b), (d) and (f), or (a), (b), (c) and (d).

As the semiconductor device mentioned above, such ones listed as examples according to the third aspect of the present invention are preferable. They may be of stacked type or mold array type.

Hereinafter, specific explanation will be made on a constitution of the semiconductor device referring to figures which show non-limiting examples. The same reference numerals will be used to designate the components having the same function respectively, so that the description will be omitted in each drawing.

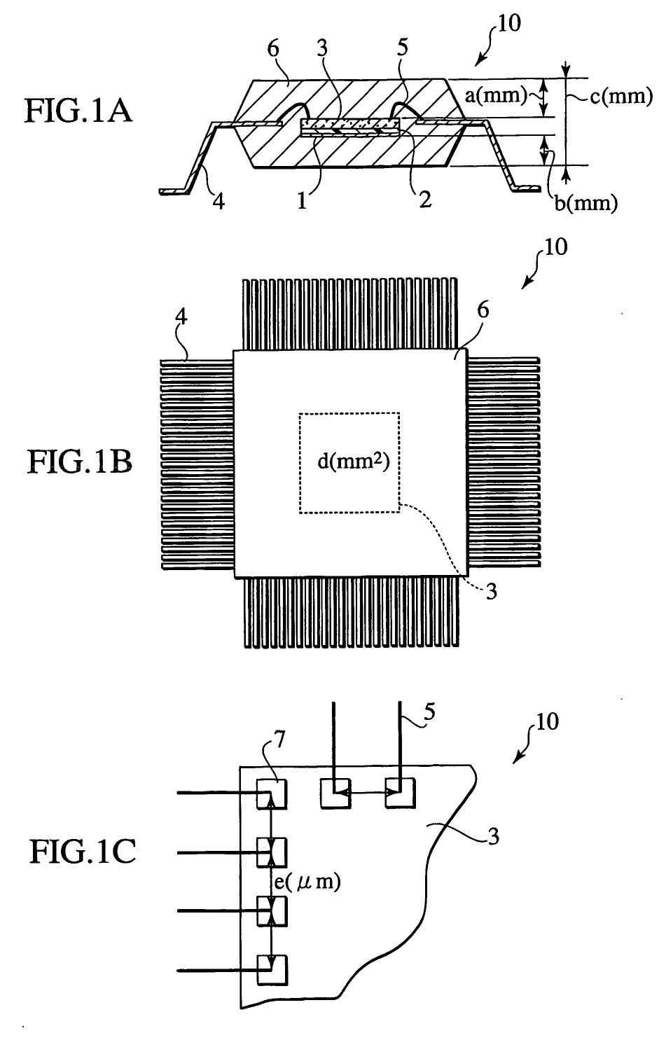

FIGS. 1A to 1C show a QFP 10 encapsulated with a resin composition 6 (encapsulating material). In detail, a semiconductor chip 3 is fixed on an island (a tab) 1 with a die attach 2. After connecting (wire bonding) terminal portions (bonding pads) 7 of the semiconductor chip 3 and lead pins 4 by wires 5, the members above are encapsulated with the encapsulating material 6. FIG. 1A shows a cross sectional view, FIG. 1B shows a top view (partly perspective view), and FIG. 1C shows an enlarged top view (partly perspective view) of the terminal portions 7 of the semiconductor chip 3.

In terms of a semiconductor device 10, at least one of the thickness of encapsulating material “a” of the upper side of the chip 3 and “b” of the lower side of the chip 3 is preferably less than or equal to 0.7 mm, more preferably less than or equal to 0.5 mm, still more preferably less than or equal to 0.3 mm, and most preferably less than or equal to 0.2 mm.

The thickness “c” of the package (the total thickness of the semiconductor device 10) is preferably less than or equal to 2.0 mm, more preferably less than or equal to 1.5 mm, still more preferably less than or equal to 1.0 mm, and most preferably less than or equal to 0.5 mm.

The area “d” of the chip 3 is preferably greater than or equal to 25 mm², more preferably greater than or equal to 30 mm², still more preferably greater than or equal to 50 mm², and most preferably greater than or equal to 80 mm².

In addition, the semiconductor device 10 is preferably of the high pin count type semiconductor device having greater than or equal to 80 pins as to the lead pins 4, more preferably 100 pins or greater, even more preferably 180 pins or greater, still more preferably 200 pins or greater, and most preferably 250 pins or greater.

The length of wire 5 connecting the semiconductor chip 3 and the lead pins 4 is preferably greater than or equal to 2 mm, more preferably 3 mm or greater, even more preferably 4 mm or greater, still more preferably 5 mm or greater, and most preferably 6 mm or greater.

The pad pitch “e” between bonding pads 7 on the semiconductor chip 3 is preferably less than or equal to 90 μm, more preferably 80 μm or less, even more preferably 70 μm or less, still more preferably 60 μm or less, and most preferably 50 μm or less.

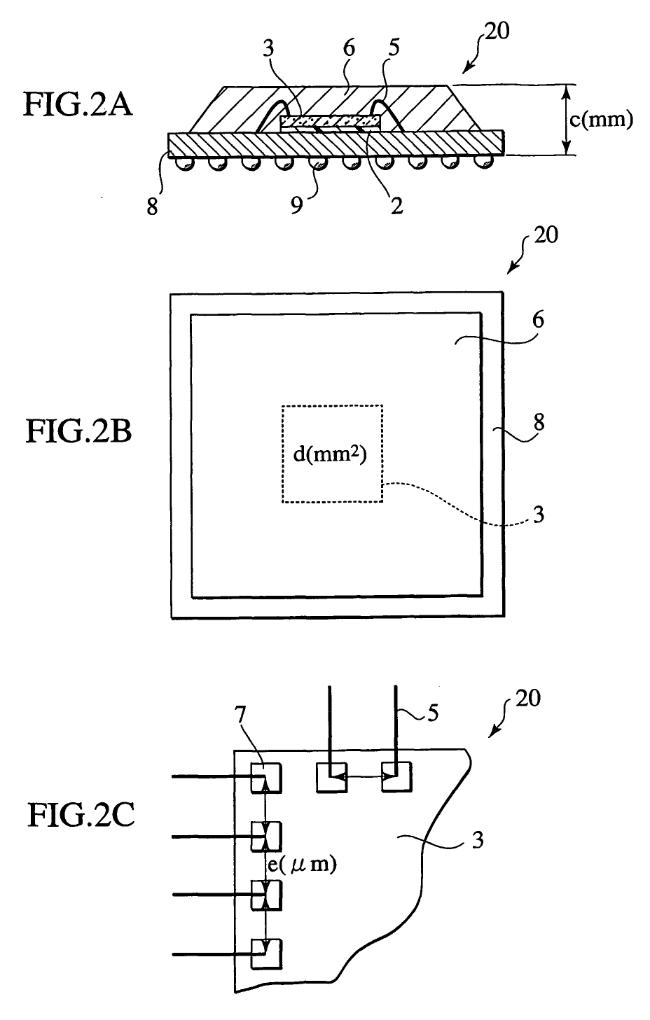

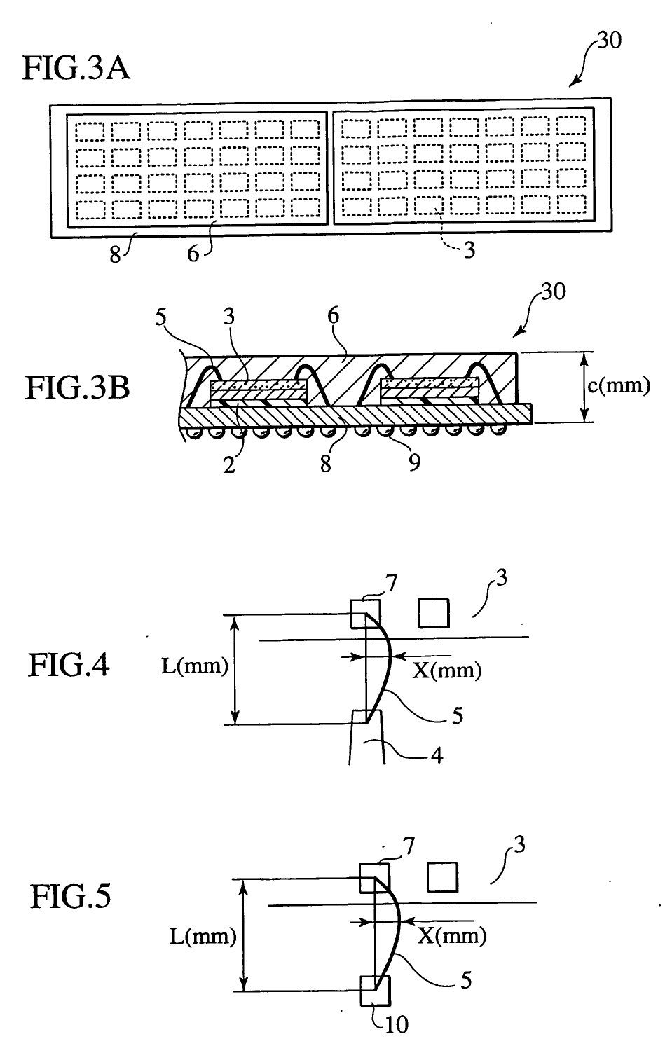

FIGS. 2A to 2C show a BGA 20 encapsulated with a resin composition 6 (encapsulating material). In detail, a semiconductor chip 3 is fixed on an insulated base substrate 8 with a die attach 2. After connecting terminal portions 7 of the semiconductor chip 3 with terminal portions on the substrate 8 by wires 5, the members above are encapsulated with the encapsulating material 6. FIG. 2A shows a cross sectional view, FIG. 2B shows a top view (partially perspective view), and FIG. 2C shows an enlarged view of the bonding pad portion. In FIG. 2A and FIG. 3B below, reference numeral 9 denotes a solder ball.

FIGS. 3A and 3B show a stacked type BGA of the mold array package type. FIG. 3A is a top view (partly perspective view), and FIG. 3B is a partially enlarged cross sectional view.

Also in the semiconductor device 20 shown in FIGS. 2A to 2C and in the semiconductor device 30 shown in FIGS. 3A and 3B, respective preferable values of the package thickness “c”, the area “d” of the semiconductor chip 3, the length of the wire 5, and the pad pitch “e” are the same as explained in FIGS. 1A to 1C.

The resin composition according to the present invention can achieve flame resistance with non-halogenated and non-antimony conditions. When using the resin composition to seal electronic parts such as IC and LSI, it is possible to seal them with good fluidity and moldability, thus obtaining products such as electronic parts devices having an excellent reliability, for example, reflow resistance, moisture resistance and high temperature storage property. Accordingly, the resin composition is industrially of great value.

By encapsulating electronic parts with the resin composition according to the present invention, it is possible to reduce the occurrence of imperfect molding such as gate break and sticking to a mold, even when used for a thin type semiconductor device having the above mentioned thickness of the encapsulating material, a semiconductor device having the above mentioned thickness of the encapsulating material and chip area, and a semiconductor device having the above mentioned pin count, wire length and pad pitch.

Next, the present invention will be described according to its examples. However, the scope of the present invention should not be limited to the examples described below.

### EXAMPLES

The mixed components, evaluated items and evaluation methodologies applied are described below. In the examples described below, the molding of the resin compositions were implemented by a transfer molding machine at a mold temperature of 180° C., under a molding pressure of 6.9 MPa, and for a curing time of 90 sec. Post curing was conducted at 180° C. for 5 hours.

[Mixed Components]

Epoxy Resin

Epoxy resin (1): biphenyl type epoxy resin having an epoxy equivalent of 192 and a melting point of 105° C. (Product name is Epicoat YX-4000H manufactured by Yuka-Shell Epoxy Co., Ltd.)

Epoxy resin (2): stilbene type epoxy resin having an epoxy equivalent of 210 and a softening point of 130° C. (Product name is ESLV-210 manufactured by Sumitomo Chemical Co., Ltd.)

Epoxy resin (3): orthocresolnovolak type epoxy resin having an epoxy equivalent of 195 and a softening point of 65° C. (Product name is ESCN-190 manufactured by Sumitomo Chemical Co., Ltd.)

Epoxy resin (4): sulfur atom containing epoxy resin having an epoxy equivalent of 244 and a melting point of 118° C. (Product name is YSLV-120TE manufactured by Nippon Steel Chemical Co., Ltd.)

Epoxy resin (5): bisphenol A type bromide epoxy resin having an epoxy equivalent of 375, a softening point of 80° C. and a bromide content of 48 wt % (Product name is ESB-400T manufactured by Sumitomo Chemical Co., Ltd.)

Epoxy resin (6): bisphenol F type epoxy resin having a melting point of 75° C. and an epoxy equivalent of 186 (Product name is YSLV-80XY manufactured by Nippon Steel Chemical Co., Ltd.)

Curing Agent

Curing agent (1): phenol.aralkyl resin having a hydroxyl group equivalent of 172 and a softening point of 70° C. (Product name is Milex XL-225 manufactured by Mitsui Chemicals, Inc.)

Curing agent (2): biphenyl type phenol resin having a hydroxyl group equivalent of 199 and a softening point of 80° C. (Product name is MEH-7851 manufactured by Meiwa Plastic industries, Ltd.)

Curing agent (3): phenolnovolak resin having a softening point of 80° C. and a hydroxyl group equivalent of 106 (Product name is H-1 manufactured by Meiwa Plastic Industries, Ltd.)

Hardening Accelerator

Hardening accelerator (1): adduct of triphenylphosphine and 1,4-benzoquinone

Hardening accelerator (2): mixture of triphenylphosphine and 1,4-benzoquinone (the molar ratio of triphenylphosphine/1,4-benzoquinone is equal to 1/1.2)

Hardening accelerator (3): adduct of tris(4-methylphenyl)phosphine and p-benzoquinone

Hardening accelerator (4): triphenylphosphine

Hardening accelerator (5): adduct of tri-p-tolylphosphine and 1,4-benzoquinone

Hardening accelerator (6): mixture of tri-p-tolylphosphine and 1,4-benzoquinone (the molar ratio of tri-p-tolylphosphine/1, 4-benzoquinone is equal to 1/1.2)

Hardening accelerator (7): adduct of tributylphosphine and 1,4-benzoquinone

Hardening accelerator (8): diazabicycloundecene phenolnovolak resin salt

Inorganic Filler

Fused silica: spherical fused silica having a mean diameter of 17.5 μm and a specific surface area of the particles of 3.8 m²/g

Flame Retardant

Composite metal hydroxide: Solid solution of magnesium and zinc hydroxides, of which M¹ is magnesium, M² is zinc, m is 7, n is 3, h is 10, and all of a, b, c and d are 1 in the chemical composition formula (C-II) described above. (Product name is Echomag Z10 manufactured by Tateho Chemical Industries Co., Ltd.)

Red phosphorus (Product name is Nova Excel 140 manufactured by Rinkagaku Kogyo Co., Ltd.)

Antimony trioxide

Condensed phosphate shown by the formula (XIXa) described above (Product name is PX-200 manufactured by Daihachi Chemical Industry Co., Ltd.)

Triphenylphosphate

Magnesium hydroxide (Product name is Kisuma 5A manufactured by Kyowa Chemical Industry Co., Ltd.)

Mold Releasing Agent

Mold releasing agent (1): linear type oxidized polyethylene having a weight average molecular weight of 8,800, a penetration of 1, and an acid value of 30 mg/KOH. (Product name is PED 153 manufactured by Clariant Japan K.K.)

Mold releasing agent (2): linear type oxidized polyethylene having a weight average molecular weight of 3,600, a penetration of 1, and an acid value of 15 mg/KOH. (Product name is PED 121 manufactured by Clariant Japan K.K.)

Mold releasing agent (3): branched chain type oxidized polyethylene having a weight average molecular weight of 3,100, a penetration of 5, and an acid value of 25 mg/KOH. (Product name is PED 522 manufactured by Clariant Japan K.K.)

Mold releasing agent (4): linear type non-oxidized polyethylene having a weight average molecular weight of 12,000, and a penetration of 1. (Product name is PED 190 manufactured by Clariant Japan K.K.)

Montanate (Product name is Hoechst-Wax E manufactured by Clariant Japan K.K.)

The weight average molecular weights of the mold releasing agents (1) to (4) described above are the measured values by high temperature GPC at a temperature of 140° C. using orthodichlorobenzene solvent.

Ion Scavenger

Hydrotalcite (Product name is DHT-4A manufactured by Kyowa Chemical Industry Co., Ltd.)

Coupling Agent

Anilinosilane: γ-anilinopropyltrimethoxysilane

Epoxy silane: γ-glycidoxypropyltrimethoxysilane (Product name is KBM 403 manufactured by Shin-Etsu Chemical Co., Ltd.)

Other Additives

Carnauba Wax (Product of Clariant Japan K.K.)

Carbon Black (Product name is MA-100 manufactured by Mitsubishi Chemical Corporation)

[Evaluated Items and Evaluation Methods]

Flame Resistance

The resin composition was molded and post-cured under the same conditions as described above using a metal mold for the preparation of a 1/16 inch thick test piece, and its flame resistance was evaluated according to the UL-94 test method.

Hardness at Curing Stage

Immediately after the resin composition was molded into a disc of a diameter of 50 mm and 3 mm thick under the same conditions as described above, the hardness of the molded disc inside the mold was measured by a Shore hardness tester type D.

Mold Release Force Under Shearing

A chromium plated stainless steel whose size was 50 mm long, 35 mm wide and 0.4 mm thick was inserted into a mold for molding a disc of 20 mm radius. On the stainless plate, the resin composition was molded under the above mentioned conditions. Immediately after the molding, the stainless plate was drawn out and the maximum drawing out force was measured. The same tests were repeated 10 times continuously and an average of the measured values of from second to tenth tests was calculated. The obtained average was evaluated as the mold release force under shearing (average). The measured drawing out force of the tenth test was evaluated as the mold release force under shearing (after 10 shots of molding).

Spiral Flow Property

The resin composition was molded under the same conditions as described above by using a mold for spiral flow measurement according to the EMMI-1-66, and the flow length (cm) was measured.

Disc Flow Property

A set of flat molds for disc-flow measurement comprising an upper half of 200 mm wide, 200 mm deep and 25 mm high and a lower half of 200 mm wide, 200 mm deep and 15 mm high was used. Five grams of sample (each of the resin composition) accurately weighed were placed on the center of the lower mold that was heated and kept at 180° C. After five seconds, the upper mold heated to 180° C. was placed to close the mold. After compression molding under a load of 78 N and for a curing time of 90 seconds, the mean diameter (mm) as a disc flow was calculated from the long diameter (mm) and the short diameter (mm) of the molded product, which were measured with a slide calipers.

Reflow Resistance

A pin flat package (QFP) having an outer size of 20 mm×14 mm×2 mm, on which a silicon chip of 8 mm×10 mm×0.4 mm was mounted, was molded with the resin composition under the same conditions as mentioned above, and followed by post-curing operation. Reflow treatments were done at every predetermined time interval under heat conditions of 240° C. for 10 seconds after moisturization under conditions of 85° C. and 85% RH. Based on the observation of the existence of cracks, the ratio of the number of packages with cracks to 5 packages tested was evaluated.

Moisture Resistance

A 80 pin flat package (QFP) having an outer size of 20 mm×14 mm×2.7 mm, in which a silicon chip for test of 6 mm×6 mm×0.4 mm size wired with aluminum, which line width was 10 μm and 1 μm thick, was mounted on an oxide film of 5 μm thickness, was molded with the epoxy resin composition and post-cured under the same conditions described above. After pretreatment and moistening, the number of breaks in the wire due to corrosion of the wire was measured at every predetermined time interval. The evaluation was done according to the number of defective packages to 10 tested packages.

The pretreatment above was conducted as follows. The flat package was moistened at 85° C., 85% RH and for 72 hours and followed by vapor phase reflow treatment done at 215° C. for 90 sec. The following moisturization was done at a pressure of 0.2 MPa and at 121° C.

High Temperature Storage Property

A test silicon chip having a size of 5 mm×9 mm×0.4 mm placed on an oxide film of 5 μm thickness and wired by aluminum of 1 μm thick and 10 μm in the line width was mounted by silver paste on a lead frame made of 42 alloy and partially plated with silver. A 16 pin type DIP (Dual Inline Package) in which bonding pads of the chip and inner leads were connected with gold wires by a thermonic type wirebonder was molded with the resin composition and post-cured under the foregoing conditions. The test sample was stored in an oven kept at 200° C., sampled at every predetermined time and tested for continuity. The high temperature storage property was evaluated by comparing the number of the packages with defective continuity to the 10 packages tested.

Gate Break Property (an Index for Mold Release Properties)

A 80 pin flat package having an outer size of 20 mm×14 mm×2 mm in which a silicone chip of 8 mm×10 mm×0.4 mm was mounted on a lead frame, was molded with the resin composition under the same conditions mentioned above. After molding, the gate portions were observed to evaluate the gate breaking number (a number of the gates which were clogged with the molded articles), with respect to the gate number (20).

Wire Sweep Rate (an Index for Wire Sweep)

Using a soft X-ray measurement apparatus (PRO-TEST 100 type manufactured by SOFTEX Society), a fluoroscopic observation of the semiconductor device was conducted to determine the wire sweep rate under conditions of a voltage of 100 V and an electric current of 1.5 mA in order to evaluate the wire sweep. As shown in FIG. 4 and FIG. 5, the observation was conducted from the perpendicular direction with respect to the frame surface. The shortest distance “L” of the wire bonding (length of the line connecting the terminal portion 7 of the semiconductor chip 3 with the lead pin 4, or with the bonding portion of the substrate (the terminal portion 10 of the printed wiring substrate) and the maximum dislocation “X” of the wire 5 were measured. X/L×100 was denoted as the wire sweep rate (%).

Voids Generated Amount

The fluoroscopic observation of the semiconductor device was conducted in the same way as in the measurement of the above wire sweep. The existence or non-existence of the voids of greater than or equal to 0.1 mm in diameter was observed, then the voids generated was evaluated by the number of semiconductor device accompanied with voids/the number of semiconductor device tested.

Extract Water Property

A molded article of 20 mm×120×1 mm was prepared by the transfer molding method. After curing, the obtained product was cut with scissors into 1 mm×1 mm and then crushed with a small vibration mill (NB-O type made by Nittoh Kagaku Co., Ltd.). Following to a process to remove large particles from the crushed particles using a 100 mesh sieve, 5 g of the sample was transferred together with 50 g of distilled water into a pressure tight vessel whose inside was coated with fluorocarbon resin, and encapsulated up to be treated at 121° C. for 20 hrs. After the treatment was completed, the content was cooled to the room temperature and taken out from the vessel. Suspended materials were precipitated by applying a centrifugal separation apparatus to take up the water phase as the extract water. Ion concentration in the extract water was measured by ion chromatogram (The Shodex column ICSI 90 4E and IC Y-521 manufactured by Showa Denko K.K.).

### (1) Example L

### Examples L1 to L10, Comparative Examples L1 to L6

Respective components shown in Table L1 were mixed by parts by weight, and roll-kneaded at 80° C. for 10 min. to prepare and evaluate resin compositions of examples L1 to L10 and comparative examples L1 to L6. The results are shown in Table L2.

TABLE L1

(Unit: parts by weight)

| | Examples L | | | | | | | |
|---|---|---|---|---|---|---|---|---|
| Composition | 1 | 2 | 3 | 4 | 5 | 6 | 7 | 8 |
| Epoxy resin (1) | 100 | 100 | 100 | 100 | 100 | 100 | — | — |
| Epoxy resin (4) | — | — | — | — | — | — | 100 | — |
| Epoxy resin (6) | — | — | — | — | — | — | — | 100 |
| Epoxy resin (2) | — | — | — | — | — | — | — | — |
| Epoxy resin (3) | — | — | — | — | — | — | — | — |
| Epoxy resin (5) | — | — | — | — | — | — | — | — |
| Curing agent (1) | 89 | 89 | 89 | 89 | 89 | — | 71 | 94 |
| Curing agent (2) | — | — | — | — | — | 102 | — | — |
| Curing agent (3) | — | — | — | — | — | — | — | — |
| Hardening accelerator (1) | 3.5 | — | 3.5 | — | 3.5 | — | — | — |
| Hardening accelerator (3) | — | 3.5 | — | 3.5 | — | 3.5 | 3.5 | 3.5 |
| Hardening accelerator (4) | — | — | — | — | — | — | — | — |
| Composite metal hydroxide | 100 | 100 | 100 | 100 | 50 | 100 | 100 | 100 |
| Condensed phosphate | — | — | — | — | 10 | — | — | — |
| Anilinosilane | — | — | 4.5 | 4.5 | — | — | — | — |
| Epoxy silane | 4.5 | 4.5 | — | — | 4.5 | 4.5 | 4.5 | 4.5 |
| Fused silica | 1425 | 1425 | 1425 | 1425 | 1550 | 1517 | 1291 | 1461 |
| Antimony trioxide | — | — | — | — | — | — | — | — |
| Carnauba wax | 2.0 | 2.0 | 2.0 | 2.0 | 2.0 | 2.0 | 2.0 | 2.0 |
| Carbon black | 3.5 | 3.5 | 3.5 | 3.5 | 3.5 | 3.5 | 3.5 | 3.5 |
| Amount of inorganic filler | 88 | 88 | 88 | 88 | 88 | 88 | 88 | 88 |
| (wt %)* | | | | | | | | |
| | Examples L | | Comparative examples L | | | | | |
| Composition | 9 | 10 | 1 | 2 | 3 | 4 | 5 | 6 |
| Epoxy resin (1) | — | — | 100 | 100 | 100 | 100 | 100 | 85 |
| Epoxy resin (4) | — | — | — | — | — | — | — | — |
| Epoxy resin (6) | — | — | — | — | — | — | — | — |
| Epoxy resin (2) | 100 | — | — | — | — | — | — | — |
| Epoxy resin (3) | — | 100 | — | — | — | — | — | — |
| Epoxy resin (5) | — | — | — | — | — | — | — | 15 |
| Curing agent (1) | 83 | — | 89 | 89 | 89 | 89 | 89 | 83 |
| Curing agent (2) | — | — | — | — | — | — | — | — |
| Curing agent (3) | — | 54 | — | — | — | — | — | — |
| Hardening accelerator (1) | — | — | — | 3.5 | 3.5 | 3.5 | 3.5 | 3.5 |
| Hardening accelerator (3) | 3.5 | 3.5 | — | — | — | — | — | — |
| Hardening accelerator (4) | — | — | 3.5 | — | — | — | — | — |
| Composite metal hydroxide | 100 | 200 | 100 | 250 | 100 | — | — | — |
| Condensed phosphate | — | — | — | — | 10 | 30 | — | — |
| Anilinosilane | — | — | — | — | — | — | — | — |
| Epoxy silane | 4.5 | 4.5 | 4.5 | 4.5 | 4.5 | 4.5 | 4.5 | 4.5 |
| Fused silica | 1380 | 386 | 1425 | 1275 | 1500 | 1751 | 1525 | 1507 |
| Antimony trioxide | — | — | — | — | — | — | — | 6.0 |
| Carnauba wax | 2.0 | 2.0 | 2.0 | 2.0 | 2.0 | 2.0 | 2.0 | 2.0 |
| Carbon black | 3.5 | 3.5 | 3.5 | 3.5 | 3.5 | 3.5 | 3.5 | 3.5 |
| Amount of inorganic filler | 88 | 78 | 88 | 88 | 88 | 88 | 88 | 88 |
| (wt %)* | | | | | | | | |

*Amount against the resin composition (wt %)

TABLE L2

| | | Examples L | | | | | | | | | | Comparative examples L | | | | | |
|---|---|---|---|---|---|---|---|---|---|---|---|---|---|---|---|---|---|
| Evaluation | | 1 | 2 | 3 | 4 | 5 | 6 | 7 | 8 | 9 | 10 | 1 | 2 | 3 | 4 | 5 | 6 |
| Spiral flow (cm) | | 95 | 92 | 100 | 97 | 112 | 104 | 90 | 101 | 91 | 88 | 73 | 80 | 102 | 128 | 105 | 103 |
| Disc flow (mm) | | 82 | 81 | 86 | 86 | 90 | 81 | 82 | 84 | 80 | 82 | 72 | 70 | 85 | 93 | 82 | 81 |
| Hardness at curing stage | | 79 | 82 | 80 | 83 | 76 | 75 | 78 | 77 | 83 | 83 | 62 | 75 | 73 | 65 | 80 | 78 |
| (Shore D) | | | | | | | | | | | | | | | | | |
| Mold release force under | | 180 | 75 | 92 | 45 | 68 | 105 | 88 | 93 | 65 | 40 | 280 | 370 | 220 | 175 | 70 | 64 |
| shearing (KPa)** | | | | | | | | | | | | | | | | | |
| UL-94 test | | V-0 | V-0 | V-0 | V-0 | V-0 | V-0 | V-0 | V-0 | V-0 | V-0 | V-0 | V-0 | V-0 | V-0 | * | V-0 |
| Gate break | | 1/20 | 0/20 | 0/20 | 0/20 | 0/20 | 0/20 | 0/20 | 0/20 | 0/20 | 0/20 | 7/20 | 15/20 | 5/20 | 2/20 | 0/20 | 0/20 |
| Reflow resistance | 72 h | 0/5 | 0/5 | 0/5 | 0/5 | 0/5 | 0/5 | 0/5 | 0/5 | 0/5 | 2/5 | 0/5 | 0/5 | 0/5 | 0/5 | 0/5 | 0/5 |
| | 96 h | 0/5 | 0/5 | 0/5 | 0/5 | 0/5 | 0/5 | 0/5 | 0/5 | 0/5 | 5/5 | 0/5 | 1/5 | 0/5 | 0/5 | 0/5 | 0/5 |
| | 168 h | 0/5 | 0/5 | 1/5 | 2/5 | 0/5 | 0/5 | 0/5 | 0/5 | 2/5 | 5/5 | 2/5 | 3/5 | 0/5 | 0/5 | 0/5 | 0/5 |
| | 336 h | 1/5 | 5/5 | 5/5 | 5/5 | 1/5 | 1/5 | 0/5 | 1/5 | 5/5 | 5/5 | 5/5 | 5/5 | 0/5 | 0/5 | 2/5 | 3/5 |
| Moisture | 100 h | 0/10 | 0/10 | 0/10 | 0/10 | 0/10 | 0/10 | 0/10 | 0/10 | 0/10 | 0/10 | 0/10 | 0/10 | 0/10 | 0/10 | 0/10 | 0/10 |
| resistance | 200 h | 0/10 | 0/10 | 0/10 | 0/10 | 0/10 | 0/10 | 0/10 | 0/10 | 0/10 | 0/10 | 0/10 | 0/10 | 0/10 | 0/10 | 0/10 | 0/10 |
| | 500 h | 0/10 | 0/10 | 0/10 | 0/10 | 0/10 | 0/10 | 0/10 | 0/10 | 0/10 | 0/10 | 0/10 | 0/10 | 0/10 | 2/10 | 0/10 | 0/10 |
| | 1000 h | 0/10 | 0/10 | 0/10 | 0/10 | 0/10 | 0/10 | 0/10 | 0/10 | 0/10 | 0/10 | 2/10 | 0/10 | 0/10 | 5/10 | 0/10 | 1/10 |
| High | 400 h | 0/10 | 0/10 | 0/10 | 0/10 | 0/10 | 0/10 | 0/10 | 0/10 | 0/10 | 0/10 | 0/10 | 0/10 | 0/10 | 0/10 | 0/10 | 0/10 |
| temperature | 600 h | 0/10 | 0/10 | 0/10 | 0/10 | 0/10 | 0/10 | 0/10 | 0/10 | 0/10 | 0/10 | 0/10 | 0/10 | 0/10 | 0/10 | 0/10 | 2/10 |
| storage property | 800 h | 0/10 | 0/10 | 0/10 | 0/10 | 0/10 | 0/10 | 0/10 | 0/10 | 0/10 | 0/10 | 0/10 | 0/10 | 0/10 | 0/10 | 0/10 | 5/10 |
| | 1000 h | 0/10 | 0/10 | 0/10 | 0/10 | 0/10 | 0/10 | 0/10 | 0/10 | 0/10 | 0/10 | 3/10 | 0/10 | 0/10 | 2/10 | 0/10 | 10/10 |

* below standards
**after 10 shots of molding

The comparative examples L4 to L6 did not include the component (C), composite metal hydroxide. Accordingly, the comparative example L5 was inferior in flame resistance and did not attain the UL-94 V-0, the comparative example L4 including phosphate was inferior in moisture resistance, and the comparative example L6 including bromide epoxy resin and antimony compound was inferior in high temperature storage property. The comparative examples L1 to L3 having the mold release force under shearing after 10 shots of molding greater than 200 KPa exhibited larger number of gate breaks, which showed poor mold release properties.

On the other hands, the examples L1 to L10 were excellent in flame resistance, few in gate breaks, and had good mole release properties, thus excellent in terms of reliability.

### (2) Example M

Preparation of Resin Composition

Respective components shown in Table M1 were mixed by parts by weight, and roll kneaded at 80° C. for 10 min to prepare and evaluate resin compositions C1 to C14. The results are shown in Table M2.

TABLE M1

(Unit: parts by weight)

| | Resin compositions | | | | | | | | | | | | | |
|---|---|---|---|---|---|---|---|---|---|---|---|---|---|---|
| Composition | C1 | C2 | C3 | C4 | C5 | C6 | C7 | C8 | C9 | C10 | C11 | C12 | C13 | C14 |
| Epoxy resin (1) | 100 | 100 | 100 | 100 | 100 | 100 | — | — | — | — | 100 | 100 | 85 | — |
| Epoxy resin (6) | — | — | — | — | — | — | 100 | — | — | — | — | — | — | — |
| Epoxy resin (2) | — | — | — | — | — | — | — | 100 | — | — | — | — | — | — |
| Epoxy resin (4) | — | — | — | — | — | — | — | — | 100 | — | — | — | — | — |
| Epoxy resin (3) | — | — | — | — | — | — | — | — | — | 100 | — | — | — | 85 |
| Epoxy resin (5) | — | — | — | — | — | — | — | — | — | — | — | — | 15 | 15 |
| Curing agent (1) | 89 | 89 | — | 89 | 89 | 89 | 94 | 83 | 71 | — | 89 | 89 | 83 | — |
| Curing agent (2) | — | — | 102 | — | — | — | — | — | — | — | — | — | — | — |
| Curing agent (3) | — | — | — | — | — | — | — | — | — | 54 | — | — | — | 50 |
| Hardening | 3.5 | 3.5 | 3.5 | 3.5 | 3.5 | 3.5 | 3.5 | 3.5 | 3.5 | 2.0 | 3.5 | 3.5 | 3.5 | 2.0 |
| accelerator (1) | | | | | | | | | | | | | | |
| Condensed | — | — | — | 10 | 10 | — | — | — | — | — | 25 | — | — | — |
| phosphate | | | | | | | | | | | | | | |
| Triphenylphosphate | — | — | — | — | — | 10 | — | — | — | — | — | — | — | — |
| Composite | 100 | 100 | 100 | 30 | 30 | 30 | 100 | 100 | 100 | 100 | — | — | — | — |
| metal hydroxide | | | | | | | | | | | | | | |
| Magnesium | — | — | — | — | — | — | — | — | — | — | — | 100 | — | — |
| hydroxide | | | | | | | | | | | | | | |
| Anilinosilane | — | 4.5 | — | — | 4.5 | — | — | — | — | — | — | — | — | — |
| Epoxy silane | 4.5 | — | 4.5 | 4.5 | — | 4.5 | 4.5 | 4.5 | 4.5 | 4.5 | 4.5 | 4.5 | 4.5 | 4.5 |
| Fused silica | 1426 | 1426 | 1521 | 1571 | 1571 | 1571 | 1460 | 1384 | 1628 | 629 | 1713 | 1426 | 1473 | 715 |
| Antimony trioxide | — | — | — | — | — | — | — | — | — | — | — | — | 6.0 | 15.0 |
| Carnauba wax | 2.0 | 2.0 | 2.0 | 2.0 | 2.0 | 2.0 | 2.0 | 2.0 | 2.0 | 2.0 | 2.0 | 2.0 | 2.0 | 2.0 |
| Carbon black | 3.5 | 3.5 | 3.5 | 3.5 | 3.5 | 3.5 | 3.5 | 3.5 | 3.5 | 3.5 | 3.5 | 3.5 | 3.5 | 3.5 |
| Amount of | 88 | 88 | 88 | 88 | 88 | 88 | 88 | 88 | 88 | 88 | 88 | 88 | 88 | 81 |
| inorganic | | | | | | | | | | | | | | |
| filler (wt %)* | | | | | | | | | | | | | | |

*Amount against the resin composition (wt %)

TABLE M2

| | Resin compositions | | | | | | | | | | | | | |
|---|---|---|---|---|---|---|---|---|---|---|---|---|---|---|
| Evaluation | C1 | C2 | C3 | C4 | C5 | C6 | C7 | C8 | C9 | C10 | C11 | C12 | C13 | C14 |
| Spiral flow (cm) | 92 | 102 | 98 | 117 | 120 | 119 | 100 | 90 | 91 | 90 | 105 | 78 | 105 | 95 |
| Disc flow (mm) | 81 | 85 | 82 | 88 | 92 | 89 | 83 | 80 | 83 | 80 | 85 | 70 | 86 | 82 |
| Hardness at curing stage | 80 | 82 | 78 | 78 | 80 | 76 | 76 | 81 | 78 | 83 | 65 | 80 | 80 | 85 |
| (Shore D) | | | | | | | | | | | | | | |
| Mold release force under | 182 | 91 | 188 | 53 | 40 | 59 | 190 | 175 | 187 | 102 | 170 | 532 | 65 | 28 |
| shearing (KPa)* | | | | | | | | | | | | | | |
| UL-94 test | V-0 | V-0 | V-0 | V-0 | V-0 | V-0 | V-0 | V-0 | V-0 | V-0 | V-0 | V-0 | V-0 | V-0 |

*after 10 shots of molding

Preparation of Semiconductor Devices (LQFP and QFP)

Using the resin compositions C1 to C14, semiconductor devices corresponding to examples M1 to M10 and comparative examples M1 to M18 were formed as follows.

### Examples M1 to M10 (Table M3)

Using the resin compositions C1 to C10, corresponding semiconductor devices (100-pins LQFP) of examples 1 to 10 were formed as follows. A silicone chip for the test of 10 mm×10 mm×0.4 mm having an area of 100 mm² and a pad pitch of 80 μm was mounted on a lead frame, then the chip and lead frame were wire-bonded by gold wires each having a diameter of 18 μm and a length of 3 mm at the maximum, and the whole was encapsulated with the corresponding resin composition to from a semiconductor device respectively. The outer size of the obtained device was 20 mm×20 mm, the thickness of the encapsulating material of the upper side of the chip was 0.5 mm, the thickness of the encapsulating material of the lower side of the chip was 0.5 mm, and the total thickness of the device was 1.5 mm.

### Comparative Examples M1 to M4 (Table M3)

Semiconductor devices (100-pins LQFP) of comparative examples M1 to M4 were formed in the same way as in the examples M1 to M10, except the use of the resin compositions C11 to C14.

### Comparative Examples M5 to M14 (Table M4)

Using the resin compositions C1 to C10, semiconductor devices (64-pins QFP-1H) of comparative examples M5 to M14 were formed as follows. A silicone chip for the test of 4 mm×4 mm×0.4 mm having an area of 16 mm² and a pad pitch of 100 μm was mounted on a lead frame, then the chip and lead frame were wire-bonded by gold wires each having a diameter of 18 μm and a length of 1.5 mm at the maximum, and the whole was encapsulated with the corresponding resin composition to form a semiconductor device respectively. The outer size of the obtained devise was 20 mm×20 mm, the thickness of the encapsulating material of the upper side of the chip was 1.1 mm, the thickness of the encapsulating material of the lower side of the chip was 1.1 mm, and the total thickness of the device was 2.7 mm.

### Comparative Examples M15 to M18 (Table M4)

The semiconductor devices (64-pins QFP-1H) of comparative examples M15 to M18 were formed in the same way as in the comparative examples M5 to M14, except the use of the resin compositions C11 to C14.

Preparation of Semiconductor Device (OMPAC Type BGA)

Semiconductor devices of examples M11 to M20 and comparative examples M19 to M36 were formed as follows, using the resin compositions C1 to C14.

### Examples M11 to M20 (Table M5)

A fine wiring pattern was formed on an insulated substrate for semiconductor chip mounting (glass-fiber-woven cloth reinforced epoxy resin laminate, the product name “E-679” manufactured by Hitachi Chemical Co., Ltd.) having an outer size of 26.2 mm×26.2 mm×0.6 mm. Then, the front and back surfaces of the substrate excluding gold plated terminals on the obverse and external connection terminals on the reverse were coated with solder resist (“PSR4000AUS5”, the product name of Taiyo Ink Mfg. Co., Ltd.) and dried at 120° C. for 2 hours. A semiconductor chip of 9 mm×9 mm×0.51 mm having an area of 81 mm² and a pad pitch of 80 μm was mounted on the dried substrate by applying an adhesive agent (“EN-X50”, the product name of Hitachi Chemical Co., Ltd.) and heated in a clean oven from room temperature to 180° C. at constantly elevating speed for 1 hour, followed by an additional heating at 180° C. for 1 hour. Then wire bonding portions and the chip were wire-bonded by gold wires each having a diameter of 30 μm and a length of 5 mm at the maximum, and the front (upper) side of the substrate on which the chip was mounted was encapsulated with each of the resin compositions C1 to C10 to form a corresponding BGA device of 26.2 mm×26.2 mm×0.9 mm (1.5 mm thick BGA device) of the examples M11 to M20 by transfer molding method under the above mentioned conditions.

### Comparative Examples M19 to M22 (Table M5)

Corresponding Semiconductor devices (1.5 mm thick BGA device) of comparative examples M19 to M22 were formed in the same way as in the examples M11 to M20, except the use of the resin composition C11 to C14.

### Comparative Examples M23 to M32 (Table M6)

In the same way as in the examples M11 to M20, a semiconductor chip of 4 mm×4 mm×0.51 mm having an area of 16 mm² and a pad pitch of 100 μm was mounted and wire bonding portions and the chip were wire-bonded by gold wires each having a diameter of 30 μm and a length of 1.5 mm at the maximum. The front side of the substrate on which the chip was mounted was encapsulated with each of the resin compositions C1 to C10 to form a corresponding BGA device of 26.2 mm×26.2 mm×1.9 mm (2.5 mm thick BGA device) of the comparative examples M23 to M32 by transfer molding method under the above mentioned conditions.

### Comparative Examples M33 to M36 (Table M6)

BGA devices of comparative examples M33 to M36 were formed in the same way as in the comparative examples M23 to M32, except the use of the resin compositions C1 to C14.

Preparation of Semiconductor Device (Mold Array Package Type Stacked Type BGA)

Semiconductor devices of examples M21 to M30 and comparative examples M37 to M54 were formed as follows, using the resin compositions C1 to C14.

### Examples M21 to M30 (Table M7)

Two semiconductor chips, each having a size of 9.7 mm×6.0 mm×0.4 mm, an area of 58 mm², and a pad pitch of 80 μm, and comprising a die bonding film “DF-400” manufactured by Hitachi Chemical Co., Ltd. adhered on its reverse side, were stacked in layer onto each other on a polyimide substrate of 48 mm×171 mm×0.15 mm, and 56 sets of the stacked chips were disposed as indicated in FIG. 3A. The chips were bonded at 200° C. for 10 sec. under a load of 200 gf, and followed by a baking of 180° C. for 1 hour. After that, wire bonding portions and the chips were wire-bonded by gold wires each having a diameter of 30 μm and a length of 5 mm at the maximum. Next, the front side of the substrate on which the chips were mounted was encapsulated with each of the resin compositions C1 to C10 to form a corresponding BGA device of 40 mm×83 mm×0.8 mm (0.95 mm thick BGA device) of examples M21 to M30 by transfer molding method under the above mentioned conditions, as shown in FIG. 3B.

### Comparative Examples M37 to M40 (Table M7)

The BGA devices (0.95 thick BGA devices) of comparative examples M37 to M40 were formed in the same way as in the examples M21 to M30, except the use of the resin compositions C11 to C14.

### Comparative Examples M41 to M50 (Table M8)

In the same way as in the examples M21 to M30, except that a single semiconductor chip, not stacked, of 5.1 mm×3.1 mm×0.4 mm having an area of 16 mm² and a pad pitch of 100 μm was mounted, and wire bonding portions and the chips were wire-bonded by gold wires each having a diameter of 30 μm and a length of 1.5 mm at the maximum, and the front side of the substrate on which the chips were mounted was encapsulated with each of the resin compositions C1 to C10 to form a corresponding BGA device of 40 mm×83 mm×2.5 mm (2.65 mm thick BGA device) of comparative examples M41 to M50 by transfer molding method under the above mentioned conditions.

### Comparative Examples M51 to M54 (Table M8)

BGA devices of comparative examples M51 to M54 were formed in the same way as in the comparative examples M41 to M50, except the use of the resin compositions C11 to C14.

The obtained semiconductor devices of the examples M1 to M30 and comparative examples M1 to M54 were evaluated by the respective tests. The results are shown in Tables M3 to M8.

TABLE M3

| | Examples M | | | | | | | | | | Comparative examples M | | | |
|---|---|---|---|---|---|---|---|---|---|---|---|---|---|---|
| Evaluation | 1 | 2 | 3 | 4 | 5 | 6 | 7 | 8 | 9 | 10 | 1 | 2 | 3 | 4 |
| Resin composition | C1 | C2 | C3 | C4 | C5 | C6 | C7 | C8 | C9 | C10 | C11 | C12 | C13 | C14 |
| Wire sweep rate (%) | 7 | 5 | 7 | 4 | 3 | 3 | 6 | 8 | 7 | 8 | 5 | 18 | 5 | 7 |
| Voids generated amount | 0/20 | 0/20 | 0/20 | 0/20 | 0/20 | 0/20 | 0/20 | 0/20 | 0/20 | 0/20 | 0/20 | 5/20 | 0/20 | 0/20 |

TABLE M4

| | Comparative examples M | | | | | | | | | | | | | |
|---|---|---|---|---|---|---|---|---|---|---|---|---|---|---|
| Evaluation | 5 | 6 | 7 | 8 | 9 | 10 | 11 | 12 | 13 | 14 | 15 | 16 | 17 | 18 |
| Resin composition | C1 | C2 | C3 | C4 | C5 | C6 | C7 | C8 | C9 | C10 | C11 | C12 | C13 | C14 |
| Wire sweep rate (%) | 0 | 0 | 0 | 0 | 0 | 0 | 0 | 0 | 0 | 0 | 0 | 11 | 0 | 0 |
| Voids generated amount | 0/20 | 0/20 | 0/20 | 0/20 | 0/20 | 0/20 | 0/20 | 0/20 | 0/20 | 0/20 | 0/20 | 2/20 | 0/20 | 0/20 |

TABLE M5

| | Examples M | | | | | | | | | | Comparative examples M | | | |
|---|---|---|---|---|---|---|---|---|---|---|---|---|---|---|
| Evaluation | 11 | 12 | 13 | 14 | 15 | 16 | 17 | 18 | 19 | 20 | 19 | 20 | 21 | 22 |
| Resin composition | C1 | C2 | C3 | C4 | C5 | C6 | C7 | C8 | C9 | C10 | C11 | C12 | C13 | C14 |
| Wire sweep rate (%) | 8 | 6 | 8 | 6 | 4 | 4 | 8 | 9 | 7 | 8 | 7 | 20 | 6 | 9 |
| Voids generated amount | 0/20 | 0/20 | 0/20 | 0/20 | 0/20 | 0/20 | 0/20 | 0/20 | 0/20 | 0/20 | 0/20 | 7/20 | 0/20 | 0/20 |

TABLE M6

| | Comparative examples M | | | | | | | | | | | | | |
|---|---|---|---|---|---|---|---|---|---|---|---|---|---|---|
| Evaluation | 23 | 24 | 25 | 26 | 27 | 28 | 29 | 30 | 31 | 32 | 33 | 34 | 35 | 36 |
| Resin composition | C1 | C2 | C3 | C4 | C5 | C6 | C7 | C8 | C9 | C10 | C11 | C12 | C13 | C14 |
| Wire sweep rate (%) | 3 | 2 | 3 | 2 | 2 | 2 | 3 | 4 | 3 | 3 | 3 | 13 | 2 | 4 |
| Voids generated amount | 0/20 | 0/20 | 0/20 | 0/20 | 0/20 | 0/20 | 0/20 | 0/20 | 0/20 | 0/20 | 0/20 | 5/20 | 0/20 | 0/20 |

TABLE M7

| | Examples M | | | | | | | | | | Comparative examples M | | | |
|---|---|---|---|---|---|---|---|---|---|---|---|---|---|---|
| Evaluation | 21 | 22 | 23 | 24 | 25 | 26 | 27 | 28 | 29 | 30 | 37 | 38 | 39 | 40 |
| Resin composition | C1 | C2 | C3 | C4 | C5 | C6 | C7 | C8 | C9 | C10 | C11 | C12 | C13 | C14 |
| Wire sweep rate (%) | 9 | 8 | 9 | 7 | 6 | 6 | 9 | 9 | 7 | 9 | 9 | 22 | 8 | 9 |
| Voids generated amount | 0/20 | 0/20 | 0/20 | 0/20 | 0/20 | 0/20 | 0/20 | 0/20 | 0/20 | 0/20 | 0/20 | 8/20 | 0/20 | 0/20 |

TABLE M8

| | Comparative examples M | | | | | | | | | | | | | |
|---|---|---|---|---|---|---|---|---|---|---|---|---|---|---|
| Evaluation | 41 | 42 | 43 | 44 | 45 | 46 | 47 | 48 | 49 | 50 | 51 | 52 | 53 | 54 |
| Resin composition | C1 | C2 | C3 | C4 | C5 | C6 | C7 | C8 | C9 | C10 | C11 | C12 | C13 | C14 |
| Wire sweep rate (%) | 4 | 3 | 4 | 3 | 3 | 3 | 4 | 6 | 4 | 4 | 4 | 15 | 3 | 5 |
| Voids generated amount | 0/20 | 0/20 | 0/20 | 0/20 | 0/20 | 0/20 | 0/20 | 0/20 | 0/20 | 0/20 | 0/20 | 7/20 | 0/20 | 0/20 |

### Examples M31 to M40, Comparative Examples M55 to M58 (Table M9)

The resin compositions C1 to C14 were used and various evaluations relating to reliability were conducted. The results are shown in table M9.

TABLE M9

| | | Examples M | | | | | | | | | | Comparative examples M | | | |
|---|---|---|---|---|---|---|---|---|---|---|---|---|---|---|---|
| Evaluation | | 31 | 32 | 33 | 34 | 35 | 36 | 37 | 38 | 39 | 40 | 55 | 56 | 57 | 58 |
| Resin composition | | C1 | C2 | C3 | C4 | C5 | C6 | C7 | C8 | C9 | C10 | C11 | C12 | C13 | C14 |
| Reflow resistance | 72 h | 0/5 | 0/5 | 0/5 | 0/5 | 0/5 | 0/5 | 0/5 | 0/5 | 0/5 | 2/5 | 0/5 | 0/5 | 0/5 | 5/5 |
| | 96 h | 0/5 | 0/5 | 0/5 | 0/5 | 0/5 | 0/5 | 0/5 | 0/5 | 0/5 | 5/5 | 0/5 | 0/5 | 0/5 | 5/5 |
| | 168 h | 0/5 | 0/5 | 0/5 | 0/5 | 0/5 | 0/5 | 0/5 | 0/5 | 0/5 | 5/5 | 0/5 | 2/5 | 0/5 | 5/5 |
| | 336 h | 3/5 | 5/5 | 1/5 | 0/5 | 2/5 | 1/5 | 2/5 | 5/5 | 0/5 | 5/5 | 1/5 | 5/5 | 1/5 | 5/5 |
| Moisture resistance | 100 h | 0/10 | 0/10 | 0/10 | 0/10 | 0/10 | 0/10 | 0/10 | 0/10 | 0/10 | 0/10 | 0/10 | 0/10 | 0/10 | 0/10 |
| | 200 h | 0/10 | 0/10 | 0/10 | 0/10 | 0/10 | 0/10 | 0/10 | 0/10 | 0/10 | 0/10 | 0/10 | 0/10 | 0/10 | 0/10 |
| | 500 h | 0/10 | 0/10 | 0/10 | 0/10 | 0/10 | 0/10 | 0/10 | 0/10 | 0/10 | 0/10 | 2/10 | 0/10 | 0/10 | 0/10 |
| | 1000 h | 0/10 | 0/10 | 0/10 | 0/10 | 0/10 | 0/10 | 0/10 | 0/10 | 0/10 | 0/10 | 5/10 | 0/10 | 0/10 | 0/10 |
| High temperature | 400 h | 0/10 | 0/10 | 0/10 | 0/10 | 0/10 | 0/10 | 0/10 | 0/10 | 0/10 | 0/10 | 0/10 | 0/10 | 0/10 | 0/10 |
| storage property | 600 h | 0/10 | 0/10 | 0/10 | 0/10 | 0/10 | 0/10 | 0/10 | 0/10 | 0/10 | 0/10 | 0/10 | 0/10 | 2/10 | 0/10 |
| | 800 h | 0/10 | 0/10 | 0/10 | 0/10 | 0/10 | 0/10 | 0/10 | 0/10 | 0/10 | 0/10 | 0/10 | 0/10 | 7/10 | 5/10 |
| | 1000 h | 0/10 | 0/10 | 0/10 | 0/10 | 0/10 | 0/10 | 0/10 | 0/10 | 0/10 | 0/10 | 2/10 | 0/10 | 10/10 | 8/10 |

In terms of the semiconductor devices of the comparative examples M2, M16, M20, M34, M38 and M52, which were encapsulated with the resin composition C12 that was non-halogenated with magnesium hydroxide, imperfect molding either wire sweep (large in wire sweep) or voids occurred. The resin composition C11 that was non-halogenated with phosphate was inferior in hardness at curing stage, and the semiconductor device of the comparative example M55, encapsulated with the resin composition C11, was inferior in moisture resistance. The semiconductor devices of the comparative examples M57 and M58, encapsulated with the resin compositions C13 and C14 using bromide flame retardant and antimony compound were inferior in high temperature storage property.

On the other hands, the resin compositions C1 to C10 were excellent in fluidity, and in the semiconductor devices of the examples M1 to M30, encapsulated with these resin compositions, no wire sweep were observed (extremely small in wire sweep), no voids occurred, and the moldability was excellent. In addition, the semiconductor devices of the examples M31 to M39 were excellent in reflow resistance.

In terms of the semiconductor devices of the comparative examples M5 to M18, M23 to M36 and M41 to M54, which had no features of (a) to (f), no wire sweep were observed (extremely small in wire sweep), and no voids generation occurred.

### (3) Example N

### Examples N1 to N8, Comparative Examples N1 to N6

Respective components were mixed by parts by weight as shown in Table N1, roll-kneaded at 80° C. for 15 min. to prepare and evaluate resin compositions of examples N1 to N8 and comparative examples N1 to N6. The results are shown in Table N2.

TABLE N1

(Unit: parts by weight)

| | Examples N | | | | | | | | Comparative examples N | | | | | |
|---|---|---|---|---|---|---|---|---|---|---|---|---|---|---|
| Composition | 1 | 2 | 3 | 4 | 5 | 6 | 7 | 8 | 1 | 2 | 3 | 4 | 5 | 6 |
| Epoxy resin (1) | 100 | 100 | 100 | 100 | — | — | — | 100 | 100 | 100 | 100 | 100 | 100 | 90 |
| Epoxy resin (3) | — | — | — | — | — | — | 100 | — | — | — | — | — | — | — |
| Epoxy resin (4) | — | — | — | — | 100 | 100 | — | — | — | — | — | — | — | — |
| Curing agent (1) | 89 | 89 | 89 | 89 | 89 | 89 | — | 89 | 89 | 89 | 89 | 89 | 89 | 89 |
| Curing agent (3) | — | — | — | — | — | — | 54 | — | — | — | — | — | — | — |
| Hardening | — | 3.5 | 3.5 | 3.5 | 3.5 | 3.5 | 3.5 | 3.5 | 3.5 | 3.5 | 3.5 | 3.5 | 3.5 | 3.5 |
| accelerator (1) | | | | | | | | | | | | | | |
| Hardening | 5.0 | — | — | — | — | — | — | — | — | — | — | — | — | — |
| accelerator (8) | | | | | | | | | | | | | | |
| Red phosphorus | — | — | 6 | — | 6 | — | 6 | 6 | 6 | — | 6 | — | — | — |
| Condensed | — | — | — | 15 | — | 15 | — | — | — | 15 | — | 15 | 15 | — |
| phosphate | | | | | | | | | | | | | | |
| Magnesium | — | — | — | — | — | — | — | — | — | — | — | — | 150 | — |
| hydroxide | | | | | | | | | | | | | | |
| Composite metal | 150 | 150 | 50 | 50 | 50 | 50 | 50 | 100 | 0.3 | 0.3 | — | — | — | — |
| hydroxide | | | | | | | | | | | | | | |
| Antimony | — | — | — | — | — | — | — | — | — | — | — | — | — | 5 |
| trioxide | | | | | | | | | | | | | | |
| Fused silica | 1545 | 1495 | 1545 | 1545 | 1545 | 1545 | 400 | 1445 | 1565 | 1565 | 1585 | 1585 | 1585 | 1585 |
| Epoxy silane | 4.5 | 4.5 | 4.5 | 4.5 | 4.5 | 4.5 | 4.5 | 4.5 | 4.5 | 4.5 | 4.5 | 4.5 | 4.5 | 4.5 |
| Epoxy resin (5) | — | — | — | — | — | — | — | — | — | — | — | — | — | 10 |
| Carnauba wax | 2 | 2 | 2 | 2 | 2 | 2 | 2 | 2 | 2 | 2 | 2 | 2 | 2 | 2 |
| Carbon black | 3.5 | 3.5 | 3.5 | 3.5 | 3.5 | 3.5 | 3.5 | 3.5 | 3.5 | 3.5 | 3.5 | 3.5 | 3.5 | 3.5 |

TABLE N2

| | | Examples N | | | | | | | | Comparative examples N | | | | | |
|---|---|---|---|---|---|---|---|---|---|---|---|---|---|---|---|
| Evaluation | | 1 | 2 | 3 | 4 | 5 | 6 | 7 | 8 | 1 | 2 | 3 | 4 | 5 | 6 |
| Flame resistance | | | | | | | | | | | | | | | |
| : total afterflame time (s) | | 27 | 33 | 18 | 35 | 20 | 29 | 25 | 12 | 18 | 39 | 28 | 43 | 48 | 5 |
| : Judgment | | V-0 | V-0 | V-0 | V-0 | V-0 | V-0 | V-0 | V-0 | V-0 | V-0 | V-0 | V-0 | V-0 | V-0 |
| Spiral flow (cm) | | 68 | 70 | 76 | 83 | 69 | 73 | 86 | 64 | 80 | 88 | 82 | 103 | 55 | 78 |
| Spiral flow drop-time (h) | | 94 | 102 | 94 | 99 | 89 | 92 | 75 | 111 | 95 | 102 | 108 | 92 | 95 | 103 |
| Hardness at curing stage | | 79 | 74 | 79 | 75 | 78 | 74 | 81 | 77 | 75 | 73 | 76 | 69 | 74 | 78 |
| (Shore D) | | | | | | | | | | | | | | | |
| Disc flow (mm) | | 80 | 82 | 89 | 92 | 88 | 90 | 81 | 85 | 92 | 95 | 92 | 95 | 71 | 88 |
| Mold release force under | | 165 | 172 | 70 | 78 | 72 | 82 | 43 | 160 | 57 | 65 | 55 | 68 | 536 | 66 |
| shearing (Kpa)* | | | | | | | | | | | | | | | |
| Reflow resistance | 48 h | 0/5 | 0/5 | 0/5 | 0/5 | 0/5 | 0/5 | 0/5 | 0/5 | 0/5 | 0/5 | 0/5 | 0/5 | 0/5 | 0/5 |
| | 72 h | 0/5 | 0/5 | 0/5 | 0/5 | 0/5 | 0/5 | 1/5 | 0/5 | 0/5 | 0/5 | 0/5 | 0/5 | 0/5 | 0/5 |
| | 96 h | 0/5 | 1/5 | 0/5 | 1/5 | 0/5 | 0/5 | 2/5 | 1/5 | 1/5 | 0/5 | 0/5 | 0/5 | 0/5 | 0/5 |
| | 168 h | 2/5 | 2/5 | 2/5 | 2/5 | 0/5 | 0/5 | 3/5 | 2/5 | 1/5 | 1/5 | 1/5 | 1/5 | 2/5 | 1/5 |
| Moisture resistance | 12 h | 0/10 | 0/10 | 0/10 | 0/10 | 0/10 | 0/10 | 0/10 | 0/10 | 0/10 | 0/10 | 0/10 | 0/10 | 0/10 | 0/10 |
| | 24 h | 0/10 | 0/10 | 0/10 | 0/10 | 0/10 | 0/10 | 0/10 | 0/10 | 0/10 | 0/10 | 0/10 | 0/10 | 0/10 | 0/10 |
| | 48 h | 0/10 | 0/10 | 0/10 | 0/10 | 0/10 | 0/10 | 0/10 | 0/10 | 0/10 | 0/10 | 1/10 | 0/10 | 0/10 | 0/10 |
| | 72 h | 0/10 | 0/10 | 0/10 | 0/10 | 0/10 | 0/10 | 0/10 | 0/10 | 0/10 | 0/10 | 4/10 | 0/10 | 0/10 | 0/10 |
| | 96 h | 0/10 | 0/10 | 0/10 | 0/10 | 0/10 | 0/10 | 0/10 | 0/10 | 3/10 | 0/10 | 8/10 | 0/10 | 0/10 | 0/10 |
| | 144 h | 0/10 | 0/10 | 0/10 | 0/10 | 0/10 | 0/10 | 0/10 | 0/10 | 8/10 | 1/10 | 10/10 | 5/10 | 0/10 | 0/10 |
| | 288 h | 0/10 | 0/10 | 0/10 | 0/10 | 0/10 | 0/10 | 0/10 | 0/10 | 10/10 | 5/10 | — | 8/10 | 3/10 | 0/10 |
| | 384 h | 0/10 | 0/10 | 0/10 | 0/10 | 0/10 | 0/10 | 0/10 | 0/10 | — | 9/10 | — | 10/10 | 7/10 | 0/10 |
| | 500 h | 0/10 | 0/10 | 0/10 | 0/10 | 0/10 | 0/10 | 0/10 | 0/10 | — | 10/10 | — | — | 10/10 | 0/10 |
| | 600 h | 0/10 | 0/10 | 0/10 | 0/10 | 0/10 | 0/10 | 0/10 | 0/10 | — | — | — | — | — | 0/10 |
| | 800 h | 0/10 | 0/10 | 0/10 | 0/10 | 0/10 | 0/10 | 0/10 | 0/10 | — | — | — | — | — | 0/10 |
| | 1000 h | 2/10 | 0/10 | 2/10 | 0/10 | 2/10 | 0/10 | 1/10 | 0/10 | — | — | — | — | — | 1/10 |
| | 1200 h | 3/10 | 0/10 | 3/10 | 1/10 | 2/10 | 0/10 | 3/10 | 1/10 | — | — | — | — | — | 3/10 |
| High temperature | 400 h | 0/10 | 0/10 | 0/10 | 0/10 | 0/10 | 0/10 | 0/10 | 0/10 | 0/10 | 0/10 | 0/10 | 0/10 | 0/10 | 2/10 |
| storage property | 600 h | 0/10 | 0/10 | 0/10 | 0/10 | 0/10 | 0/10 | 1/10 | 0/10 | 0/10 | 0/10 | 0/10 | 0/10 | 0/10 | 5/10 |
| | 800 h | 0/10 | 0/10 | 0/10 | 0/10 | 0/10 | 0/10 | 2/10 | 0/10 | 0/10 | 0/10 | 0/10 | 0/10 | 0/10 | 10/10 |
| | 1000 h | 0/10 | 0/10 | 0/10 | 0/10 | 0/10 | 0/10 | 2/10 | 0/10 | 1/10 | 0/10 | 1/10 | 0/10 | 0/10 | — |

| | | | | | | | | | | | | | | |
|---|---|---|---|---|---|---|---|---|---|---|---|---|---|---|
| Sodium ion | 0.96 | 1.4 | 2 | 0.78 | 2.2 | 1.2 | 2.7 | 0.96 | 4.6 | 2.9 | 6.8 | 3.6 | 2.9 | 1.4 |
| (Na⁺) | | | | | | | | | | | | | | |
| concentration in the extract | | | | | | | | | | | | | | |
| water (ppm) | | | | | | | | | | | | | | |
| Chlorine ion (Cl⁻) | 0.75 | 1.6 | 1.1 | 2 | 1.3 | 1.8 | 0.96 | 0.63 | 3.8 | 7.8 | 3.3 | 2.2 | 4.8 | 2.4 |
| concentration in the extract | | | | | | | | | | | | | | |
| water (ppm) | | | | | | | | | | | | | | |
| Total phosphate ion | 0.5 | 6.8 | 18 | 7.5 | 15 | 9.8 | 24 | 4.8 | 65 | 39 | 82 | 43 | 44 | 0.3 |
| concentration in the extract | | | | | | | | | | | | | | |
| water (ppm) | | | | | | | | | | | | | | |
| pH of the extract water | 7.1 | 7.2 | 6.5 | 6.8 | 7.0 | 7.3 | 6.4 | 7.3 | 4.3 | 5.1 | 4.2 | 5.6 | 6.9 | 4.5 |
| Electric conductivity | 40 | 29 | 72 | 58 | 67 | 61 | 82 | 25 | 540 | 230 | 880 | 350 | 140 | 90 |
| of the extract water (μs/cm) | | | | | | | | | | | | | | |

*after 10 shots of molding

The comparative examples N1 to N4 of which the ion concentrations in the extract water exceeded the set level and comparative example N5 using non-composite type metal hydroxide were inferior in moisture resistance. The comparative example N6 including bromide epoxy resin and antimony compound as flame retardant was inferior in high temperature storage property.

On the other hands, the examples N1 to N8 were excellent in any of fluidity, hardness at curing stage, reflow resistance, moisture resistance and high temperature storage property, as well as in flame resistance.

### (4) Example P

### Examples P1 and P2, Comparative Examples P1 to P4

Respective components shown in Table P1 were mixed by parts by weight, and roll-kneaded at 80° C. for 10 min. to prepare and evaluate resin compositions of examples P1 and P2 and comparative examples P1 to P4. The results are shown in Table P2.

TABLE P1

(Unit: parts by weight)

| | Examples P | | Comparative examples P | | | |
|---|---|---|---|---|---|---|
| Composition | 1 | 2 | 1 | 2 | 3 | 4 |
| Epoxy resin (4) | 100 | 70 | — | 70 | — | — |
| Epoxy resin (1) | — | 20 | 100 | 20 | 100 | 85 |
| Epoxy resin (3) | — | 10 | — | 10 | — | — |
| Curing agent (1) | 70 | 54 | 90 | 54 | 90 | 83 |
| Curing agent (2) | — | 26 | — | 26 | — | — |
| Hardening accelerator (1) | 3.8 | — | 3.8 | — | 3.8 | 3.5 |
| Hardening accelerator (2) | — | 3.8 | — | 3.8 | — | — |
| Fused silica | 1286 | 1677 | 1438 | 1953 | 1991 | 1485 |
| Composite metal hydroxide | 100 | 50 | 100 | — | — | — |
| Condensed phosphate | — | 30 | — | 60 | 60 | — |
| Antimony trioxide | — | — | — | — | — | 6 |
| Epoxy resin (5) | — | — | — | — | — | 15 |
| Hydrotalcite | — | 5 | — | 5 | — | — |
| Epoxy silane | 5 | 5 | 5 | 5 | 5 | 5 |
| Carnauba wax | 2 | 2 | 2 | 2 | 2 | 2 |
| Carbon black | 3 | 3 | 3 | 3 | 3 | 3 |
| Amount of inorganic filler (wt %)* | 82 | 86 | 88 | 88 | 88 | 88 |

*Amount against the resin composition (wt %)

TABLE P2

| | | Examples | | | | | |
|---|---|---|---|---|---|---|---|
| | | P | | Comparative examples P | | | |
| Evaluation | | 1 | 2 | 1 | 2 | 3 | 4 |
| Flame resistance | | V-0 | V-0 | V-0 | V-0 | V-0 | V-0 |
| Spiral flow (in.) | | 34 | 40 | 32 | 48 | 45 | 38 |
| Hardness at curing stage | | 74 | 72 | 77 | 52 | 58 | 75 |
| (Shore D) | | | | | | | |
| Disc flow (mm) | | 87 | 83 | 88 | 87 | 92 | 81 |
| Mold release force under | | 180 | 182 | 110 | 99 | 95 | 85 |
| shearing (KPa)* | | | | | | | |
| Reflow | 72 h | 0/5 | 0/5 | 0/5 | 0/5 | 0/5 | 0/5 |
| resistance | 96 h | 0/5 | 0/5 | 1/5 | 0/5 | 0/5 | 0/5 |
| | 168 h | 0/5 | 0/5 | 2/5 | 0/5 | 0/5 | 1/5 |
| | 336 h | 2/5 | 1/5 | 5/5 | 0/5 | 0/5 | 2/5 |
| Moisture | 30 h | 0/10 | 0/10 | 0/10 | 0/10 | 0/10 | 0/10 |
| resistance | 100 h | 0/10 | 0/10 | 0/10 | 0/10 | 1/10 | 0/10 |
| | 250 h | 0/10 | 0/10 | 0/10 | 1/10 | 3/10 | 0/10 |
| | 500 h | 0/10 | 0/10 | 0/10 | 4/10 | 10/10 | 1/10 |
| High | 400 h | 0/10 | 0/10 | 0/10 | 0/10 | 0/10 | 0/10 |
| temperature | 600 h | 0/10 | 0/10 | 0/10 | 0/10 | 0/10 | 1/10 |
| storage | 800 h | 0/10 | 0/10 | 0/10 | 1/10 | 1/10 | 4/10 |
| property | 1000 h | 0/10 | 0/10 | 0/10 | 2/10 | 3/10 | 10/10 |

*after 10 shots of molding

As shown in Table P2, the comparative examples P1 to P3 which did not contain one of or both of the sulfur atom containing epoxy resin and the composite metal hydroxide (C) were inferior in terms of either reflow resistance, moisture resistance, or high temperature storage property. The comparative example M4 in which bromide epoxy resin and antimony compound were used was inferior in the high temperature storage property.

On the other hand, in the examples M1 and M2, all of the reflow resistance, the moisture resistance and the high temperature storage property were favorable, and the V-0 of the UL-94 test was achieved to show good flame resistance.

### (5) Example Q

### Examples Q1 to Q6, Comparative Examples Q1 to Q6

Respective components shown in Table Q1 were mixed by parts by weight, and roll-kneaded at 80° C. for 10 min. to prepare and evaluate epoxy resin compositions of examples Q1 to Q6 and comparative examples Q1 to Q6 were prepared. The results are shown in Table Q2.

TABLE Q1
(Unit: parts by weight)

| | Examples Q | | | | | | Comparative examples Q | | | | | |
|---|---|---|---|---|---|---|---|---|---|---|---|---|
| Composition | 1 | 2 | 3 | 4 | 5 | 6 | 1 | 2 | 3 | 4 | 5 | 6 |
| Epoxy resin (1) | 100 | 20 | 100 | 100 | 20 | — | 100 | 20 | 100 | 85 | 20 | — |
| Epoxy resin (2) | — | 50 | — | — | — | — | — | 50 | — | — | — | — |
| Epoxy resin (3) | — | 30 | — | — | 10 | — | — | 30 | — | — | 10 | — |
| Epoxy resin (4) | — | — | — | — | 70 | 100 | — | — | — | — | 70 | 100 |
| Curing agent (1) | 89 | 62 | 89 | 89 | 54 | 70 | 89 | 62 | 89 | 83 | 54 | 70 |
| Curing agent (2) | — | 27 | — | — | 26 | — | — | 27 | — | — | 26 | — |
| Hardening accelerator (5) | 1.75 | — | — | — | — | — | — | — | — | 3.5 | — | — |
| Hardening accelerator (6) | — | 3.5 | — | — | — | — | — | 3.5 | — | — | — | — |
| Hardening accelerator (1) | 1.75 | — | 3.5 | — | 3.7 | 3.7 | — | — | 3.5 | — | — | — |
| Hardening accelerator (4) | — | — | — | — | — | — | 3.5 | — | — | — | 3.7 | 3.7 |
| Hardening accelerator (7) | — | — | — | 4.2 | — | — | — | — | — | — | — | — |
| Fused silica | 1385 | 1115 | 1385 | 1390 | 1321 | 1292 | 1385 | 1176 | 1823 | 1485 | 1319 | 1292 |
| Composite metal hydroxide | 100 | 50 | 100 | 100 | 100 | 100 | 100 | — | — | — | 100 | 100 |
| Red phosphorus | — | 3 | — | — | — | — | — | 5 | — | — | — | — |
| Antimony trioxide | — | — | — | — | — | — | — | — | — | 6 | — | — |
| Epoxy resin (5) | — | — | — | — | — | — | — | — | — | 15 | — | — |
| Epoxy silane | 5 | 5 | 5 | 5 | 5 | 5 | 5 | 5 | 5 | 5 | 5 | 5 |
| Carnauba wax | 2 | 2 | 2 | 2 | 2 | 2 | 2 | 2 | 2 | 2 | 2 | 2 |
| Carbon black | 3 | 3 | 3 | 3 | 3 | 3 | 3 | 3 | 3 | 3 | 3 | 3 |
| Amount of inorganic filler (wt %)* | 82 | 81 | 82 | 82 | 82 | 82 | 82 | 85 | 90 | 88 | 82 | 82 |

*Amount against the resin composition (wt %)

TABLE Q2

| | | Examples Q | | | | | | Comparative examples Q | | | | | |
|---|---|---|---|---|---|---|---|---|---|---|---|---|---|
| Evaluation | | 1 | 2 | 3 | 4 | 5 | 6 | 1 | 2 | 3 | 4 | 5 | 6 |
| Flame resistance | | V-0 | V-0 | V-0 | V-0 | V-0 | V-0 | V-0 | V-0 | V-1 | V-0 | V-0 | V-0 |
| Spiral flow (in.) | | 33 | 35 | 34 | 37 | 35 | 36 | 23 | 38 | 29 | 35 | 25 | 26 |
| Spiral flow (cm) | | 84 | 89 | 86 | 94 | 89 | 91 | 58 | 97 | 74 | 89 | 64 | 66 |
| Hardness at curing stage (Shore D) | | 79 | 80 | 75 | 78 | 75 | 75 | 83 | 80 | 76 | 82 | 82 | 82 |
| Mold release force under shearing | | 5.6 | 5.4 | 14.3 | 5.8 | 13.1 | 13.0 | 5.0 | 5.2 | 5.6 | 5.0 | 5.2 | 5.1 |
| (average) (Kgf) | | | | | | | | | | | | | |
| Mold release force under shearing | | 175 | 169 | 447 | 181 | 409 | 406 | 156 | 162 | 175 | 156 | 162 | 159 |
| (average) (KPa) | | | | | | | | | | | | | |
| Mold release force under shearing | | 108 | 92 | 190 | 121 | 185 | 182 | 88 | 90 | 105 | 84 | 93 | 89 |
| (after 10 shots of molding) (KPa) | | | | | | | | | | | | | |
| Reflow resistance | 72 h | 0/5 | 0/5 | 0/5 | 0/5 | 0/5 | 0/5 | 0/5 | 0/5 | 0/5 | 0/5 | 0/5 | 0/5 |
| | 96 h | 0/5 | 0/5 | 0/5 | 0/5 | 0/5 | 0/5 | 2/5 | 0/5 | 0/5 | 0/5 | 2/5 | 1/5 |
| | 168 h | 2/5 | 3/5 | 1/5 | 1/5 | 1/5 | 0/5 | 5/5 | 3/5 | 0/5 | 3/5 | 4/5 | 3/5 |
| | 336 h | 4/5 | 5/5 | 3/5 | 3/5 | 3/5 | 0/5 | 5/5 | 5/5 | 1/5 | 5/5 | 5/5 | 5/5 |
| Moisture resistance | 30 h | 0/10 | 0/10 | 0/10 | 0/10 | 0/10 | 0/10 | 0/10 | 0/10 | 0/10 | 0/10 | 0/10 | 0/10 |
| | 100 h | 0/10 | 0/10 | 0/10 | 0/10 | 0/10 | 0/10 | 0/10 | 1/10 | 0/10 | 0/10 | 0/10 | 0/10 |
| | 250 h | 0/10 | 0/10 | 0/10 | 0/10 | 0/10 | 0/10 | 0/10 | 6/10 | 0/10 | 0/10 | 0/10 | 0/10 |
| | 500 h | 0/10 | 1/10 | 0/10 | 0/10 | 0/10 | 0/10 | 0/10 | 10/10 | 0/10 | 1/10 | 0/10 | 0/10 |
| High temperature | 400 h | 0/10 | 0/10 | 0/10 | 0/10 | 0/10 | 0/10 | 0/10 | 0/10 | 0/10 | 0/10 | 0/10 | 0/10 |
| storage property | 600 h | 0/10 | 0/10 | 0/10 | 0/10 | 0/10 | 0/10 | 0/10 | 0/10 | 0/10 | 1/10 | 0/10 | 0/10 |
| | 800 h | 0/10 | 0/10 | 0/10 | 0/10 | 0/10 | 0/10 | 0/10 | 1/10 | 0/10 | 4/10 | 0/10 | 0/10 |
| | 1000 h | 0/10 | 0/10 | 0/10 | 0/10 | 0/10 | 0/10 | 0/10 | 2/10 | 0/10 | 10/10 | 0/10 | 0/10 |

As indicated in Table Q2, the comparative examples Q1, Q5 and Q6 which contained phosphine compound but did not contain quinone compound were inferior in fluidity and reflow resistance. The comparative examples Q2 to Q4 which did not contain composite metal hydroxide (C) were inferior in any one of flame resistance, moisture resistance and high temperature storage property. Especially, the comparative example Q4 in which bromide epoxy resin and antimony compound were used as flame retardant was much inferior in high temperature storage property.

On the other hand, the examples Q1 to Q6 were excellent in terms of reflow resistance, moisture resistance and high temperature storage property. They also demonstrated superior characteristics of flame resistance, with the UL-94 test achieving V-0. Especially, the examples Q1 and Q2 using the phosphine compound in which R in the general formula (IA) is alkyl group and the example Q4 using the adduct of the phosphine compound shown by the general formula (IB) and quinone compound also showed good mold release properties under shearing.

### (6) Example R

Synthesis of Mold Releasing Agent

A copolymerization product of a mixture of 1-eicosene, 1-docosane and 1-tricosane and maleic anhydride (product name: Nissan Electol WPB-1 manufactured by NOF Corporation) as the copolymerization product between α-olefin and maleic anhydride and stealyl alcohol as an alcohol were dissolved in toluene and reacted at 100° C. for 8 hours. The reaction system above was heated to remove toluene under increasing temperatures to 160° C. step by step, and forced to continue the reaction at 160° C. for 6 hours under reduced pressure to remove unreacted components. An esterificated product, the component (G): mold releasing agent (5) having a weight average molecular weight of 34,000, and a mono-esterification ratio of 70 mol % was obtained.

Another esterificated compound, mold releasing agent (6) having a weight average molecular weight of 23,000 and a mono-esterification ratio of 70 mol % was obtained using the same method as described above except the use of copolymerization product between propylene and maleic anhydride (the copolymerization ratio 1/1) as the copolymerization product between α-olefin and maleic anhydride. In addition, in the same method described above except the use of propyl alcohol as monovalent alcohol, an esterificated compound, mold releasing agent (7) having a weight average molecular weight of 20,000 and a mono-esterification ratio of 30 mol % was obtained. The weight average molecular weight here was the value measured with GPC using THF (tetrahydrofuran) as a solvent.

### Examples R1 to R4, Comparative Examples R1 to R10

Respective components shown in Table R1 were mixed by parts by weight, and roll-kneaded at 80° C. for 10 min. to prepare and evaluate resin compositions of examples R1 to R4 and of the comparative examples R1 to R10. Here, epoxy resins and respective mold releasing agents were pre-mixed at 170° C. for 6 hours in advance to the roll kneading. The results are shown in Table R2.

TABLE R1
(Unit: parts by weight)

| | Examples R | | | | Comparative examples R | | | | | | | | | |
|---|---|---|---|---|---|---|---|---|---|---|---|---|---|---|
| Composition | 1 | 2 | 3 | 4 | 1 | 2 | 3 | 4 | 5 | 6 | 7 | 8 | 9 | 10 |
| Epoxy resin (1) | 100 | 20 | 40 | — | 100 | 100 | 100 | 100 | 100 | 20 | 20 | 40 | — | 85 |
| Epoxy resin (2) | — | 50 | — | — | — | — | — | — | — | 50 | 50 | — | — | — |
| Epoxy resin (3) | — | 30 | — | — | — | — | — | — | — | 30 | 30 | — | — | — |
| Epoxy resin (4) | — | — | 60 | 100 | — | — | — | — | — | — | — | 60 | 100 | — |
| Curing agent (1) | 89 | 75 | 78 | 70 | 89 | 89 | 89 | 89 | 89 | 75 | 75 | 78 | 70 | 83 |
| Curing agent (2) | — | 12 | — | — | — | — | — | — | — | 12 | 12 | — | — | — |
| Hardening | 3.5 | 3 | 3.5 | 3.7 | 3.5 | 3.5 | 3.5 | 3.5 | 3.5 | 3 | 3 | 3.5 | 3.7 | 3.5 |
| accelerator (1) | | | | | | | | | | | | | | |
| Fused silica | 1372 | 962 | 1490 | 1284 | 1372 | 1372 | 1372 | 1372 | 1372 | 962 | 962 | 1490 | 1284 | 1485 |
| Composite | 150 | 200 | 100 | 100 | 150 | 150 | 150 | 150 | 150 | 200 | 200 | — | 100 | — |
| metal hydroxide | | | | | | | | | | | | | | |
| Mold releasing | 3 | 3 | 3 | 3 | 6 | — | — | — | — | 3 | 3 | 3 | 6 | — |
| agent (1) | | | | | | | | | | | | | | |
| Mold releasing | — | — | — | — | — | — | 3 | — | — | — | — | — | — | — |
| agent (2) | | | | | | | | | | | | | | |
| Mold releasing | — | — | — | — | — | — | — | 3 | — | — | — | — | — | — |
| agent (3) | | | | | | | | | | | | | | |
| Mold releasing | — | — | — | — | — | — | — | — | 3 | — | — | — | — | — |
| agent (4) | | | | | | | | | | | | | | |
| Mold releasing | 3 | 3 | 3 | 3 | — | 6 | 3 | 3 | 3 | — | — | 3 | — | — |
| agent (5) | | | | | | | | | | | | | | |
| Mold releasing | — | — | — | — | — | — | — | — | — | 3 | — | — | — | — |
| agent (6) | | | | | | | | | | | | | | |
| Mold releasing | — | — | — | — | — | — | — | — | — | — | 3 | — | — | — |
| agent (7) | | | | | | | | | | | | | | |
| Magnesium hydroxide | — | — | — | — | — | — | — | — | — | — | — | 100 | — | — |
| Antimony trioxide | — | — | — | — | — | — | — | — | — | — | — | — | — | 6 |
| Epoxy resin (5) | — | — | — | — | — | — | — | — | — | — | — | — | — | 15 |
| Montanate ester | 1 | 1 | 1 | 1 | 1 | 1 | 1 | 1 | 1 | 1 | 1 | 1 | 1 | 1 |
| Epoxy silane | 5 | 5 | 5 | 5 | 5 | 5 | 5 | 5 | 5 | 5 | 5 | 5 | 5 | 5 |
| Carbon black | 3 | 3 | 3 | 3 | 3 | 3 | 3 | 3 | 3 | 3 | 3 | 3 | 3 | 3 |
| Amount of inorganic | 79 | 70 | 83 | 82 | 79 | 79 | 79 | 79 | 79 | 70 | 70 | 83 | 82 | 88 |
| filler (wt %)* | | | | | | | | | | | | | | |

*Amount against the resin composition (wt %)

TABLE R2

| | | Examples R | | | | Comparative examples R | | | | | | | | | |
|---|---|---|---|---|---|---|---|---|---|---|---|---|---|---|---|
| Evaluation | | 1 | 2 | 3 | 4 | 1 | 2 | 3 | 4 | 5 | 6 | 7 | 8 | 9 | 10 |
| Flame resistance | | V-0 | V-0 | V-0 | V-0 | V-0 | V-0 | V-0 | V-0 | V-0 | V-0 | V-0 | V-0 | V-0 | V-0 |
| Spiral flow (in.) | | 76 | 69 | 76 | 91 | 76 | 76 | 78 | 81 | 84 | 69 | 69 | 63 | 90 | 89 |
| Hardness at curing stage | | 80 | 77 | 77 | 75 | 81 | 79 | 80 | 80 | 79 | 77 | 77 | 78 | 73 | 82 |
| (Shore D) | | | | | | | | | | | | | | | |
| Mold release force under | | 6.0 | 7.5 | 7.1 | 8.6 | 13.8 | 14.2 | 12.0 | 14.0 | 42.0 | 12.3 | 12.2 | 12.1 | 15.8 | 5.0 |
| shearing (average) (Kgf) | | | | | | | | | | | | | | | |
| Mold release force under | | 187 | 234 | 222 | 269 | 431 | 443 | 375 | 437 | 1312 | 384 | 381 | 378 | 493 | 156 |
| shearing(average) (KPa) | | | | | | | | | | | | | | | |
| Mold release force under | | 123 | 138 | 135 | 169 | 189 | 196 | 185 | 189 | 582 | 182 | 180 | 180 | 226 | 102 |
| shearing (after 10 shots of | | | | | | | | | | | | | | | |
| molding)(KPa) | | | | | | | | | | | | | | | |
| Reflow resistance | 72 h | 0/5 | 0/5 | 0/5 | 0/5 | 0/5 | 0/5 | 0/5 | 0/5 | 0/5 | 0/5 | 0/5 | 0/5 | 0/5 | 0/5 |
| | 96 h | 0/5 | 0/5 | 0/5 | 0/5 | 0/5 | 0/5 | 0/5 | 0/5 | 0/5 | 0/5 | 0/5 | 0/5 | 0/5 | 0/5 |
| | 168 h | 2/5 | 5/5 | 0/5 | 0/5 | 2/5 | 2/5 | 2/5 | 2/5 | 2/5 | 5/5 | 5/5 | 1/5 | 0/5 | 2/5 |
| | 336 h | 5/5 | 5/5 | 3/5 | 0/5 | 5/5 | 5/5 | 5/5 | 5/5 | 5/5 | 5/5 | 5/5 | 4/5 | 0/5 | 5/5 |
| Moisture | 100 h | 0/10 | 0/10 | 0/10 | 0/10 | 0/10 | 0/10 | 0/10 | 0/10 | 0/10 | 0/10 | 0/10 | 0/10 | 0/10 | 0/10 |
| resistance | 250 h | 0/10 | 0/10 | 0/10 | 0/10 | 0/10 | 0/10 | 0/10 | 0/10 | 0/10 | 0/10 | 0/10 | 0/10 | 0/10 | 0/10 |
| | 500 h | 0/10 | 0/10 | 0/10 | 0/10 | 0/10 | 0/10 | 0/10 | 0/10 | 0/10 | 0/10 | 0/10 | 0/10 | 0/10 | 1/10 |
| | 750 h | 0/10 | 0/10 | 0/10 | 0/10 | 0/10 | 0/10 | 0/10 | 0/10 | 0/10 | 0/10 | 0/10 | 0/10 | 0/10 | 6/10 |
| High temperature | 400 h | 0/10 | 0/10 | 0/10 | 0/10 | 0/10 | 0/10 | 0/10 | 0/10 | 0/10 | 0/10 | 0/10 | 0/10 | 0/10 | 0/10 |
| storage property | 600 h | 0/10 | 0/10 | 0/10 | 0/10 | 0/10 | 0/10 | 0/10 | 0/10 | 0/10 | 0/10 | 0/10 | 0/10 | 0/10 | 1/10 |
| | 800 h | 0/10 | 0/10 | 0/10 | 0/10 | 0/10 | 0/10 | 0/10 | 0/10 | 0/10 | 0/10 | 0/10 | 0/10 | 0/10 | 4/10 |
| | 1000 h | 0/10 | 0/10 | 0/10 | 0/10 | 0/10 | 0/10 | 0/10 | 0/10 | 0/10 | 0/10 | 0/10 | 0/10 | 0/10 | 10/10 |

As indicated in Table R2, the comparative examples R1 to R9 which did not include any one of the components (C), (F) and (G) were inferior in mold release properties under shearing. Moreover, the comparative example R10 which included bromide epoxy resin and antimony compound as flame retardant was inferior in terms of moisture resistance and high temperature storage property.

On the other hand, examples R1 to R4 were preferable in terms of all of mold release properties under shearing, moisture resistance and high temperature storage property, and V-0 was achieved in the UL-94 test to show good flame resistance. Moreover, there was also no problem in terms of spiral flow, hardness at curing stage or reflow resistance.

It is to be noted that, besides those already mentioned above, various changes and modifications can be made in the above-mentioned embodiments without departing from the novel and advantageous features of the present invention. Therefore, all such changes and modifications are intended to be included within the scope of the appended claims.

1. An encapsulating epoxy resin composition, containing an epoxy resin (A), a curing agent (B), and a composite metal hydroxide (C), and having a mold release force under shearing after 10 shots of molding which is less than or equal to 200 KPa.

2. An encapsulating epoxy resin composition according to claim 1, further containing an inorganic filler (D).

3. An encapsulating epoxy resin composition according to claim 1, further containing a hardening accelerator (E).

4. An encapsulating epoxy resin composition according to claim 3, wherein the component (E) comprises at least one selected from the group consisting of a hardening accelerator containing a phosphine compound represented by the general formula (IA) and a quinone compound, a hardening accelerator containing a phosphine compound comprising a phosphorus atom bonded with at least one alkyl group and a quinone compound, a hardening accelerator containing an adduct of a phosphine compound represented by the general formula (IA) and a quinone compound, and a hardening accelerator containing an adduct of a phosphine compound comprising a phosphorus atom bonded with at least one alkyl group and a quinone compound. 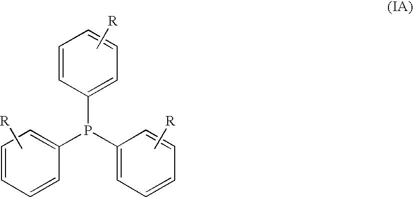
(In the formula (IA), R is selected from the group consisting of a hydrogen atom, a substituted or unsubstituted hydrocarbon group having 1 to 12 carbon atoms, and a substituted or unsubstituted alkoxy group having 1 to 12 carbon atoms, and all of which may be the same or different to each other.)

5. An encapsulating epoxy resin composition according to claim 4, wherein the phosphine compound comprising a phosphorus atom bonded with at least one alkyl group is a compound represented by the general formula (IB): 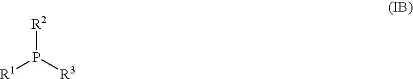
(In the formula (IB), R¹ represents a substituted or unsubstituted alkyl group having 1 to 12 carbon atoms, R² and R³ are independently selected from the group consisting of a hydrogen atom and a substituted or unsubstituted hydrocarbon group having 1 to 12 carbon atoms, and all of which may be the same or different to each other.)

6. An encapsulating epoxy resin composition according to claim 4, wherein the quinone compound is p-benzoquinone.

7. An encapsulating epoxy resin composition according to claim 4, wherein the phosphine compound represented by the general formula (IA) is selected from the group consisting of triphenylphosphine, tri-p-tolylphosphine, and tributylphosphine.

8. An encapsulating epoxy resin composition according to claim 1, further containing a linear type oxidized polyethylene (F) having a weight average molecular weight of greater than or equal to 4,000, and an ester compound (G) obtained by esterification of a copolymer of an α-olefin having 5 to 30 carbon atoms and maleic anhydride, with a monovalent alcohol having 5 to 25 carbon atoms.

9. An encapsulating epoxy resin composition according to claim 8, wherein at least one of the component (F) and the component (G) is contained as a pre-mixture with a part of or all of the component (A).

10. An encapsulating epoxy resin composition according to claim 1, wherein the component (C) contains a compound represented by the composition formula (C-I):
p(M¹aOb).q(M²cOd).r(M³cOd).mH₂O (C-I)
(In the formula (C-I), M¹, M² and M³ are different metal elements each other, a, b, c, d, p, q, and m are positive numerals, and r is 0 or a positive numeral.)

11. An encapsulating epoxy resin composition according to claim 10, wherein M¹ is selected from the group consisting of metal elements belonging to the third period, alkaline earth metal elements of group IIA and metal elements belonging to groups IVB, IIB, VIII, IB, IIIA and IVA, and M² is selected from transition metal elements of groups IIIB to IIB.

12. An encapsulating epoxy resin composition according to claim 11, wherein M¹ is selected from the group consisting of magnesium, calcium, aluminum, tin, titanium, iron, cobalt, nickel, copper and zinc, and M² is selected from the group consisting of iron, cobalt, nickel, copper and zinc.

13. An encapsulating epoxy resin composition according to claim 12, wherein M¹ is magnesium and M² is selected from the group consisting of zinc and nickel.

14. An encapsulating epoxy resin composition according to claim 10, wherein r is 0 and a molar ratio p/q is 99/1 to 50/50.

15. An encapsulating epoxy resin composition according to claim 1, wherein an extract water which is obtained by extracting ions from a mixture containing 1 g of crushed pieces of a molded article made of the encapsulating epoxy resin composition per 10 ml of water has a concentration of sodium ion ranging from 0 to 3 ppm, a concentration of chloride ion ranging from 0 to 3 ppm, an electric conductivity less than or equal to 100 μS/cm, and a pH value ranging from 5.0 to 9.0.

16. An encapsulating epoxy resin composition according to claim 15, further containing a phosphorus atom-containing compound (H).

17. An encapsulating epoxy resin composition according to claim 16, wherein the component (H) contains at least one selected from the group consisting of red phosphorus, phosphate, and a compound containing phosphorus and nitrogen.

18. An encapsulating epoxy resin composition according to claim 16, wherein a total concentration of orthophosphate ions (PO₄³⁻), phosphite ions (HPO₃²⁻) and hypophosphite ions (H₂PO₂⁻) in the extract water ranges from 0 to 30 ppm.

19. An encapsulating epoxy resin composition according to claim 1, further containing a silane coupling agent (J) having a secondary amino group.

20. An encapsulating epoxy resin composition according to claim 19, wherein the component (J) contains a compound represented by the general formula (II): 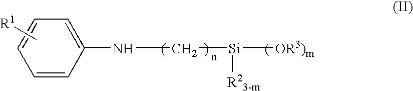
(In the formula (II), R¹ is selected from the group consisting of a hydrogen atom, an alkyl group having 1 to 6 carbon atoms and an alkoxy group having 1 or 2 carbon atoms, R² is selected from an alkyl group having 1 to 6 carbon atoms and a phenyl, R³ indicates methyl or ethyl, n is an integer ranging from 1 to 6, and m is an integer of 1 to 3).

21. An encapsulating epoxy resin composition according to claim 1, wherein the component (A) contains at least one selected from the group consisting of a biphenyl type epoxy resin, a bisphenol F type epoxy resin, a stilbene type epoxy resin, a sulfur atom containing epoxy resin, a novolak type epoxy resin, a dicyclopentadiene type epoxy resin, a naphthalene type epoxy resin, and a triphenylmethane type epoxy resin.

22. An encapsulating epoxy resin composition according to claim 1, wherein the component (A) contains a sulfur atom containing epoxy resin.

23. An encapsulating epoxy resin composition according to claim 22, wherein the sulfur atom containing epoxy resin contains a compound represented by the general formula (III): 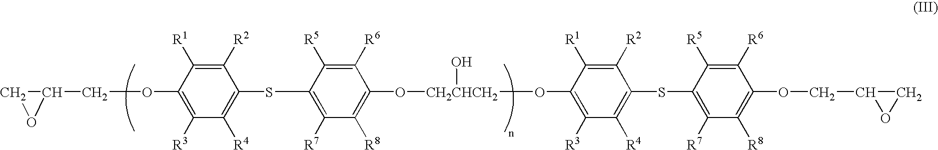
(In the formula (III), each one of R¹ to R⁸, which may be the same or different to each other, is selected from a hydrogen atom and a substituted or unsubstituted monovalent hydrocarbon group having 1 to 10 carbon atoms, and n is an integer of 0 to 3.)

24. An encapsulating epoxy resin composition according to claim 3, wherein the component (E) contains an adduct of cycloamidine compound and phenol resin.

25. An encapsulating epoxy resin composition according to claim 1, wherein the component (B) contains at least one selected from the group consisting of a biphenyl type phenol resin, an aralkyl type phenol resin, a dicyclopentasiene type phenol resin, a triphenyl methane type phenol resin, and a novolak type phenol resin.

26. An encapsulating epoxy resin composition according to claim 1, for encapsulating a semiconductor device having at least one of features including:
(a) at least one of an encapsulating material of an upper side of a semiconductor chip and an encapsulating material of a lower side of the semiconductor chip has a thickness less than or equal to 0.7 mm;
(b) a pin count is greater than or equal to 80;
(c) a wire length is greater than or equal to 2 mm;
(d) a pad pitch on the semiconductor chip is less than or equal to 90 μm;
(e) a thickness of a package, in which the semiconductor chip is disposed on a mounting substrate, is less than or equal to 2 mm; and
(f) an area of the semiconductor chip is greater than or equal to 25 mm².

27. An encapsulating epoxy resin composition according to claim 26, wherein the features of the semiconductor device are any one of:
(1) (a) or (e); and
(2) (a) and at least one feature selected from (b) to (f).

28. An encapsulating epoxy resin composition according to claim 26, wherein the features of the semiconductor device are any one of:
(1) (b) and (c);
(2) (b) and (d); and
(3) (b), (c) and (d).

29. An encapsulating epoxy resin composition according to claim 26, wherein the features of the semiconductor device are any one of:
(1) (a) and (b);
(2) (a) and (c);
(3) (a) and (d);
(4) (a) and (f);
(5) (c) and (e);
(6) (a), (b) and (d);
(7) (c), (e) and (f);
(8) (a), (b), (d) and (f); and
(9) (a), (b), (c) and (d).

30. An encapsulating epoxy resin composition according to claim 26, wherein the semiconductor device is a stacked type package.

31. An encapsulating epoxy resin composition according to claim 26, wherein the semiconductor device is a mold array package.

32. An electronic parts device comprising an elemental device encapsulated with the encapsulating epoxy resin composition according to claim 1.

33. An electronic parts device according to claim 32, wherein the electronic parts device is a semiconductor device having at least one of features including:
(a) at least one of an encapsulating material of an upper side of a semiconductor chip and an encapsulating material of a lower side of the semiconductor chip has a thickness less than or equal to 0.7 mm;
(b) a pin count is greater than or equal to 80;
(c) a wire length is greater than or equal to 2 mm;
(d) a pad pitch on the semiconductor chip is less than or equal to 90 μm;
(e) a thickness of a package, in which the semiconductor chip is disposed on a mounting substrate, is less than or equal to 2 mm; and
(f) an area of the semiconductor chip is greater than or equal to 25 mm².
